(19) United States
(12) Patent Application Publication
(10) Pub. No.: US 2017/0026896 A1
(43) Pub. Date: Jan. 26, 2017

(54) TERMINAL DEVICE, RELAY TERMINAL DEVICE, AND COMMUNICATION CONTROL METHOD

(71) Applicant: SHARP KABUSHIKI KAISHA, Sakai City, Osaka (JP)

(72) Inventors: Masayuki ENOMOTO, Sakai City (JP); Masafumi ARAMOTO, Sakai City (JP)

(73) Assignee: SHARP KABUSHIKI KAISHA, Sakai City, Osaka (JP)

(21) Appl. No.: 15/302,221

(22) PCT Filed: Apr. 7, 2015
(86) PCT No.: PCT/JP2015/060872

§ 371 Date: Oct. 6, 2016

(30) Foreign Application Priority Data
Apr. 7, 2014 (JP) 2014-078278

(51) Int. Cl. H04W 40/20; H04W 40/34

(52) U.S. Cl. CPC H04W 40/20; H04W 40/34; H04W 88/04

(57) ABSTRACT

Provided are respective communication control procedures of a terminal device and a relay terminal device, and a mobile communication system or the like with which the terminal device or the relay terminal device establishes a communication path with the terminal device or the relay terminal device in proximity through a proximity communication service, and the terminal device or the relay terminal device newly establishes a communication path through a proximity service while continuing transmission and reception of data in the established communication path and switches the transmission and reception of data to the newly established communication path.

The terminal device or the relay terminal device performs a switching procedure including means for newly establishing a communication path during the transmission and reception of data in a ProSe service and switching to the newly established communication path.

### TECHNICAL FIELD

The present invention relates to a terminal device, a relay terminal device, and a communication control method.

### BACKGROUND ART

In the 3rd Generation Partnership Project (3GPP) which is the standardization group for a mobile communication system, the specification work of an Evolved Packet System (EPS) described in NPL 1 as the next generation mobile communication system has progressed, and a wireless LAN (WLAN) as well as Long Term Evolution (LTE) has been discussed as an access system connected to the EPS.

In the 3GPP, also as described in NPL 2, proximity services (ProSe) of notifying user equipment (UE) of the presence of another user equipment in proximity have been discussed. ProSe is further aimed at the UE directly performing the transmission and reception of data by establishing a direct communication path with proximity UE without a base station in between.

In ProSe, since the transmission and reception of data are directly performed between the UEs, the transmission and reception of data can be performed without an access network based on an access technology such as LTE or a mobile communication network such as a core network in between, and thus, an offloading effect of avoiding traffic concentration is expected.

In ProSe, the use of two methods for a direct communication path between the UEs has been discussed. The first method is a method (hereinafter, referred to as LTE Direct) of establishing the direct communication path between the UEs using an LTE access technology, and the second method is a method of establishing the direct communication path using a wireless LAN access technology.

In LTE Direct, the UE uses a commercial frequency allocated in an LTE system of each mobile communication provider, and directly performs the transmission and reception of data to and from another UE by using an LTE communication scheme.

In WLAN Direct, the UE uses a non-commercial frequency allocated in the WLAN, and directly performs the transmission and reception of data to and from another UE.

In ProSe, the necessity for the UE to detect the presence of a communication target UE in proximity by searching for the communication target UE in order to perform the transmission and reception of data through LTE Direct or WLAN Direct is given as a service request condition.

In the 3GPP, as a mode in which one-to-many communication is performed, a group owner (GO) mode in which the UEs perform communication via UE having a relaying function and a decentralized mode in which direct communication is performed between the UEs are defined. A group owner (GO) is UE that manages a group, and manages a communication resource, information related to security or information related to the group in a case where direct communication is performed between the GO and the UE. In a case where each UE performs direct communication, it is necessary for the GO to allocate a communication resource. The GO receives data of direct communication transmitted from each UE and transfers the data to UE of the group, and thus, provides the transmission and reception of data between the UEs.

In the decentralized mode, a communication resource, information related to security or information related to the group is managed by each UE. In a case where direct communication is performed, each UE detects whether or not the direct communication is being performed, and starts the direct communication.

As mentioned above, in ProSe, it is aimed to provide the GO mode in which the transmission and reception of data between the UEs are performed via the GO and the decentralized mode in which each UE performs the direct communication with another UE. The switching, if necessary, between the decentralized mode and the GO mode has also been discussed.

### CITATION LIST

### Non Patent Literature

NPL 1: 3GPP TS23.401, Technical Specification Group Services and System Aspects, General Packet Radio Service (GPRS) enhancements for Evolved Universal Terrestrial Radio Access Network (E-UTRAN) access

NPL 2: 3GPP TR22.803, Technical Specification Group Services and System Aspects, Feasibility study for Proximity Services (ProSe)

### SUMMARY OF INVENTION

### Technical Problem

However, although communication path establishment procedures in the GO mode and the decentralized mode have been suggested, there has not been specific realization means for switching between the GO mode and the decentralized mode. That is, there has not been realization means for switching from the GO mode to the decentralized mode. Further, there has not been realization means for switching from the decentralized mode to the GO mode.

For example, in a case where UE 2 is in proximity to UE1, but not in close proximity to the UE 1 and therefore the UE1 is not able to perform direct communication with the UE 2, the GO mode is a desirable mode for allowing the UE 1 and the UE 2 to perform communication. However, in a case where the UE 2 is in sufficiently close proximity to UE 1 so that the UE 1 can perform direct communication with the UE 2, a radio resource, for example, is unnecessarily used by the GO to be present between the UEs, and therefore the decentralized mode is desirable.

In order to perform the switching from the GO mode to the decentralized mode, it is necessary for the UE and the GO to detect the switching to the decentralized mode, establish the communication path of the decentralized mode, and remove the communication path of the GO mode.

In order to perform the switching from the decentralized mode to the GO mode, it is necessary for the UE and the GO to detect the switching to the GO mode, establish the communication path of the GO mode, and remove the communication path of the decentralized mode.

However, means for allowing the UE and the GO to detect the switching to the decentralized mode, establish the communication path of the decentralized mode and remove the communication path of the GO mode in order to switch from the GO mode to the decentralized mode has not been found.

Further, means for allowing the UE and the GO to detect the switching to the GO mode, establish the communication path of the GO mode and remove the communication path of the decentralized mode in order to perform the switching from the decentralized mode to the GO mode has not been found.

The present invention has been made in view of such circumstances, and it is an object of the present invention to provide the respective processes of a terminal device, a base station, a position management apparatus and a subscriber manage apparatus, and a mobile communication system, which provide means for allowing UE that transitions to a decentralized mode from a GO mode during communication using a communication path of the GO mode to switch to a communication path of a decentralized mode while continuing a ProSe service and means for allowing the UE that transitions from the decentralized mode to the GO mode during communication using a communication path of the decentralized mode to switch to the communication path of the GO mode while continuing the ProSe service.

### Solution to Problem

There is provided a relay terminal device. In a case where transmission and reception of data are switched to a second communication path of a second mode in which data is directly transmitted to a terminal device present in the proximity of the relay terminal device for a period during which a first communication path of a first mode in which data transmitted from the terminal device is transferred to a base station apparatus and data transmitted from the base station apparatus is transferred to the terminal device is established and the transmission and reception of data are performed in the first communication path of the first mode, the relay terminal device transmits to the terminal device a request message which includes information indicating the switching to the second communication path of the second mode and requests the switching to the second communication path of the second mode; receives from the terminal device a response message to the request message for requesting the switching; establishes the second communication path of the second mode; and switches the transmission and reception of the data in the first communication path of the first mode to the transmission and reception of the data in the second communication path of the second mode.

There is provided a relay terminal device. In a case where transmission and reception of data are switched to a first communication path of a first mode in which data transmitted from a terminal device is transferred to a base station apparatus and data transmitted from the base station apparatus is transferred to the terminal device for a period during which a second communication path of a second mode in which data is directly transmitted to the terminal device present in the proximity of the relay terminal device is established and the transmission and reception of data are performed in the second communication path of the second mode, the relay terminal device transmits to the terminal device a request message which includes information indicating the switching to the first communication path of the first mode and requests the switching to the first communication path of the first mode; receives from the terminal device a response message to the request message for requesting the switching; establishes the first communication path of the first mode; and switches the transmission and reception of the data in the second communication path of the second mode to the transmission and reception of the data in the first communication path of the first mode.

The request message for requesting the switching is a request message for requesting that the communication path is established.

The request message for requesting the switching is a request message for requesting that the communication path before the switching is removed.

The request message for requesting the switching includes information for identifying the terminal device or the relay terminal device, or information indicating a connection destination.

There is provided a terminal device. In a case where transmission and reception of data are switched to a first communication path of a first mode in which data is transmitted via a relay terminal device for a period during which a second communication path of a second mode in which data is directly transmitted to the relay terminal device present in the proximity of the terminal device is established and the transmission and reception of data are performed in the second communication path of the second mode, the terminal device transmits to the relay terminal device a request message which includes information indicating the switching to the first communication path of the first mode and requests the switching to the first communication path of the first mode; receives from the relay terminal device a response message to the request message for requesting the switching; establishes the first communication path of the first mode; and switches the transmission and reception of the data in the second communication path of the second mode to the transmission and reception of the data in the first communication path of the first mode.

There is provided a terminal device. In a case where transmission and reception of data are switched to a second communication path of a second mode in which data is directly transmitted to a second terminal device present in the proximity of the terminal device for a period during which a first communication path of a first mode in which data is transmitted via a relay terminal device present in the proximity of the terminal device is established and the transmission and reception of data are performed in the first communication path of the first mode, the terminal device transmits to the second terminal device a request message which includes information indicating the switching to the second communication path of the second mode and requests the switching to the second communication path of the second mode; receives from the second terminal device a response message to the request message for requesting the switching; establishes the second communication path of the second mode; and switches the transmission and reception of the data in the first communication path of the first mode to the transmission and reception of the data in the second communication path of the second mode.

There is provided a terminal device. In a case where transmission and reception of data are switched to a first communication path of a first mode in which data is transmitted via a relay terminal device present in the proximity of the terminal device for a period during which a second communication path of a second mode in which data is directly transmitted to a second terminal device present in the proximity of the terminal device is established and the transmission and reception of data are performed in the second communication path of the second mode, the terminal device transmits to the second terminal device a request message which includes information indicating the switching to the first communication path of the first mode and requests the switching to the first communication path of the first mode; receives from the second terminal device a response message to the request message for requesting the switching; establishes the first communication path of the first mode; and switches the transmission and reception of the data in the second communication path of the second mode to the transmission and reception of the data in the first communication path of the first mode.

The request message for requesting the switching is a request message for requesting that the communication path is established.

The request message for requesting the switching is a request message for requesting that the communication path is removed.

The request message for requesting the switching includes information for identifying the terminal device or the relay terminal device, or information indicating a connection destination.

There is provided a communication control method of a relay terminal device. The method includes, in a case where transmission and reception of data are switched to a second communication path of a second mode in which data is directly transmitted to a terminal device present in the proximity of the relay terminal device for a period during which a first communication path of a first mode in which data transmitted from the terminal device is transferred to a base station apparatus and data transmitted from the base station apparatus is transferred to the terminal device is established and the transmission and reception of data are performed in the first communication path of the first mode, a step of transmitting to the terminal device a request message which includes information indicating the switching to the second communication path of the second mode and requests the switching to the second communication path of the second mode; receiving from the terminal device a response message to the request message for requesting the switching; a step of establishing the second communication path of the second mode; and a step of switching the transmission and reception of the data in the first communication path of the first mode to the transmission and reception of the data in the second communication path of the second mode.

There is provided a communication control method of a relay terminal device. The method includes, in a case where transmission and reception of data are switched to a first communication path of a first mode in which data transmitted from a terminal device is transferred to a base station apparatus and data transmitted from the base station apparatus is transferred to the terminal device for a period during which a second communication path of a second mode in which data is directly transmitted to the terminal device present in the proximity of the relay terminal device is established and the transmission and reception of data are performed in the second communication path of the second mode, a step of transmitting to the terminal device a request message which includes information indicating the switching to the first communication path of the first mode and requests the switching to the first communication path of the first mode; a step of receiving from the terminal device a response message to the request message for requesting the switching; a step of establishing the first communication path of the first mode; and a step of switching the transmission and reception of the data in the second communication path of the second mode to the transmission and reception of the data in the first communication path of the first mode.

There is provided a communication control method of a terminal device. The method includes, in a case where the terminal device switches transmission and reception of data to a first communication path of a first mode in which data is transmitted via a relay terminal device for a period during which a second communication path of a second mode in which data is directly transmitted to a relay terminal device present in the proximity of the terminal device is established and the transmission and reception of data are performed in the second communication path of the second mode, a step of transmitting to the relay terminal device a request message which includes information indicating the switching to the first communication path of the first mode and requests the switching to the first communication path of the first mode; a step of receiving from the relay terminal device a response message to the request message for requesting the switching; a step of establishing the first communication path of the first mode; and a switching the transmission and reception of the data in the second communication path of the second mode to the transmission and reception of the data in the first communication path of the first mode.

There is provided a communication control method of a terminal device. The method includes, in a case where transmission and reception of data are switched to a second communication path of a second mode in which data is directly transmitted to a second terminal device present in the proximity of the terminal device for a period during which a first communication path of a first mode in which data is transmitted via a relay terminal device present in the proximity of the terminal device is established and the transmission and reception of data are performed in the first communication path of the first mode, a step of transmitting to the second terminal device a request message which includes information indicating the switching to the second communication path of the second mode and requests the switching to the second communication path of the second mode; a step of receiving from the second terminal device a response message to the request message for requesting the switching; a step of establishing the second communication path of the second mode; and a step of switching the transmission and reception of the data in the first communication path of the first mode to the transmission and reception of the data in the second communication path of the second mode.

There is provided a communication control method of a terminal device. The method includes, in a case where transmission and reception of data are switched to a first communication path of a first mode in which data is transmitted via a relay terminal device present in the proximity of the terminal device for a period during which a second communication path of a second mode in which data is directly transmitted to a second terminal device present in the proximity of the terminal device is established and the transmission and reception of data are performed in the second communication path of the second mode, a step of transmitting to the second terminal device a request message which includes information indicating the switching to the first communication path of the first mode and requests the switching to the first communication path of the first mode; a step of receiving from the second terminal device a response message to the request message for requesting the switching; a step of establishing the first communication path of the first mode; and a step of switching the transmission and reception of the data in the second communication path of the second mode to the transmission and reception of the data in the first communication path of the first mode.

The request message for requesting the switching is a request message for requesting that the communication path is established.

The request message for requesting the switching is a request message for requesting that the communication path is removed.

The request message for requesting the switching includes information for identifying the terminal device or the relay terminal device, or information indicating a connection destination.

### Advantageous Effects of Invention

According to the present invention, a communication source UE and a communication destination UE establish a communication path of a GO mode and switch from the GO mode to a decentralized mode during the transmission and reception of data, and thus, a mobile communication provider can switch from the communication path of the GO mode to a communication path of the decentralized mode.

The communication source UE and the communication destination UE establish the communication path of the decentralized mode and switch from the decentralized mode to the GO mode during the transmission and reception of data, and thus, the mobile communication provider can switch from the communication path of the decentralized mode to the communication path of the GO mode.

### BRIEF DESCRIPTION OF DRAWINGS

FIG. 1 is a diagram for describing an outline of a mobile communication system 1 according to a first embodiment.

FIG. 2 is a diagram for describing a communication form according to the first embodiment.

FIG. 3 is a diagram for describing a functional structure of UE according to the first embodiment.

FIG. 4 is a diagram illustrating an example of a functional structure managed in a storage unit of the UE according to the first embodiment.

FIG. 5 is a diagram for describing a functional structure of UE-R according to the first embodiment.

FIG. 6 is a diagram illustrating an example of a functional structure managed in a storage unit of the UE-R according to the first embodiment.

FIG. 7 is a diagram for describing a functional structure of an eNB according to the first embodiment.

FIG. 8 is a diagram for describing a functional structure of an MME according to the first embodiment.

FIG. 9 is a diagram for describing a functional structure of a ProSe Server according to the first embodiment.

FIG. 10 is a diagram for describing a flow of processes according to the first embodiment.

FIG. 11 is a diagram for describing a registration procedure of the UE in the ProSe application server according to the first embodiment.

FIG. 12 is a diagram for describing network connection and a service registration procedure of the UE-R according to the first embodiment.

FIG. 13 is a diagram for describing a communication path establishment procedure in a GO mode according to the first embodiment.

FIG. 14 is a diagram for describing the management of a communication path of the GO mode according to the first embodiment.

FIG. 15 is a diagram for describing a switching procedure to a decentralized mode according to the first embodiment.

FIG. 16 is a diagram for describing a communication path establishment procedure in the decentralized mode according to the first embodiment.

FIG. 17 is a diagram for describing a communication path removal procedure of the GO mode according to the first embodiment.

FIG. 18 is a diagram for describing the management of a communication path of the decentralized mode according to the first embodiment.

FIG. 19 is a diagram for describing a switching procedure to a decentralized mode according to Modification Example 1.

FIG. 20 is a diagram for describing a communication path establishment procedure of the decentralized mode according to Modification Example 1.

FIG. 21 is a diagram for describing a communication path removal procedure of a GO mode according to Modification Example 1.

FIG. 22 is a diagram for describing a flow of processes according to a second embodiment.

FIG. 23 is a diagram for describing a switching procedure to a GO mode according to the second embodiment.

FIG. 24 is a diagram for describing a communication path establishment procedure of the GO mode according to the second embodiment.

FIG. 25 is a diagram for describing a communication path removal procedure of a decentralized mode according to the second embodiment.

FIG. 26 is a diagram for describing a switching procedure to a GO mode according to Modification Example 2.

FIG. 27 is a diagram for describing a communication path removal procedure of a decentralized mode according to Modification Example 2.

FIG. 28 is a diagram for describing a communication form according to a third embodiment.

FIG. 29 is a diagram for describing the management of a communication path of a GO mode according the third embodiment.

FIG. 30 is a diagram for describing a switching procedure to a decentralized mode according to the third embodiment.

FIG. 31 is a diagram for describing the management of a communication path of a decentralized mode according to the third embodiment.

FIG. 32 is a diagram for describing a switching procedure to a GO mode according to a fourth embodiment.

FIG. 33 is a diagram for describing the selection of UE-R according to the fourth embodiment.

FIG. 34 is a diagram for describing a switching procedure to a GO mode according to Modification Example 3.

### DESCRIPTION OF EMBODIMENTS

Hereinafter, preferred embodiments for implementing the present invention will be described with reference to the drawings. In the present embodiment, embodiments of a mobile communication system to which the present invention applies as an example will be described in detail with reference to the drawings. LTE Direct is described as LTE (D). Here, LTE (D) refers to a direct communication path between UEs which is established using an LTE communication scheme.

### 1. First Embodiment

Initially, a first embodiment to which the present invention applies will be described with reference to the drawings.

### 1.1 Outline of Mobile Communication System

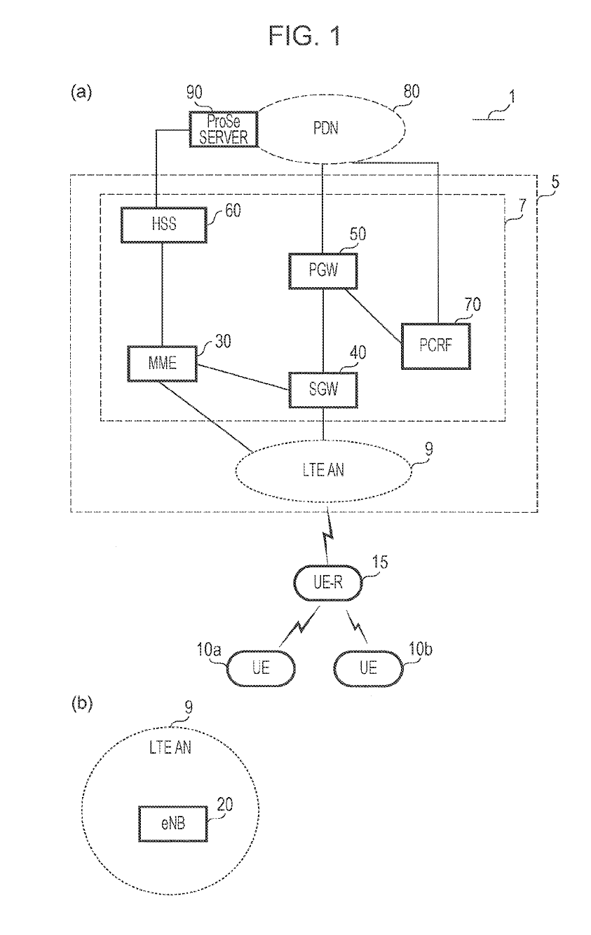

FIG. 1 is a diagram for describing the outline of a mobile communication system 1 according to the present embodiment. As illustrated in FIG. 1(a), in the mobile communication system 1, UEs (terminal devices (UE 10a and UE 10b)), a UE-R (relay terminal device) 15, and a packet data network (PDN) 80 are connected via an IP mobile communication network 5. A ProSe Server 90 is connected to the PDN 80. The UE 10a and the UE-R 15 are positioned in the proximity of each other, and may be connected through LTE (D). The UE 10b and the UE-R 15 are positioned in the proximity of each other, and may be connected through LTE (D). In a case where the UE 10a and the UE 10b are the same device and are described as the UE 10, the following description is applied to both the UE 10a and the UE 10b.

The UE-R 15 is connected to the IP mobile communication network 5, and the IP mobile communication network 5 is connected to the PDN 80.

For example, the IP mobile communication network 5 may be a network that includes a wireless access network and a core network operated by a mobile communication provider, or may be a broadband network operated by a fixed-line communication provider. Here, the broadband network may be an IP mobile communication network which is connected by an asymmetric digital subscriber line (ADSL) to provide high-speed communication through a digital line such as an optical fiber and is operated by the communication provider. The IP mobile communication network is not limited to the above-described examples, and may be a network that wirelessly accesses using Worldwide Interoperability for Microwave Access (WiMAX).

The UE 10 and the UE-R 15 are communication terminals that are connected using an access system such as LTE or WLAN, and may be connected to the IP access network by being connected through the installing of a 3GPP LTE communication interface or a WLAN communication interface.

As a specific example, there is a portable phone terminal, a smart phone, a home appliance, a tablet computer or a personal computer having another communication function.

The PDN 80 is a network that provides a network service of performing the transmission and reception of data as a packet, and is, for example, the Internet or IMS. The PDN may be a network that provides a group phone call service such as a group phone call. The PDN 80 may include an application server or a group communication application server (GCSE AS: Group Communication Service Enablers Application server).

The application server is a server which manages control information or identification information associated with an application used by the UE 10 and notifies the UE 10 or the UE-R 15 of the control information or the identification information when necessary.

The GCSE AS is a server which manages control information or identification information associated with an application for performing group communication and notifies the UE 10 or the UE-R 15 of the control information or the identification information when necessary.

The UE-R 15 is a relay terminal device, and the UE-R 15 may be connected to, but not limited to the UE 10, a plurality of terminal devices by establishing a direct communication path through LTE (D). The relay terminal device is a terminal device having a relay function, and the UE-R 15 establishes a communication path by being connected to the IP mobile communication network, and establishes to connectivity with the PDN 80.

The UE-R 15 has a relay function of relaying communication between the UE 10 and the PDN 80, and thus, the UE 10 realizes the transmission and reception of data to and from the PDN 80.

As stated above, the UE 10 and the UE-R 15 may have the same structure except for the presence of the relay function. The UE-R 15 may manage a group as a group owner (GO). The management of the group may means that members (UEs or users) of the group are registered or the members of the group are removed. The members registered in the group may perform the transmission and reception of data between the members registered in the group.

The PDN 80 is connected to an IP access network by using a wired line. For example, the PDN is constructed using an asymmetric digital subscriber line (ADSL) or an optical fiber. However, the PDN is not limited to the above-described examples, and may be a wireless access network such as Long Term Evolution (LTE), wireless LAN (WLAN), or Worldwide Interoperability for Microwave Access (WiMAX).

[1.1.1 Structure Example of IP Mobile Communication Network]

As illustrated in FIG. 1, the mobile communication system 1 includes the UE 10, the UE-R 15, the IP mobile communication network 5, and the packet data network (PDN) 80. A plurality of communication terminals such as the UE 10a and the UE 10b may be connected to the UE-R 15. These communication terminals have the same structure as that of the UE 10. A plurality of terminal devices having a relay function other than the UE-R 15 may be connected to the IP mobile communication network 5. The terminal device has the same structure as that of the UE-R, and the description thereof will be omitted for simplifying the drawings.

The IP mobile communication network 5 includes a core network 7, and a wireless access network (for example, LTE AN 9).

The core network 7 includes a mobile management entity (MME) 30, a serving gateway (SGW) 40, a PGW (access control apparatus) 50 (Packet Data Network Gateway), a home subscriber server (HSS) 60, and a policy and charging rules function (PCRF) 70.

The wireless access network is connected to the core network 7. The UE-R 15 may be wirelessly connected to the wireless access network.

As the wireless access network, an LTE access network (LTE AN 9) capable of being connected by an LTE access system may be used.

Since the respective devices and apparatuses have the same structures as those of the devices and apparatuses of the related art in the mobile communication system using an EPS, the detailed description thereof will be omitted, but the functions thereof will be briefly described. The PGW 50 is connected to the PDN 80, the SGW 40 and the PCRF 70, and delivers user data, as a gateway apparatus between the PDN 80 and the core network 7.

The SGW 40 is connected to the PGW 50, the MME 30, and the LTE AN 9, and delivers user data, as a gateway apparatus between the core network 7 and the LTE AN 9.

The MME 30 is connected to the SGW 40, the HSS 60 and the LTE AN 9, and is a position management apparatus that performs access control and position management of the UE 10 via the LTE AN 9.

The HSS 60 is connected to the Prose Server 90, the MME 30 and the SGW 40, and manages subscriber information.

The PCRF 70 is connected to the PGW 50 and the PDN 80, and manages QoS for data delivery.

The ProSe Server 90 is connected to the MME 30, and is a server apparatus that manages the establishment of a direct communication path between the communication terminals. The ProSe Server 90 and the MME 30 may be realized as a single apparatus, or may be respectively realized independent apparatuses. It has been described that the ProSe Server is included in the core network 7, but is not limited thereto, and may be included in the PDN 80 as illustrated in FIG. 1. The ProSe Server and the GCSE included in the PDN that provides the group communication service may be realized as a single apparatus.

The ProSe Server 90 may serve as a ProSe Function which is one function of the network. The ProSe Server may serve as a ProSe Function 90 which is a part of the function of a certain apparatus.

As illustrated in FIG. 1(b), the wireless access network includes an apparatus (for example, a base station apparatus or an access point apparatus) to which the UE-R 15 is connected in actuality. As the apparatus used in the connection, various apparatuses applied to the wireless access network are considered, but the LTE AN 9 includes the eNB 20 in the present embodiment. The eNB 20 is a radio base station to which the UE-R 15 is connected in the LTE access system, and the LTE AN 9 may include one or a plurality of radio base stations.

In the present specification, the UE-R 15 being connected to the wireless access network means that the UE-R is connected to the base station apparatus included in the wireless access network, and a signal or data is also transmitted and received via the base station apparatus or the access point.

For example, the UE-R 15 being connected to the LTE AN 9 means that the UE-R 15 is connected to the LTE AN via the eNB 20.

The UE 10 may establish a communication path in a group owner mode (GO mode) and a decentralized mode. In the GO mode, each UE is connected to the IP mobile communication network 5 via the UE-R 15 which is the group owner (GO). As illustrated in FIG. 1(a), in the GO mode, the UE 10a performs the transmission and reception of data via the UE-R 15. The UE 10b performs the transmission and reception of data via the UE-R 15.

In a case where the UE 10a transmits data to the UE 10b, the UE 10a transmits data to the UE 10b via the UE-R 15, the LTE AN 9, the core network 7 and the PDN 80 and then passing back through the core network 7, the LTE AN 9 and the UE-R 15 from the PDN 80. In this case, the UE-R 15 may directly transmit data from the UE 10a to the UE 10b without the LTE AN 9, the core network 7 and the PDN 80 in between.

In a case where the UE 10b transmits data to the UE 10a, the UE 10b transmits data to the UE 10a via the UE-R 15, the LTE AN 9, the core network 7 and the PDN 80 and then passing back through the core network 7, the LTE AN 9 and the UE-R 15 from the PDN 80. In this case, the UE-R 15 may directly transmit data from the UE 10b to the UE 10a without the LTE AN 9, the core network 7 and the PDN 80 in between.

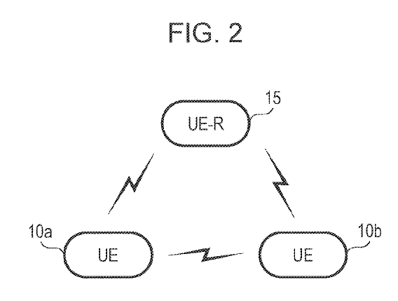

FIG. 2 illustrates an example of the transmission and reception of data in the decentralized mode according to the first embodiment. In the decentralized mode, the UE 10a and the UE 10b does not perform the transmission and reception of data via the UE-R 15 and directly performs the transmission and reception of data between the UEs. In FIG. 2, the UE 10a does not perform the transmission and reception of data via the UE-R 15 and performs direct communication with the UE 10b and/or the UE-R 15. The UE 10b performs direct communication with the UE-R 15 and/or the UE 10a. In the present embodiment, the UE-R 15 belongs to the same group as that of the UE 10a and the UE 10b, and the UE-R 15 may perform the transmission and reception of data to and from the UE 10a and the UE 10b through the direct communication path.

### 1.2 Structures of Device and Apparatus

Hereinafter, the structures of each device and apparatus will be simply described with reference to the drawings.

[1.2.1 Structure of UE]

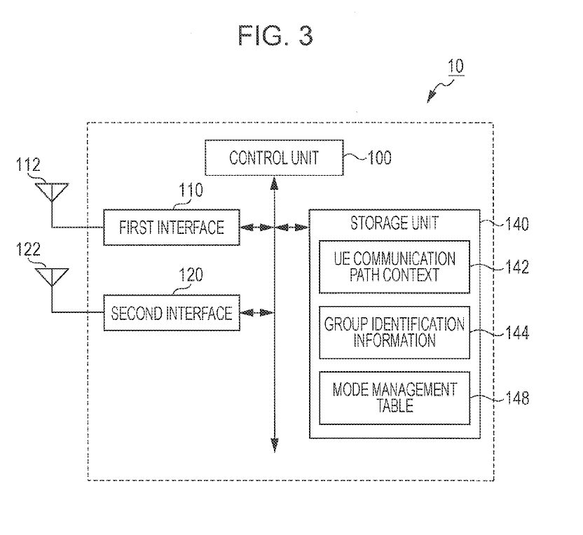

A functional structure of the UE 10 according to the present embodiment is illustrated based on FIG. 3. The UE 10 has the same structure as those of the UE 10a and the UE 10b. In the UE 10, a first interface 110, a second interface 120, and a storage unit 140 are connected to a control unit 100 through a bus.

The control unit 100 is a functional unit for controlling the UE 10. The control unit 100 realizes various processes by reading various programs and various information items stored in the storage unit 140 and executing the read programs.

The first interface 110 is a functional unit that establishes a direct communication path with another communication terminal or the UE-R 15 by an LTE access scheme to perform the transmission and reception of data through wireless communication. An external antenna 112 is connected to the first interface 110.

The UE 10 establishes a direct communication path with another UE 10 or the UE-R 15 through the first interface without the LTE base station in between, and can perform communication.

The second interface 120 is a functional unit that is connected to the eNB 20 by the LTE access scheme to establish a communication path to the PDN 80 via the core network 7 and performs the transmission and reception of data through wireless communication. An external antenna 122 is connected to the second interface 120.

The UE 10 is connected to the LTE AN 9 through the second interface 120 to establish a communication path with the PDN 80 through the core network 7, and may perform the transmission and reception of data.

Although it has been described in the drawing that the first interface 110 and the second interface 120 perform the communication through different antennas, one antenna may be used in common.

The storage unit 140 is a functional unit that stores programs or data required in various operations of the UE 10. For example, the storage unit 140 is realized using a semiconductor memory, or a hard disk drive (HDD). The storage unit 140 stores a UE communication path context 142, group identification information 144 and a mode management table 148.

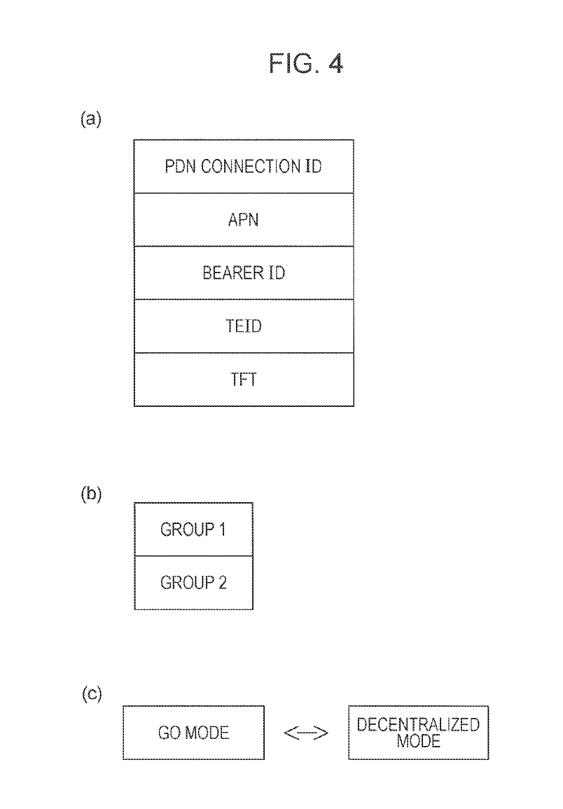

FIG. 4(a) illustrates an example of the UE communication path context 142. The UE communication path context 142 of FIG. 4(a) is an information group stored in association with a communication path established by the UE, and includes an Access Point Name (APN), a bearer ID, a PDN connection ID, a Tunnel Endpoint Identifier (TEID) and a Traffic Flow Template (TFT).

The Access Point Name (APN) is identification information used to select the PGW 50 in the IP mobile communication network 5, and is identification information associated with the PDN 80. In a case where a different PDN 80 is associated with each service such as IMS or image distribution, the APN may be used as identification information for identifying a service.

The bearer ID is information for identifying a radio bearer which is a radio communication path between the UE 10 and the UE-R 15, which is established when the UE 10 is connected to the UE-R 15. The bearer ID is information for identifying a radio bearer which is a radio communication path between the UE 10 and another UE, which is established when the UE 10 performs the direct communication with the other UE.

In a case where the UE 10 is connected to the eNB 20, the bearer ID may be information for identifying a radio bearer which is a radio communication path between the UE 10 and the eNB 20, which is established when the UE 10 is connected to the eNB 20.

The PDN connection ID is information for identifying PDN connection which is a logical path established by the UE 10 with the PGW 50.

The TEID is identification information of a tunnel communication path for delivering user data, which constitutes the PDN connection, and may be identification information of a tunnel communication path established based on a GTP protocol, a Mobile IP protocol, or a Proxy Mobile IP protocol.

The TFT is configuration information of a transmission destination defined for each application, and the UE 10 determines the transmission destination by using the TFT in a case where the transmission of data occurs in a certain application. The TFT and the bearer ID may be managed so as to be associated with each other, and may be used to determine the transmission destination of data. When the transmission destination is determined, the TFT may be configured in association with information related to communication quality, and data may be transmitted depending on the communication quality.

The UE communication path context 142 may also include UE identifier, base station identification information and service identification information. The UE identifier is an identifier for identifying the UE 10 (UE 10a or UE 10b) and the UE-R 15. The base station identification information may be information for identifying the UE-R 15, or may be information for identifying the eNB 20. The base station identification information may be obtained by combining a provider identification code for identifying the mobile communication provider that provides the communication service with a base station identification code. Accordingly, the base station identification information may be used as unique identification information in a plurality of mobile communication networks provided by a plurality of mobile communication providers.

The service identification information is information for identifying a service provided by the mobile communication provider in the IP mobile communication network 5. The service identification information may be an APN, or may be service domain identification information such as fully qualified domain name (FQDN). The service identification information is not limited to the above-described examples, and may be identification information associated with the service. The service may be a voice phone call service based on the IMS or a video distribution service, or may be a service that provides group communication. The service identification information is identification information for identifying such services.

FIG. 4(b) illustrates an example of the group identification information 144. In FIG. 4(b), the UE 10 manages group identification information items of Group 1 and Group 2. The group identification information 144 may be information for identifying a group when two or more communication terminals constitute the group and communication is performed between the groups. In a case where a plurality of contents is delivered to the group, the group identification information may be information for identifying these contents.

For example, the group identification information may be information for identifying a terminal group when a simultaneous phone call is performed between the plurality of communication terminals. Alternatively, the group identification information may be information for identifying a session for the phone call. Alternatively, when image distribution is performed to the plurality of communication terminals, the group identification information may be identification information for identifying the terminals that receive the image distribution as the group, or may be identification information for identifying the distributed image in a case where there is a plurality of images.

The group identification information may be an IP multicast address, or may be a Temporary Mobile Subscriber Identify (TMSI) which is a temporary ID which is assigned by the communication provider and is used to authenticate a user. The group identification information is not limited to the above-described examples, and may be information, such as a mail address, for identifying the group. The group identification information 144 may be included in the UE communication path context 142.

FIG. 4(c) illustrates the mode management table 148. In the mode management table 148, information indicating the GO mode or the decentralized mode is managed. In FIG. 4(c), the GO mode is managed. Here, the UE 10 may manage the GO mode depending on the establishment of the communication path in the GO mode or the switching to the GO mode. The UE 10 may manage the decentralized mode depending on the establishment of the communication path of the decentralized mode or the switching of the communication path of the decentralized mode. The mode management table 148 may be included in the UE communication path context 142.

The UE 10 may manage permission information indicating that the switching between the GO mode and the decentralized mode can be performed. Here, the UE 10 may manage permission information indicating only that the switching between the GO mode and the decentralized mode can be performed (permission). The UE 10 may manage permission information indicating that the switching between the GO mode and the decentralized mode can be performed (permission) and permission information indicating that the switching between the GO mode and the decentralized mode is not able to be performed (non-permission). The permission information indicating that the switching between the GO mode and the decentralized mode can be performed may be managed by the UE communication path context 142.

A plurality of communication terminals, but not limited to the UE 10, may be connected to the UE-R 15. The structures of these communication terminals are the same structure as that of the UE 10, and thus, the detailed description thereof will be omitted.

[1.2.2 Structure of UE-R]

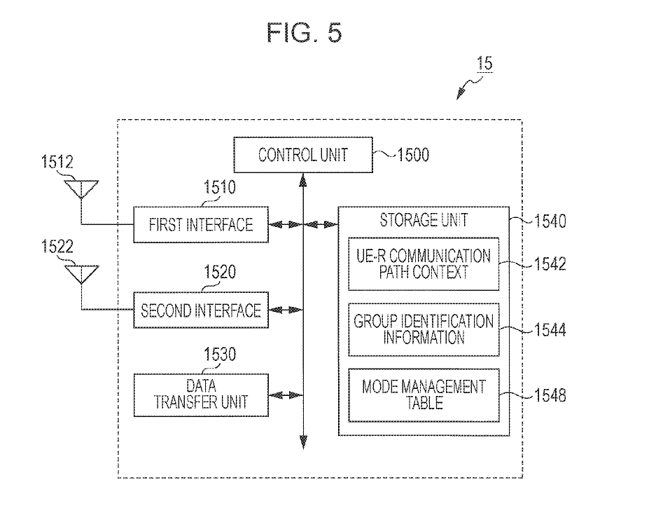

FIG. 5 illustrates a functional structure of the UE-R 15 according to the present embodiment. In the UE-R 15, a first interface 1510, a second interface 1520, a data transfer unit 1530, and a storage unit 1540 are connected to a control unit 1500 through a bus.

The control unit 1500 is a functional unit for controlling the UE-R 15. The control unit 1500 realizes various processes by reading various information items and various programs stored in the storage unit 1540 and executing the read information items and programs.

The first interface 1510 is a functional unit that establishes a direct communication path with another communication terminal such as the UE 10 by the LTE access scheme to perform the transmission and reception of data through wireless communication. An external antenna 1512 is connected to the first interface 1510.

The UE-R 15 establishes a direct communication path with another communication terminal such as the UE 10 through the first interface without the LTE base station in between, and may perform communication.

The second interface 1520 is a functional unit that is connected to the eNB 20 by the LTE access scheme, establishes a communication path to the PDN 80 through the core network 7, and performs the transmission and reception of data through wireless communication. An external antenna 1522 is connected to the second interface 1520.

The UE-R 15 is connected to the LTE AN 9 through the second interface 1520 to establish a communication path with the PDN 80 through the core network 7, and may perform the transmission and reception of data.

Although it has been described in the drawing that the first interface 1510 and the second interface 1520 perform the communication through different antennas, one antenna may be used in common.

The storage unit 1540 is a functional unit that stores programs or data required in various operations of the UE-R 15. For example, the storage unit 1540 is realized using a semiconductor memory, or a hard disk drive (HDD). The storage unit 1540 stores a UE-R communication path context 1542, group identification information 1544 and a mode management table 1548.

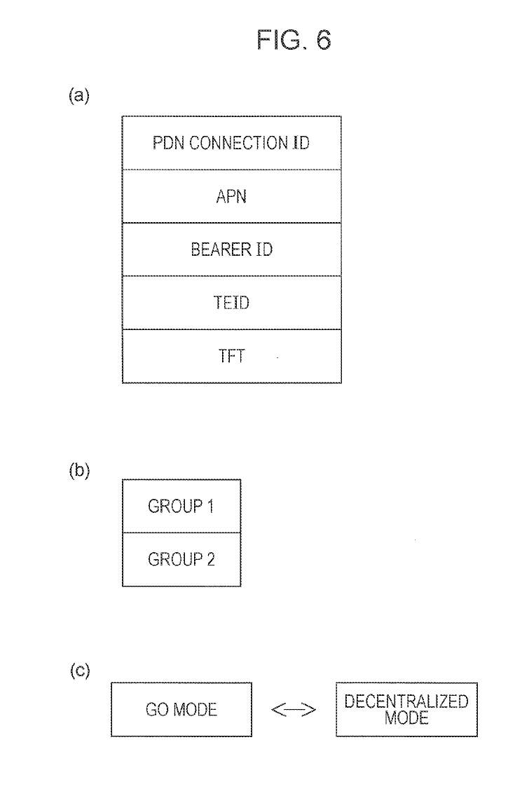

FIG. 6(a) illustrates an example of the UE-R communication path context 1542. The UE-R communication path context 1542 is an information group managed in association with a communication path established by the UE-R 15, and may include a PDN connection ID, an Access Point Name (APN), a bearer ID, a Tunnel Endpoint Identifier (TEID) and a Traffic Flow Template (TFT). The UE-R communication path context 1542 may include base station identification information and service identification information.

The PDN connection ID is information for identifying PDN connection which is a logical path established by the UE 10 with the PGW 50.

The Access Point Name (APN) is identification information used to select the PGW 50 in the IP mobile communication network 5, and is identification information associated with the PDN 80. In a case where a different PDN 80 is associated with each service such as IMS or image distribution, the APN may be used as identification information for identifying a service.

The bearer ID is information for identifying a radio bearer which is a radio communication path between the UE 10 and the UE-R 15, which is established when the UE 10 is connected to the UE-R 15. In a case where the UE 10 is connected to the eNB 20, the bearer ID may be information for identifying a radio bearer which is a radio communication path between the UE 10 and the eNB 20, which is established when the UE 10 is connected to the eNB 20.

The TEID is identification information of a tunnel communication path for delivering user data, which constitutes the PDN connection, and may be identification information of a tunnel communication path established based on a GTP protocol, a Mobile IP protocol, or a Proxy Mobile IP protocol.

The TFT is configuration information of a transmission destination defined for each application, and the UE-R 15 determines the transmission destination by using the TFT in a case where the transmission of data occurs in a certain application. The TFT and the bearer ID may be managed so as to be associated with each other, and may be used to determine the transmission destination of data. When the transmission destination is determined, the TFT may be configured in association with information related to communication quality, and data may be transmitted depending on the communication quality.

The base station identification information may be information for identifying the UE-R 15, or may be information for identifying the eNB 20. The base station identification information may be obtained by combining a provider identification code for identifying the mobile communication provider that provides the communication service with a base station identification code. Accordingly, the base station identification information may be used as unique identification information in a plurality of mobile communication networks provided by a plurality of mobile communication providers.

The service identification information is information for identifying a service provided by the mobile communication provider in the IP mobile communication network 5. The service identification information may be an APN, or may be service domain identification information such as fully qualified domain name (FQDN). The service identification information is not limited to the above-described examples, and may be identification information associated with the service. The service may be a voice phone call service based on the IMS or a video distribution service, or may be a service that provides group communication. The service identification information is identification information for identifying such services.

The UE-R communication path context 1542 may be retained for each communication path. For example, the UE-R communication path context may be retained for each of the direct communication path established with the UE 10 and the communication path which is connected to the eNB 20 and is connected to the PGW 50.

Here, the base station information of the UE-R communication path context 1542 with respect to the direct communication path may be information for identifying the UE-R 15, and the base station information of the UE-R communication path context 1542 with respect to the communication path which is connected to the eNB 20 and is connected to the PGW 50 may be information for identifying the eNB 20.

The UE-R communication path context 1542 including identification information of the UE-R 15 may be retained. The identification information of the UE-R 15 may be subscriber identification information associated with the UE-R 15 such as International Mobile Subscriber Identity (IMSI), may be an IP address assigned to the UE-R 15, or may be information such as fully qualified domain name (FQDN) associated with the UE-R 15.

The UE-R communication path context 1542 may store information for identifying the position management apparatus. The information for identifying the position management apparatus may be an IP address assigned to the position management apparatus, or may be information such as fully qualified domain name (FQDN) associated with the position management apparatus. The information for identifying the position management apparatus may be a Globally Unique MME Identifier (GMMEI) having global uniqueness, or may be Global Unique Temporary Identity (GUTI) including a Temporary Mobile Subscriber Identify (TMSI) that is a temporary ID which is used to authenticate the UE and is assigned by the provider and the GUTI.

FIG. 6(b) illustrates an example of the group identification information 1544. In FIG. 6(b), the UE-R 15 manages group identification information items of Group 1 and Group 2. The group identification information 1544 may be information for identifying a group when two or more communication terminals constitute the group and communication is performed between the groups. In a case where a plurality of contents is delivered to the group, the group identification information may be information for identifying these contents.

For example, the group identification information may be information for identifying the terminal group when a simultaneous phone call is performed between the plurality of communication terminals. Alternatively, the group identification information may be information for identifying a session for the phone call. Alternatively, when image distribution is performed to the plurality of communication terminals, the group identification information may be identification information for identifying the terminals that receives the image distribution as the group, or may be identification information for identifying the distributed image in a case where there is a plurality of images.

The group identification information may be an IP multicast address, or may be a Temporary Mobile Subscriber Identify (TMSI) which is a temporary ID which is assigned by the communication provider and is used to authenticate a user. The group identification information is not limited to the above-described examples, and may be information, such as a mail address, for identifying the group. The group identification information 1544 may be included in the UE-R communication path context 1542.

FIG. 6(c) illustrates the mode management table 1548. In the mode management table 1548, information indicating the GO mode or the decentralized mode is managed. In FIG. 6(c), the GO mode is managed. Here, the UE 10 may manage the GO mode depending on the establishment of the communication path in the GO mode or the switching to the GO mode. The UE 10 may manage the decentralized mode depending on the establishment of the communication path of the decentralized mode or the switching of the communication path of the decentralized mode. The mode management table 148 may be included in the UE-R communication path context 1542.

The UE-R 15 may manage permission information indicating that the switching between the GO mode and the decentralized mode can be performed. The UE-R 15 may manage permission information indicating only that the switching between the GO mode and the decentralized mode can be performed (permission). The UE-R 15 may manage permission information indicating that the switching between the GO mode and the decentralized mode can be performed (permission) and permission information indicating that the switching between the GO mode and the decentralized mode is not able to be performed (non-permission). The permission information indicating that the switching between the GO mode and the decentralized mode can be performed may be managed by the UE-R communication path context 1542.

The data transfer unit 1530 is a functional unit that transfers reception data from the UE 10, which is received through the first interface 1510, to the IP mobile communication network through the second interface 1520, and transfers reception data addressed to the UE 10, which is received through the second interface 1520, to the UE 10 through the first interface 1510. A plurality of communication terminals, but not limited to the UE 10, may be connected to the UE-R 15. A plurality of communication terminals having a relay function, but not limited to the UE-R 15, may be connected to the eNB 20. The structure of the communication terminal having the relay function is the same as that of the UE-R 15, and thus, the detailed description thereof will be omitted.

[1.2.3 Structure of eNB]

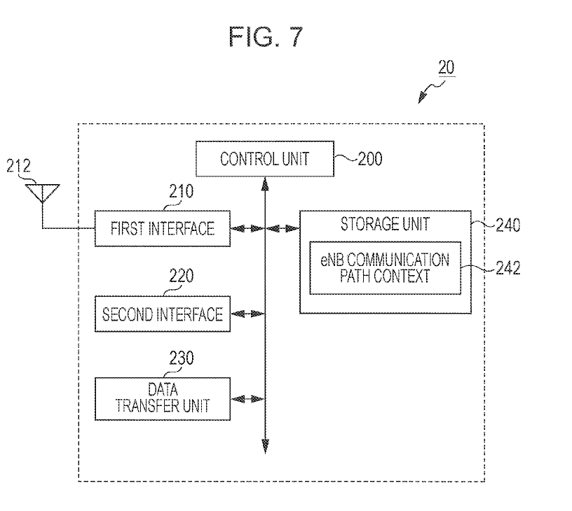

A functional structure of the eNB 20 according to the present embodiment is illustrated with reference to FIG. 7. In the eNB 20, a first interface 210, a second interface 220, a data transfer unit 230, and a storage unit 240 are connected to a control unit 200 through a bus.

The control unit 200 is a functional unit for controlling the eNB 20. The control unit 200 realizes various processes by reading various information items or various programs stored in the storage unit 240 and executing the read information items and programs.

The first interface 210 is a functional unit that establishes a radio communication path with another communication terminal such as the UE-R 15 or the UE 10 by the LTE access scheme, and performs the transmission and reception of data through wireless communication. An external antenna 212 is connected to the first interface 210.

The second interface 220 is connected to the core network to the core network 7 through wired connection. The connection to the core network 7 may be connection using Ethernet (registered trademark) or an optical fiber cable.

The storage unit 240 is a functional unit that stores programs or data required in various operations of the eNB 20. For example, the storage unit 240 is realized using a semiconductor memory, or a hard disk drive (HDD). The storage unit 240 stores an eNB communication path context 242.

The eNB communication path context 242 is an information group stored in association with a communication path established with the UE-R 15 or the UE 10, and may include an Access Point Name (APN), a bearer ID, a PDN connection ID, a Tunnel Endpoint Identifier (TEID), base station identification information, service identification information, and group identification information.

The Access Point Name (APN) is identification information used to select the PGW 50 in the IP mobile communication network 5, and is identification information associated with the PDN 80. In a case where a different PDN 80 is associated with each service such as IMS or image distribution, the APN may be used as identification information for identifying a service.

The bearer ID is information for identifying a radio bearer which is a radio communication path between the UE 10 and the UE-R 15, which is established when the UE 10 is connected to the UE-R 15. In a case where the UE 10 is connected to the eNB 20, the bearer ID may be information for identifying a radio bearer which is a radio communication path between the UE 10 and the eNB 20, which is established when the UE 10 is connected to the eNB 20.

The PDN connection ID is information for identifying PDN connection which is a logical path established by the UE 10 with the PGW 50.

The TEID is identification information of a tunnel communication path for delivering user data, which constitutes the PDN connection, and may be identification information of a tunnel communication path established based on a GTP protocol, a Mobile IP protocol, or a Proxy Mobile IP protocol.

The base station identification information may be information for identifying the UE-R 15, or may be information for identifying the eNB 20. The base station identification information may be obtained by combining a provider identification code for identifying the mobile communication provider that provides the communication service with a base station identification code. Accordingly, the base station identification information may be used as unique identification information in a plurality of mobile communication networks provided by a plurality of mobile communication providers.

The base station identification information may be an IP address assigned to the base station, or may be identification information such as fully qualified domain name (FQDN).

The information for identifying the UE-R 15 may also be an IP address assigned to the UE-R 15, or may be identification information such as fully qualified domain name (FQDN).

The service identification information is information for identifying a service provided by the mobile communication provider in the IP mobile communication network 5. The service identification information may be an APN, or may be service domain identification information such as fully qualified domain name (FQDN). The service identification information is not limited to the above-described examples, and may be identification information associated with the service. The service may be a voice phone call service based on the IMS or a video distribution service, or may be a service that provides group communication. The service identification information is identification information for identifying such services.

The group identification information may be information for identifying a group when two or more communication terminals constitute the group and communication is performed between the groups. In a case where a plurality of contents is delivered to the group, the group identification information may be information for identifying these contents.

For example, the group identification information may be information for identifying the terminal group when a simultaneous phone call is performed between the plurality of communication terminals. Alternatively, the group identification information may be information for identifying a session for the phone call. Alternatively, when image distribution is performed to the plurality of communication terminals, the group identification information may be identification information for identifying the terminals that receives the image distribution as the group, or may be identification information for identifying the distributed image in a case where there is a plurality of images.

The group identification information may be an IP multicast address, or may be a Temporary Mobile Subscriber Identify (TMSI) which is a temporary ID which is assigned by the communication provider and is used to authenticate a user. The group identification information is not limited to the above-described examples, and may be information, such as a mail address, for identifying the group.

The eNB communication path context 242 may be retained for each communication path. For example, a communication path established with the UE-R 15 and a communication path with another communication terminal having the relay function may be respectively retained.

Here, the base station information of the communication path context with respect to the direct communication path may store information for identifying the UE-R 15 and information for identifying the eNB 20.

The data transfer unit 230 is a functional unit that transfers reception data from the UE-R 15, which is received through the first interface 210, to the IP mobile communication network through the second interface 220, and transfers reception data addressed to the UE 10, which is received through the second interface 220, to the UE 10 via the UE-R 15 by the first interface 210.

[1.2.4 Structure of MME]

The MME 30 is a position management apparatus that determines whether or not to permit the service providing or communication path establishment of the UE 10.

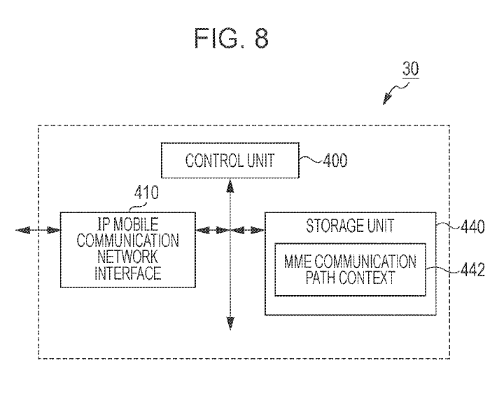

FIG. 8 illustrates a functional structure of the MME 30. In the MME 30, an IP mobile communication network interface 410, and a storage unit 440 are connected to a control unit 400 through a bus.

The control unit 400 is a functional unit for controlling the UE 10. The control unit 400 realizes various processes by reading various programs stored in the storage unit 440 and executing the read programs.

The IP mobile communication network interface 410 is a functional unit for allowing the MME 30 to be connected to the IP mobile communication network 5.

The storage unit 440 is a functional unit that stores programs or data required in various operations of the MME 30. For example, the storage unit 440 is realized using a semiconductor memory or a hard disk drive (HDD). The storage unit 440 stores an MME communication path context 442.

The MME communication path context 442 is an information group stored in association with a direct communication path established with the UE-R 15 and the UE 10, and may include an Access Point Name (APN), a bearer ID, a PDN connection ID, a Tunnel Endpoint Identifier (TEID), identification information of the terminal device, identification information of the ProSe Server, base station identification information, service identification information and group identification information.

The access point name (APN) is identification information used to select the PGW 50 in the IP mobile communication network 5, and is identification information associated with the PDN 80. In a case where a different PDN 80 is associated with each service such as IMS or image distribution, the APN may be used as identification information for identifying a service.

The bearer ID is information for identifying a radio bearer which is a radio communication path between the UE 10 and the UE-R 15, which is established when the UE 10 is connected to the UE-R 15. In a case where the UE 10 is connected to the eNB 20, the bearer ID may be information for identifying a radio bearer which is a radio communication path between the UE 10 and the eNB 20, which is established when the UE 10 is connected to the eNB 20.

The PDN connection ID is information for identifying PDN connection which is a logical path established by the UE 10 with the PGW 50.

The TEID is identification information of a tunnel communication path for delivering user data, which constitutes the PDN connection, and may be identification information of a tunnel communication path established based on a GTP protocol, a Mobile IP protocol, or a Proxy Mobile IP protocol.

The identification information of the terminal device may be information for identifying the UE-R 15. The information for identifying the UE-R 15 may be subscriber identification information associated with the UE-R 15 such as International Mobile Subscriber Identity (IMSI), may be an IP address assigned to the UE-R 15, or may be information such as fully qualified domain name (FQDN) associated with the UE-R 15. A plurality of identification information items may be stored.

The identification information of the ProSe Server may be information for identifying the ProSe Server 90. The information for identifying the ProSe Server 90 may be an IP address assigned to the ProSe Server 90, or may be information such as fully qualified domain name (FQDN) associated with the ProSe Server 90.

The MME 30 may store the identification information of the terminal device and the identification information of the ProSe Server 90 so as to associate these identification information items. Accordingly, the MME may store the ProSe Server that manages the service of the terminal device, or may store the terminal device to which the ProSe Server provides the service.

The base station identification information may be information for identifying the UE-R 15, or may be information for identifying the eNB 20. The base station identification information may be obtained by combining a provider identification code for identifying the mobile communication provider that provides the communication service with a base station identification code. Accordingly, the base station identification information may be used as unique identification information in a plurality of mobile communication networks provided by a plurality of mobile communication providers.

The service identification information is information for identifying a service provided by the mobile communication provider in the IP mobile communication network 5. The service identification information may be an APN, or may be service domain identification information such as fully qualified domain name (FQDN). The service identification information is not limited to the above-described examples, and may be identification information associated with the service. The service may be a voice phone call service based on the IMS or a video distribution service, or may be a service that provides group communication. The service identification information is identification information for identifying such services.

The group identification information may be information for identifying a group when two or more communication terminals constitute the group and communication is performed between the groups. In a case where a plurality of contents is delivered to the group, the group identification information may be information for identifying these contents.

For example, the group identification information may be information for identifying the terminal group when a simultaneous phone call is performed between the plurality of communication terminals. Alternatively, the group identification information may be information for identifying a session for the phone call. Alternatively, when image distribution is performed to the plurality of communication terminals, the group identification information may be identification information for identifying the terminals that receives the image distribution as the group, or may be identification information for identifying the distributed image in a case where there is a plurality of images.

The group identification information may be an IP multicast address, or may be a Temporary Mobile Subscriber Identify (TMSI) which is a temporary ID which is assigned by the communication provider and is used to authenticate a user. The group identification information is not limited to the above-described examples, and may be information, such as a mail address, for identifying the group.

The MME communication path context 442 may be retained for each communication path. For example, The ProSe Server communication path context may be retained for each of the communication path established by the UE 10 with the UE-R 15 and the communication path established by the UE with another communication terminal having the relay function.

Here, the base station information of the communication path context with respect to the direct communication path may store information for identifying the UE-R 15 and information for identifying the eNB 20 to which the UE-R 15 is connected.

The information group described above may be stored as an information element of Mobility Management (MM) context.

[1.2.5 Structure of ProSe Server]

The ProSe Server 90 is a server apparatus that provides a service such as the establishment of the direct communication path with the UE-R 15 or the UE 10 or the detection of the proximity terminal.

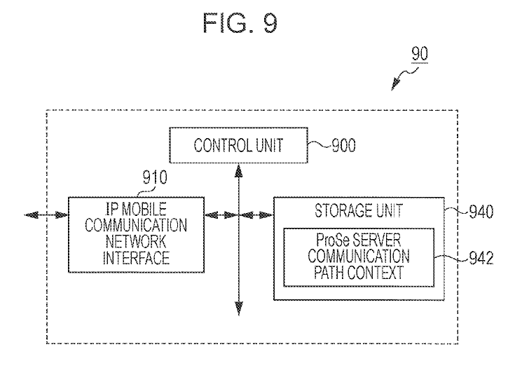

FIG. 9 illustrates a functional structure of the ProSe Server 90. In the ProSe Server 90, an IP mobile communication network interface 910, and a storage unit 940 are connected to a control unit 900 through a bus.

The control unit 900 is a functional unit for controlling the ProSe Server 90. The control unit 900 realizes various processes by reading various programs stored in the storage unit 940 and reading the read programs.

The IP mobile communication network interface 910 is a functional unit for allowing the ProSe Server 90 to be connected to the IP mobile communication network 5.

The storage unit 940 is a functional unit that stores programs or data required in various operations of the ProSe Server 90. For example, the storage unit 940 is realized using a semiconductor memory or a hard disk drive (HDD).

The storage unit 940 stores a ProSe Server communication path context 942.

The ProSe Server communication path context 942 is an information group stored in association with a direct communication path established with the UE-R 15 or the UE 10, and may include an access point name (APN), a bearer ID, a PDN connection ID, a Tunnel Endpoint Identifier (TEID), base station identification information, service identification information, and group identification information.

The access point name (APN) is identification information used to select the PGW 50 in the IP mobile communication network 5, and is identification information associated with the PDN 80. In a case where a different PDN 80 is associated with each service such as IMS or image distribution, the APN may be used as identification information for identifying a service.

The bearer ID is information for identifying a radio bearer which is a radio communication path between the UE 10 and the UE-R 15, which is established when the UE 10 is connected to the UE-R 15. In a case where the UE 10 is connected to the eNB 20, the bearer ID may be information for identifying a radio bearer which is a radio communication path between the UE 10 and the eNB 20, which is established when the UE 10 is connected to the eNB 20.

The PDN connection ID is information for identifying PDN connection which is a logical path established by the UE 10 with the PGW 50.

The TEID is identification information of a tunnel communication path for delivering user data, which constitutes the PDN connection, and may be identification information of a tunnel communication path established based on a GTP protocol, a Mobile IP protocol, or a Proxy Mobile IP protocol.

The base station identification information may be information for identifying the UE-R 15, or may be information for identifying the eNB 20. The base station identification information may be obtained by combining a provider identification code for identifying the mobile communication provider that provides the communication service with a base station identification code. Accordingly, the base station identification information may be used as unique identification information in a plurality of mobile communication networks provided by a plurality of mobile communication providers.

The service identification information is information for identifying a service provided by the mobile communication provider in the IP mobile communication network 5. The service identification information may be an APN, or may be service domain identification information such as fully qualified domain name (FQDN). The service identification information is not limited to the above-described examples, and may be identification information associated with the service. The service may be a voice phone call service based on the IMS or a video distribution service, or may be a service that provides group communication. The service identification information is identification information for identifying such services.

The group identification information may be information for identifying a group when two or more communication terminals constitute the group and communication is performed between the groups. In a case where a plurality of contents is delivered to the group, the group identification information may be information for identifying these contents.

For example, the group identification information may be information for identifying the terminal group when a simultaneous phone call is performed between the plurality of communication terminals. Alternatively, the group identification information may be information for identifying a session for the phone call. Alternatively, when image distribution is performed to the plurality of communication terminals, the group identification information may be identification information for identifying the terminals that receives the image distribution as the group, or may be identification information for identifying the distributed image in a case where there are a plurality of images.

The group identification information may be an IP multicast address, or may be a Temporary Mobile Subscriber Identify (TMSI) which is a temporary ID which is assigned by the communication provider and is used to authenticate a user. The group identification information is not limited to the above-described examples, and may be information, such as a mail address, for identifying the group.

The ProSe Server communication path context 942 may be retained for each communication path. For example, The ProSe Server communication path context 942 may be retained for each of the communication path established by the UE 10 with the UE-R 15 and the communication path established by the UE with another communication terminal having the relay function.

Here, the base station information of the communication path context with respect to the direct communication path may store information for identifying the UE-R 15 and information for identifying the eNB 20 to which the UE-R 15 is connected.

The ProSe Server 90 may retain the ProSe Server communication path context 942 including the identification information of the UE-R 15. The information for identifying the UE-R 15 may be subscriber identification information associated with the UE-R 15 such as International Mobile Subscriber Identity (IMSI), may be an IP address assigned to the UE-R 15, or may be information such as fully qualified domain name (FQDN) associated with the UE-R 15.

The ProSe Server communication path context 942 may store information for identifying the position management apparatus. The information for identifying the position management apparatus (MME 30) may be an IP address assigned to the position management apparatus, or may be information such as fully qualified domain name (FQDN) associated with the position management apparatus. The information for identifying the position management apparatus may be a Globally Unique MME Identifier (GMMEI) having global uniqueness, or may be Global Unique Temporary Identity (GUTI) including a Temporary Mobile Subscriber Identify (TMSI) that is a temporary ID which is used to authenticate the UE and is assigned by the provider and the GUTI.

The ProSe Server 90 may store the identification information of such a terminal and the identification information of the position management apparatus so as to associate these identification information items. Accordingly, the ProSe Server may perform the position management of the position management apparatus with respect to the terminal device.

The ProSe Server 90 may manage permission information for authenticating that the UE 10 or the UE-R 15 can perform the switching between the GO mode and the decentralized mode. The ProSe Server 90 may manage permission information indicating only that the switching between the GO mode and the decentralized mode can be performed (permission). The ProSe Server 90 may manage permission information indicating that the switching between the GO mode and the decentralized mode can be performed (permission) and permission information indicating that the switching between the GO mode and the decentralized mode is not able to be performed (non-permission).

### 1.3 Description of Process

Hereinafter, an example of a specific process in the above-described mobile communication system will be described.

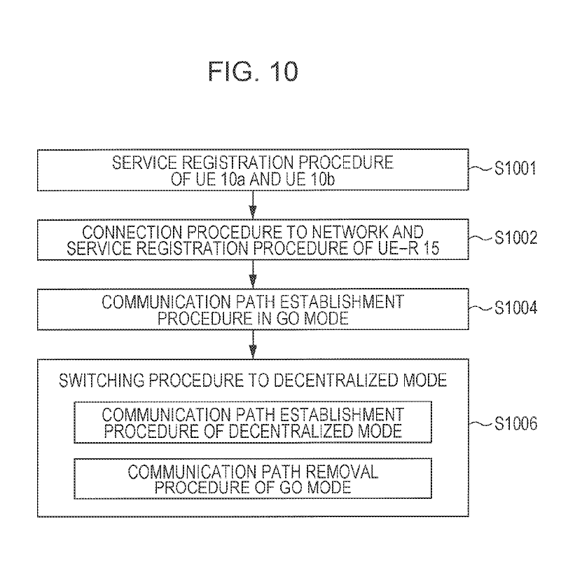

In the first embodiment, a procedure of switching from a communication path in the GO mode to a communication mode in the decentralized mode will be described. FIG. 10 illustrates a flow of primary processes in the first embodiment. In the first embodiment, the UE-R 15 initially performs a connection procedure to a network and a service registration procedure (S1002). The UE-R 15 and the UE 10 (UE 10a or UE 10b) perform a communication path establishment procedure in the GO mode (S1004). Accordingly, the UE 10 (UE 10a or UE 10b) and the UE-R 15 start the transmission and reception of data in the communication path in the GO mode. The UE 10 and the UE-R 15 perform a switching procedure to the communication path of the decentralized mode during the transmission and reception of data through the communication path of the GO mode (S1006). The switching procedure to the decentralized mode is performed by a communication path establishment procedure of the decentralized mode and a communication path removal procedure of the GO mode.

[1.3.1 Service Registration Procedure in UE]

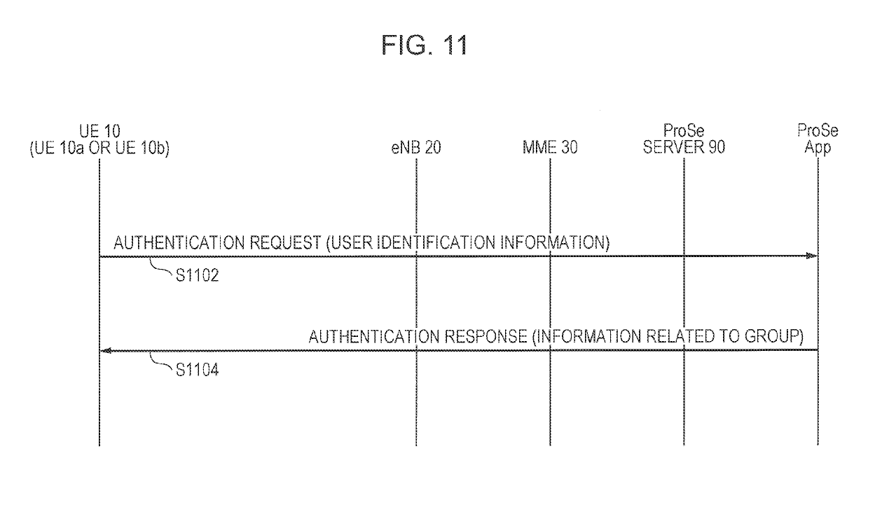

FIG. 11 illustrates a service registration procedure in the UE 10a or the UE 10b. Here, it is assumed that the UE 10a performs a service registration procedure in a ProSe application server in Application 1. The UE 10a may perform the service registration procedure not in Application 1 but in Application 2 or Application 3.

The UE 10a transmits an authentication request to the ProSe application server (S1102). The UE 10a adds user identification information to the authentication request. Here, as the user identification information, information stored in the UE 10a may be used, or information directly input to the UE 10a may be used. The UE 10a may add the user identification information and an authentication key (password) for authenticating the user to the authentication request. As the authentication key, a key previously stored in the UE 10a may be used, or a key directly input to the UE 10a may be used.

Although it has been described in the example that the UE 10a previously transmits the authentication request to the ProSe application server in a case where the UE is located within the zone of the eNB 20, the UE may transmit the authentication request to the ProSe application server in a case where the communication path of the GO mode is established or in a case where the switching of the communication path to the communication path of the GO mode is performed.

The UE may transmit the authentication request by using not the eNB 20 but another wireless communication system such as a wireless LAN or WiMAX. The UE 10a may transmit the authentication request to the ProSe application server through a cable such as a wired LAN.

The ProSe application server receives the authentication request from the UE 10a, checks that the user identification information included in the authentication request is valid, and performs the authentication. Here, in a case where the authentication key is included, the ProSe application server may check whether or not the authentication key corresponding to the user identification information is valid. After the authentication is performed, the ProSe application server extracts information related to the group from the user identification information. Here, the user may be previously registered in the group, and may perform the transmission and reception of data only within the group. As the information related to the group, there are a group identifier such as a group ID or an IP multicast address. Here, as the information related to the group, user identification information belonging to the group may be extracted.

In a case where the authentication request is received from the UE 10a, the ProSe application server may transmit authentication information to the ProSe Server 90. The ProSe Server 90 that receives the authentication information from the ProSe application server may check the authentication information, and may authenticate the UE 10a. Here, the ProSe Server 90 may authenticate that the UE 10a can perform the switching between the GO mode and the decentralized mode. The ProSe Server 90 may perform the authentication using the authentication information of the UE 10a, and then may transmit an authentication response, as a response to the authentication information from the ProSe application server. The ProSe Server 90 may add the permission information indicating that the switching between the GO mode and the decentralized mode can be performed to the response to the authentication information from the ProSe application server. The ProSe Server 90 may add the permission information indicating that the switching between the GO mode and the decentralized mode is not able to be performed to the response to the authentication information from the ProSe application server. The ProSe Server 90 does not add the permission information indicating that the switching between the GO mode and the decentralized mode can be performed to the response to the authentication information from the ProSe application server, and thus, this response may indicate that the switching between the GO mode and the decentralized mode is not able to be performed.

The ProSe application server transmits the authentication response to the UE 10a after the authentication is performed (S1104). Here, the ProSe application server adds the information related to the group to the authentication response. As the information related to the group, the group identifier such as the group ID or the IP address may be added to the authentication request. As the information related to the group, the identification information of the user belonging to the group may be added to the authentication request.

The ProSe application server may add the permission information which is notified from the ProSe Server 90 and indicates that the switching between the GO mode and the decentralized mode can be performed and is notified from the ProSe Server 90 to the authentication request. The ProSe application server may the permission information which is notified from the ProSe Server 90 and indicates that the switching between the GO mode and the decentralized mode is not able to be performed to the authentication request. The ProSe application server does not add the permission information which is notified from the ProSe Server 90 and indicates that the switching between the GO mode and the decentralized mode can be performed to the authentication request, and thus, this response may indicate that the switching between the GO mode and the decentralized mode is not able to be performed.

The UE 10a receives the authentication response from the ProSe application server, and receives the information related to the group included in the authentication response. The UE 10a may receive the permission information which is included in the authentication response and indicates that the switching between the GO mode and the decentralized mode can be performed, and may manage the permission information indicating that the switching between the GO mode and the decentralized mode can be performed. The UE 10a may receive the permission information which is included in the authentication response and indicates that the switching between the GO mode and the decentralized mode is not able to be performed, and may manage the permission information indicating that the switching between the GO mode and the decentralized mode is not able to be performed. In a case where the permission information which is included in the authentication response and indicates that the switching between the GO mode and the decentralized mode can be performed is not received, the UE 10a may manage the permission information indicating that the switching between the GO mode and the decentralized mode is not able to be performed.

Through the above-described procedure, the UE 10a can be authenticated by the ProSe application server, and can perform the transmission and reception of data in Application 1.

The UE 10a may transmit the authentication request to the ProSe Server 90 instead of transmitting the authentication request to the ProSe application server. Here, the ProSe Server 90 may authenticate the UE 10a by using the authentication information included in the authentication request. The ProSe Server 90 may authenticate that the UE 10a can perform the switching between the GO mode and the decentralized mode.

The ProSe Server 90 that receives the authentication request may transmit the authentication information to the ProSe application server. The ProSe application server that receives the authentication information from the ProSe Server 90 may check the authentication information, may perform authentication using the authentication information of the UE 10a, and then may transmit the authentication response, as the response to the authentication information from the ProSe Server 90. The ProSe application server may add the permission information indicating that the switching between the GO mode and the decentralized mode can be performed to the response to the authentication information from the ProSe Server 90. The ProSe Server 90 that receives the authentication request from the UE 10a may transmit the authentication response to the UE 10a.

Here, in a case where the ProSe Server 90 authenticates that the UE 10a can perform the switching between the GO mode and the decentralized mode, the ProSe Server may add the permission information indicating that the switching between the GO mode and the decentralized mode can be performed to the response. In a case where the ProSe Server 90 authenticates that the UE 10a is not able to perform the switching between the GO mode and the decentralized mode, the ProSe Server may add the permission information indicating that the switching between the GO mode and the decentralized mode is not able to be performed to the response. Here, in a case where the ProSe Server 90 authenticates that the UE 10a is not able to perform the switching between the GO mode and the decentralized mode, the ProSe Server does not add the permission information indicating that the switching between the GO mode and the decentralized mode can be performed to the response, and thus, this response may indicate that the switching between the GO mode and the decentralized mode is not able to be performed.

The UE 10a receives the authentication response from the ProSe Server 90. The UE 10a may receive the permission information which is included in the authentication response and indicates that the switching between the GO mode and the decentralized mode can be performed, and may manage the permission information indicating that the switching between the GO mode and the decentralized mode can be performed. Here, in a case where the permission information indicating that the switching between the GO mode and the decentralized mode is not able to be performed is received from the ProSe Server 90, the UE 10a may manage the permission information indicating that the switching between the GO mode and the decentralized mode is not able to be performed.

In a case where the permission information indicating that the switching between the GO mode and the decentralized mode can be performed is not received from the ProSe Server 90, the UE 10a may determine that the switching between the GO mode and the decentralized mode is not able to be performed, and may manage the permission information indicating that the switching between the GO mode and the decentralized mode is not able to be performed.

Meanwhile, similarly to the UE 10a, the UE 10b transmits the authentication request to the ProSe application server (S1102), and the ProSe application server authenticates the UE 10b and transmits the authentication response to the UE 10b (S1104).

The UE 10b may transmit the authentication request to the ProSe Server 90 instead of transmitting the authentication request to the ProSe application server. Here, the ProSe Server 90 may authenticate the UE 10b by using the authentication information included in the authentication request. The ProSe Server may authenticate that the switching between the GO mode and the decentralized mode can be performed.

The ProSe Server 90 that receives the authentication request may transmit the authentication information to the ProSe application server. The ProSe application server that receives the authentication information from the ProSe Server 90 may check the authentication information, may perform the authentication using the authentication information of the UE 10b, and then may transmit the authentication response, as the response to the authentication information from the ProSe Server 90. The ProSe application server may add the permission information indicating that the switching between the GO mode and the decentralized mode can be performed to the response to the authentication information from the ProSe Server 90. The ProSe Server 90 that receives the authentication request from the UE 10b may transmit the authentication response to the UE 10b.

Here, in a case where the ProSe Server 90 authenticates that the UE 10b can perform the switching between the GO mode and the decentralized mode, the ProSe Server may add the permission information indicating that the switching between the GO mode and the decentralized mode can be performed to the response. In a case where the ProSe Server 90 authenticates that the UE 10b is not able to perform the switching between the GO mode and the decentralized mode, the ProSe Server may add the permission information indicating that the switching between the GO mode and the decentralized mode is not able to be performed to the response. Here, in a case where the ProSe Server 90 authenticates that the UE 10b is not able to perform the switching between the GO mode and the decentralized mode, the ProSe Server does not add the permission information indicating that the switching between the GO mode and the decentralized mode can be performed to the response, and thus, this response may indicate that the switching between the GO mode and the decentralized mode is not able to be performed.

The UE 10b receives the authentication response from the ProSe Server 90. The UE 10b may receive the permission information which is included in the authentication response and indicates that the switching between the GO mode and the decentralized mode can be performed, and may manage the permission information indicating that the switching between the GO mode and the decentralized mode can be performed.

Here, in a case where the permission information indicating that the switching between the GO mode and the decentralized mode is not able to be performed is received from the ProSe Server 90, the UE 10b may manage the permission information indicating that the switching between the GO mode and the decentralized mode is not able to be performed.

In a case where the permission information indicating that the switching between the GO mode and the decentralized mode can be performed is not received from the ProSe Server 90, the UE 10b may determine that the switching between the GO mode and the decentralized mode is not able to be performed, and may manage the permission information indicating that the switching between the GO mode and the decentralized mode is not able to be performed.

Through the above-described procedure, the UE 10b can be authenticated by the ProSe application server, and can perform the transmission and reception of data in Application 1.

Through the above-described procedure, the UE 10a and the UE 10b may be authenticated by the ProSe application server, and may perform the transmission and reception of data in Application 1.

[1.3.2 Connection Procedure to Network and Service Registration Procedure in UE-R]

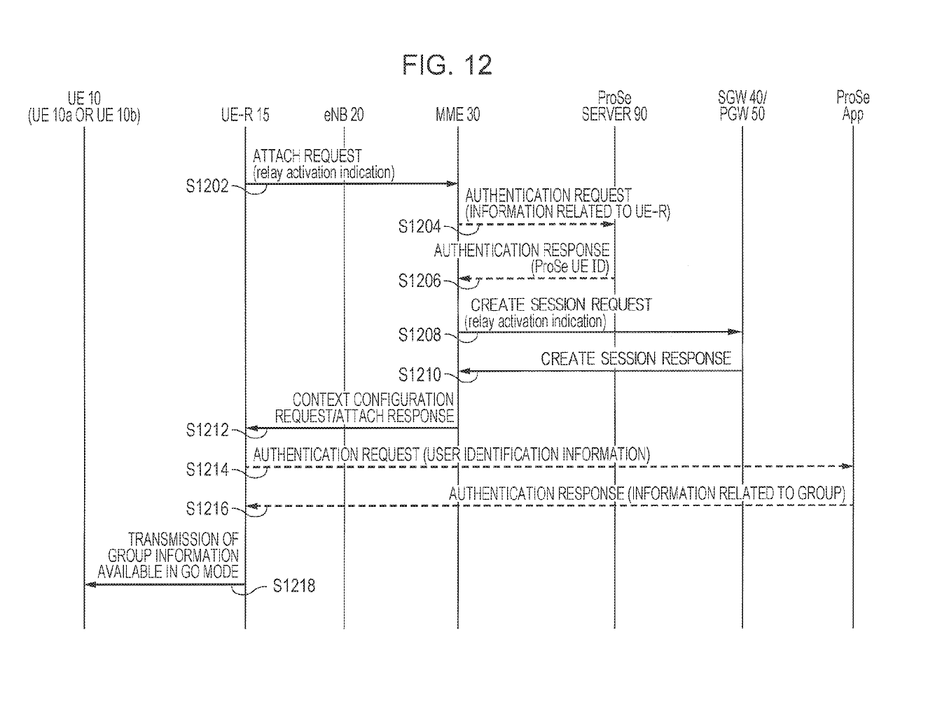

A connection procedure to the network and a service registration procedure in the UE-R 15 will be described. FIG. 12 illustrates the connection procedure to the network and the service registration procedure in the UE-R 15.

The UE-R 15 transmits an attach request to the MME 30 (S1202). Here, the UE-R 15 may a relay activation indication to the attach request. The relay activation indication is information indicating that the UE-R 15 validates relaying.

The MME 30 that receives the attach request from the UE-R 15 authenticates the UE-R 15. Here, in a case where the relay activation indication is included in the attach request, the MME 30 detects that the UE-R 15 requests the validation of the relaying. Even in a case where the relay activation indication is not included in the attach request, the MME 30 may detect that the UE-R 15 requests the validation of the relaying by using the APN included in the attach request.

In a case where the relay activation indication is not included in the attach request, the MME may authenticate the UE-R 15 by the same method as that used in the typical UE.

In a case where it is detected that the UE-R 15 requests the validation of the relaying, the MME 30 may transmit the authentication request to the ProSe Server 90 (S1204). In this case, the MME 30 adds the information related to the UE-R 15 to the authentication request. Here, the information related to the UE-R 15 is the identification information of the UE-R 15 and the information indicating that the UE-R 15 validates the relaying.

The ProSe Server 90 that receives the authentication request from the MME 30 authenticates that the UE-R 15 provides a ProSe service by using the information related to the UE-R included in the authentication request. The ProSe service means that another UE performs the proximity detection and the transmission and reception of data is directly performed between the UEs without the eNB 20 and the core network 7 in between in a case where the UE is positioned in proximity.

Here, in a case where the ProSe UE ID is managed, the ProSe Sever 90 may generate a ProSe UE ID corresponding to the UE-R 15.

The ProSe Server 90 that authenticates the UE-R 15 transmits the authentication response to the MME 30 (S1206). The authentication response includes the generated ProSe UE ID. The MME 30 receives the authentication response from the ProSe Server 90, and receives the ProSe UE ID included in the authentication response.

In a case where the MME 30 and the ProSe Server 90 are the same apparatus, the MME 30 transmits the authentication request to the ProSe Server 90 (S1204), and the ProSe Server 90 need not transmit the authentication response to the MME 30 (S1206).

In a case where the MME 30 and the ProSe Server 90 are the same apparatus, the MME 30 authenticates the UE-R 15 and generates the ProSe UE ID.

The MME 30 authenticates the UE-R 15, and then the MME 30 selects the SGW 40/PGW 50. The selection of the SGW 40/PGW 50 may be performed using the APN in a case where the APN is included in the attach request. In a case where the APN is not included in the attach request, the MME 30 may arbitrarily perform the selection.

The MME 30 may acquire a PDN address by using the APN. Here, the PDN address is an IP address assigned to the UE-R 15. In a case where the APN is not included in the attach request, the MME 30 may arbitrarily perform the determination.

Here, in a case where the APN included in the attach request is information indicating that the relaying is validated, not an IP address assigned to a single UE-R 15 but a plurality of IP addresses capable of being assigned to a plurality of UEs may be acquired as the PDN address. Here, an address block capable of assigning the plurality of IP addresses may be assigned instead of the plurality of IP addresses. For example, as the address block, only a network part of the IP address may be acquired.

Even though the APN is not included in the attach request, the MME may detect that the PDN address for the relaying is acquired by the relay activation indication. In a case where the MME detects that a communication path in the relaying is established by another information element other than the APN and the relay activation indication, the MME may detect that the PDN address for the relaying is acquired.

The MME 30 transmits a create session request to the SGW 40 (S1208). The create session request may include the relay activation indication. The communication path establishment for the relaying may be requested by the relay activation indication. In a case where the same communication path as that established by the UE of the related art is established even in the relaying, the create session request may not include the relay activation indication.

The SGW 40 that receives the create session request from the MME 30 transmits the create session request to the PGW 50. Here, in a case where the relay activation indication is included in the create session request (S1208) from the MME 30, the SGW 40 adds the relay activation indication to the create session request. Accordingly, the SGW 40 may request the communication path establishment for the relaying.

The PGW 50 that receives the create session request from the SGW 40 establishes the communication path between the SGW 40 and the PGW 50. In this case, in a case where the relay activation indication is included in the create session request, the PGW may secure the communication path for the relaying. Subsequently, the PGW 50 transmits a create session response to the SGW 40. In this case, the PGW may add control information for managing the communication path to the create session response.

Subsequently, the SGW 40 establishes the communication path between the eNB 20 and the SGW 40. In this case, in a case where the relay activation indication is included in the create session request, the SGW may secure the communication path for the relaying. Subsequently, the SGW 40 transmits the create session response to the MME 30 (S1210). In this case, the SGW may add control information for managing the communication path to the create session response.

Thereafter, the MME 30 transmits context configuration request/attach response to the UE-R 15 (S1212). The context configuration request/attach response may include the information such as the PDN address.

In a case where the attach response is received from the MME 30, the UE-R 15 may generate the TFT. The TFT is configuration information of a transmission destination defined for each application, and the UE 10a determines the transmission destination by using the TFT in a case where the transmission of data occurs in a certain application. In a case where the bearer ID is included in the attach response, the TFT and the bearer ID may be managed so as to be associated with each other, and may be used to determine the transmission destination of data. When the transmission destination is determined, the TFT may be configured in association with information related to communication quality, and data may be transmitted depending on the communication quality.

The UE-R 15 may secure the information such as the PDN address for establishing the communication path in the GO mode for the connected UE 10a or UE 10b, and may notify the UE 10a or the UE 10b of the information later.

Through the above-described procedure, the UE-R 15 can perform the transmission and reception of data via the eNB 20 and the SGW 40/PGW 50.

Subsequently, the UE-R 15 may transmit the authentication request for requesting that the relaying of ProSe is authenticated in Application 1 to the ProSe application server (S1214), and the ProSe application server may authenticate the UE-R 15 and then may transmit the authentication response to the UE-R 15 (S1216). This authentication request is the same as that transmitted from the UE 10a in the registration procedure of the ProSe application in the UE. The authentication response which is the response to the authentication is the same as that transmitted from the ProSe application server in the registration procedure of the ProSe application in the UE, and thus, the description thereof will be omitted.

The authentication request may be transmitted in a case where the transmission and reception of data are performed in Application 1 in addition to a case where the UE-R 15 functions as the relay device. That is, if the UE-R 15 merely supports the function of the relay device, the authentication request may not be transmitted.

Through the above-described procedure, the UE 10a can be authenticated by the ProSe application server, and can perform the transmission and reception of data in Application 1.

The UE-R 15 transmits group information available in the GO mode (S1218). The UE 10a and the UE 10b may detect that the group available in the GO mode in the UE-R 15 by receiving the group information available in the GO mode from the UE-R 15. Here, it is assumed that the GO mode in Group 1 is available.

[1.3.3 Communication Path establishment Procedure in GO Mode]

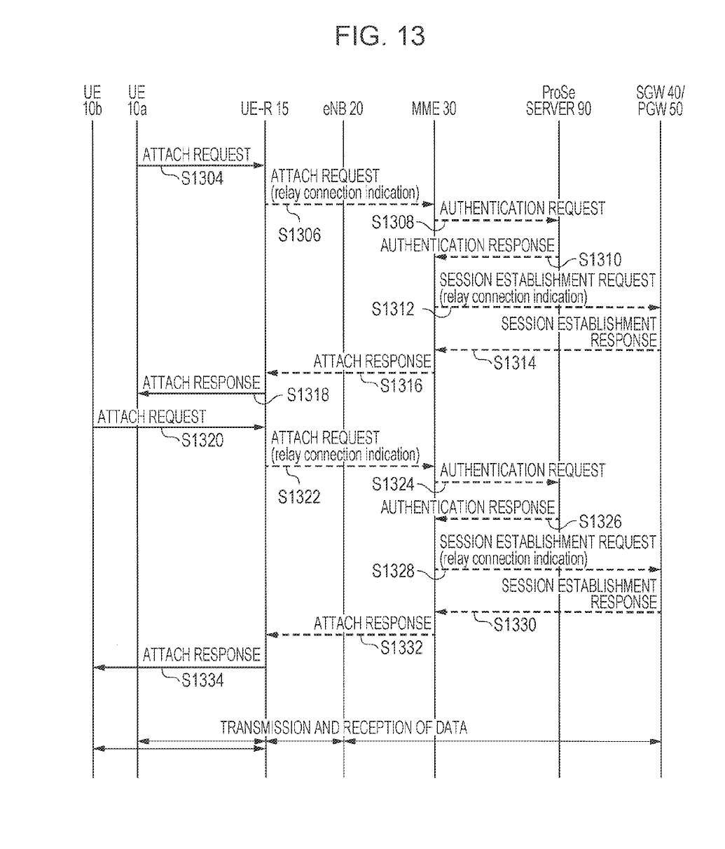

The communication path establishment procedure in the GO mode will be described. FIG. 13 illustrates the communication path establishment procedure in the GO mode.

The UE 10a transmits the attach request to the UE-R 15 (S1304). The attach request transmitted herein may include the information for identifying the group in addition to the request transmitted to the eNB 20 or the MME 30 from the UE of the related art. Here, the information for identifying the group is an identifier for identifying the group which the UE 10a participates in and can perform the transmission and reception of data, and is, for example, Group 1 or Group 2. Here, the information for identifying the group includes information for identifying the group of Group 1 corresponding to the communication path established in the GO mode.

The attach request may include the information such as the APN or an attach type. The attach request may be transmitted by the method in which the security is secured.

Here, before the attach request is transmitted to the UE-R 15, the UE 10a may perform the proximity detection in order to detect whether or not the attach request can be transmitted to the UE-R 15. Here, in the proximity detection, as the UE-R 15 can perform the direct communication, it is detected that the UE-R 15 is present in proximity. Here, there are various methods as the method of the proximity detection. However, for example, if the UE 10a transmits the control signal including the identification information of the UE-R 15 and receives the response from the UE-R 15, the UE can detect that the UE-R 15 is present in proximity. Alternatively, the UE 10a transmits a proximity detection signal through broadcasting and the UE-R 15 transmits the response including the identification information of the UE-R 15, so that the UE 10a may detect that the UE-R 15 is present in proximity.

The UE 10a may request that the core network 7 or the ProSe Server 90 performs the proximity detection. For example, the UE 10a or the UE-R 15 may previously notify the core network 7 or the ProSe Server 90 of positional information, and the core network 7 or the ProSe Server 90 may compare the positional information of the UE 10a and the positional information of the UE-R 15 in response to the inquiry from the UE 10a and may perform the proximity detection by notifying the UE 10a that the UE-R 15 is present in proximity if the UE-R is present in proximity.

Here, the UE 10a performs the proximity detection using the UE-R 15 as a target, but this UE 10a may detect the UE 10b by using the identification information of the UE 10b instead of the identification information of the UE-R 15.

Although it has been described that the UE 10a performs the proximity detection on the UE 10b or the UE-R 15, the same is true of a method in which the UE 10b performs the proximity detection on the UE 10a or the UE-R 15. The same is true of a method in which the UE-R 15 performs the proximity detection on the UE 10a or the UE 10b instead of the UE 10a or the UE 10b.

Thereafter, the UE-R 15 transmits the attach request to the MME 30 (S1306). In this case, the attach request includes a relay connection indication. The relay connection indication is information indicating that the UE such as the UE 10a or the UE 10b is connected to the UE-R 15. Here, although the relay connection indication is used as the information indicating that the UE is connected to the UE-R 15, any information element may be used as long as the information indicates that the UE is connected to the UE-R 15. The attach request may include an information element for identifying the connected UE.

The MME 30 receives the attach request from the UE-R 15. The MME 30 may receive the attach request, and may perform a process of generating the PDN address (the IP address of the UE 10a) or a PDP context parameter.

The MME 30 detects that the UE 10a is connected to the UE-R 15 by the relay connection indication included in the attach request from the UE-R 15.

In a case where it is detected that the UE 10a is connected to the UE-R 15, the MME 30 may transmit the authentication request to the ProSe Server 90 (S1308). Here, the MME 30 may add the UE identifier of the UE 10a connected to the UE-R 15 to the authentication request.

The ProSe Server 90 receives the authentication request from the MME 30. Here, the ProSe Server 90 that receives the authentication request may authenticate that the UE 10a performs ProSe, or may authenticate that the UE is connected to the core network via the UE-R 15. In a case where the ProSe Server 90 authenticates that the UE 10a performs ProSe or authenticates that the UE is connected to the core network via the UE-R 15, the ProSe Server may extract the ProSe UE ID for identifying the UE 10a capable of being used in the proximity detection of ProSe or the establishment of the direct communication path.

The ProSe Server 90 transmits the authentication response to the MME 30 (S1310), and the MME 30 receives the authentication response from the ProSe Server 90. Here, the ProSe Server 90 may notify the MME 30 of the ProSe UE ID. The MME 30 receives the authentication response from the ProSe Server 90 and detects that the UE 10a is connected to the UE-R 15. Here, the MME 30 may perform the Process for generating the PDN address (the IP address of the UE 10a) or the PDP context parameter.

The MME 30 transmits a session establishment request to the SGW 40/PGW 50 (S1312). Here, the session establishment request includes the relay connection indication. Since this request includes the relay connection indication, this request may indicate that the communication path that secures communication quality in order for the UE 10a to transmit and receive the data to the SGW 40/PGW 50 via the UE-R 15 is established.

The SGW 40/PGW 50 receives the session establishment request from the MME 30. The ProSe Server 90 detects that the UE 10a is connected to the core network via the UE-R 15 by the relay connection indication included in the session establishment request. Accordingly, the SGW 40/PGW 50 may establish the communication path for the UE 10a that secures communication quality in order for the UE 10a to transmit and receive the data via the UE-R 15.

The SGW 40/PGW 50 transmits the session establishment response to the MME 30 (S1314), and the MME 30 receives the session establishment response from the SGW 40/PGW 50. Accordingly, the MME 30 checks that the communication path through which the UE 10a is connected to the UE-R 15 to perform the transmission and reception of data is established between the PGW 50 and the SGW 30, between the SGW 30 and the eNB 20 and between the eNB 20 and the UE-R 15.

The MME 30 transmits the attach response to the UE-R 15 (S1316), and the UE-R 15 receives the attach response from the MME 30. Accordingly, the UE-R 15 secures the communication path through which the UE 10a can perform the transmission and reception of data via the UE-R 15 in the communication path between the UE-R 15 and the core network.

In a case where the attach response is received from the MME 30, the UE-R 15 may generate the TFT. Here, in a case where the bearer ID is included in the attach response, the TFT and the bearer ID may be managed so as to be associated with each other, and may be used to determine the transmission destination of data. When the transmission destination is determined, the TFT may be configured in association with information related to communication quality, and data may be transmitted depending on the communication quality.

Although the UE-R 15 transmits the attach request to the MME 30 and gains the authentication of the UE 10a, if the validation of the relay function by the UE-R 15 is previously authenticated, the authentication of the UE 10a may not be performed. That is, the UE-R 15 may not transmit the attach request to the MME 30 (S1306). In a case where the UE-R 15 does not transmit the attach request to the MME 30, the MME 30 may transmit the authentication request to the ProSe Server 90 (S1308), the ProSe Server 90 may transmit the authentication response to the MME 30 (S1310), the MME 30 may transmit the session establishment request to the SGW 40/PGW 50 (S1312), the SGW 40/PGW 50 may transmit the session establishment response to the MME 30 (S1314), and the MME 30 may transmit the attach response to the UE-R 15 (S1316).

The UE-R 15 transmits the attach response to the UE 10a (S1318), and the UE 10a receives the attach response from the UE-R 15.

Here, the UE-R 15 may receive the information such as the APN, the PDN address, the bearer ID or the PDP context parameter by the attach response from the MME 30, and may notify the UE 10a of the received information and the attach response.

Here, the UE-R 15 may previously receive the information such as the APN, the PDN address, the bearer ID or the PDP context parameter in the registration procedure to the network or the service registration procedure in the relaying, and may notify the UE 10a of the attach response.

In a case where the attach response is received from the UE-R 15, the UE 10a may generate the TFT. Here, in a case where the bearer ID is included in the attach response, the TFT and the bearer ID may be managed so as to be associated with each other, and may be used to determine the transmission destination of data. When the transmission destination is determined, the TFT may be configured in association with information related to communication quality, and data may be transmitted depending on the communication quality.

Here, in a case where only a single communication path is established, the UE may transmit the data of all the applications to the established communication path without generating the TFT.

Through the above-described procedure, the UE 10a can establish the communication path in the GO mode.

The above-described procedure is similarly performed in the UE 10b. That is, the UE 10b transmits the attach request to the UE-R 15 (S1320), the UE-R 15 transmits the attach request to the MME 30 (S1322), the MME 30 transmits the authentication request to the ProSe Server 90 (S1324), the ProSe Server 90 transmits the authentication response to the MME 30 (S1326), the MME 30 transmits the session establishment request to the SGW 40/PGW 50 (S1328), the SGW 40/PGW 50 transmits the session establishment response to the MME 30 (S1330), the MME 30 transmits the attach response to the UE-R 15 (S1332), and the UE-R 15 transmits the attach response to the UE 10b (S1334).

Similarly to the case of the UE 10a, if the validation of the relay function of the UE-R 15 is previously authenticated, the UE-R 15 may not perform the authentication of the UE 10b. That is, the UE-R 15 may not transmit the attach request to the MME 30 (S1322), the MME 30 may not transmit the authentication request to the ProSe Server 90 (S1324), the ProSe Server 90 may not transmit the authentication response to the MME 30 (S1326), the MME 30 may not transmit the session establishment request to the SGW 40/PGW 50 (S1328), the SGW 40/PGW 50 may not transmit the session establishment response to the MME 30 (S1330), and the MME 30 may not transmit the attach response to the UE-R 15 (S1332). Through the above-described procedure, the UE 10b can establish the communication path in the GO mode.

As mentioned above, the UE 10a, the UE 10b and the UE-R 15 can establish the communication path in the GO mode and can perform the transmission and reception of data.

[1.3.3.1 Management of Communication Path in GO Mode]

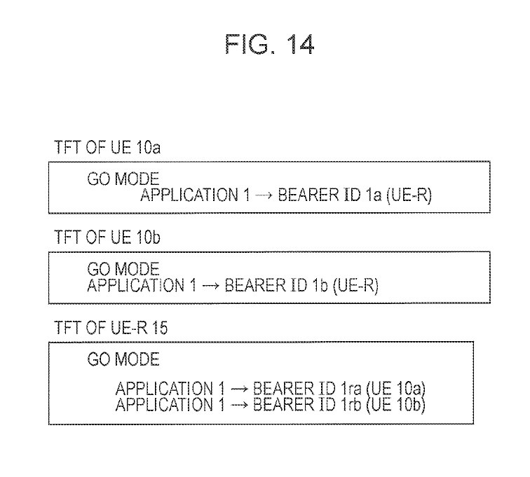

FIG. 14 illustrates an example of the TFT in the UE 10a, the UE 10b and the UE-R 15 in a case where the communication path in the GO mode is established. In FIG. 14, an example of the TFT in Application 1 is illustrated. Here, although only the example in Application 1 is illustrated, Application 2 or Application 3 may be managed in the TFT.

In the TFT of the UE 10a, Application 1 is managed in association with the bearer ID 1a. Here, the bearer ID 1a is a bearer ID indicating the communication path in the GO mode established by the UE 10a with the UE-R 15. In a case where the data is transmitted in Application 1, this bearer ID indicates that the UE 10a transmits the data to the UE-R 15. As described above, the UE 10a can perform the transmission and reception of data in Application 1 in the communication path of the GO mode by managing the TFT.

That is, in a case where the transmission and reception of data are performed in Application 1, the UE 10a transmits the data to the UE-R 15, the UE-R 15 transmits the data received from the UE 10a to the eNB 20, the eNB 20 transmits the data received from the UE-R 15 to the SGW 40, the SGW 40 transmits the data received from the eNB 20 to the PGW 50, and the PGW 50 transmits the data received from the SGW 40 to the PDN 80.

In the PDN 80, a process (routing process) of detecting the path to the UE 10b is performed, and the data is transmitted to the PGW 50 again. The PGW 50 transmits the data received from the PDN 80 to the SGW 40, the SGW 40 transmits the data received from the PGW 50 to the eNB 20, the eNB 20 transmits the data received from the SGW 40 to the UE-R 15, and the UE-R 15 transmits the data received from the eNB 20 to the UE 10b.

In the TFT of the UE 10b, Application 1 is managed in association with a bearer ID 1b. Here, the bearer ID 1b is a bearer ID indicating the communication path established by the UE 10b with the UE-R 15, and indicates that the UE 10b transmits the data to the UE-R 15 in a case where the data is transmitted in Application 1. As described above, the UE 10b can perform the transmission and reception of data in Application 1 in the communication path of the GO mode by managing the TFT.

That is, in a case where the transmission and reception of data are performed in Application 1, the UE 10b transmits the data to the UE-R 15, the UE-R 15 transmits the data received from the UE 10b to the eNB 20, the eNB 20 transmits the data received from the UE-R 15 to the SGW 40, the SGW 40 transmits the data received from the eNB 20 to the PGW 50, and the PGW 50 transmits the data received from the SGW 40 to the PDN 80.

In the PDN 80, the process (routing process) of detecting the path to the UE 10a is performed, and the data is transmitted to the PGW 50 again. The PGW 50 transmits the data received from the PDN 80 to the SGW 40, the SGW 40 transmits the data received from the PGW 50 to the eNB 20, the eNB 20 transmits the data received from the SGW 40 to the UE-R 15, and the UE-R 15 transmits the data received from the eNB 20 to the UE 10a.

A bearer ID 1ra is a bearer ID indicating the communication path established by the UE-R 15 with the UE 10a, and indicates that the UE-R 15 transmits the data to the UE 10a in a case where the data is transmitted in Application 1. A bearer ID 1rb is a bearer ID indicating the communication path established by the UE-R 15 with the UE 10b, and indicates that the UE-R 15 transmits the data to the UE 10b in a case where the data is transmitted in Application 1. As described above, the UE-R 15 can perform the transmission and reception of data in Application 1 in the communication path of the GO mode by managing the TFT. That is, the UE-R 15 transmits the data to the UE 10a and the UE 10b in a case where the transmission and reception of data are performed in Application 1.

[1.3.4 Switching Procedure to Decentralized Mode]

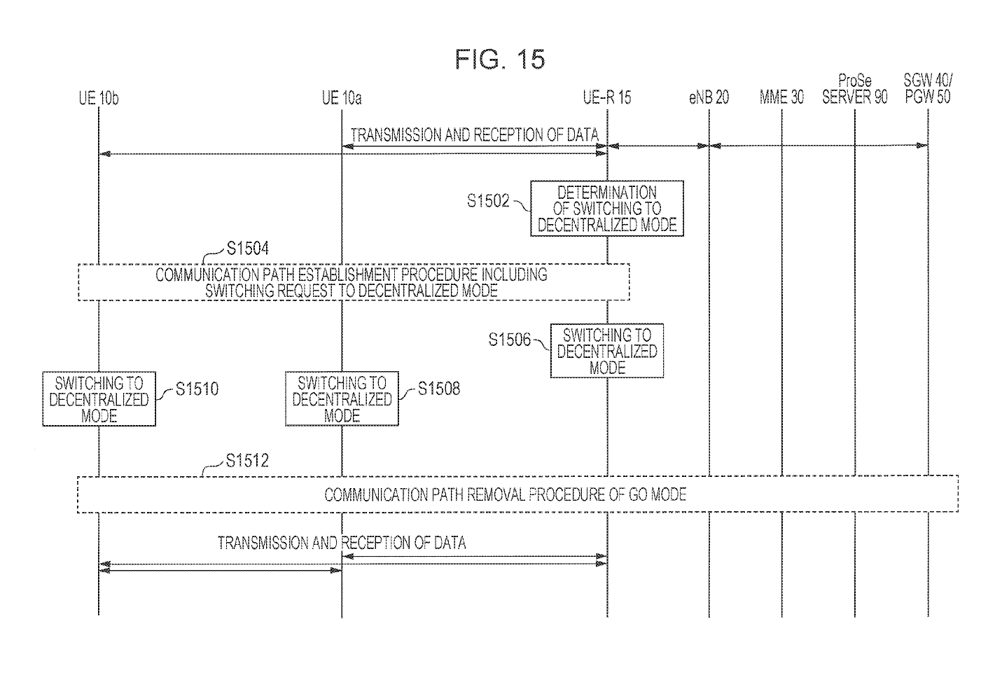

A switching procedure to a decentralized mode will be described. FIG. 15 illustrates the switching procedure to the decentralized mode. The switching to the decentralized mode is performed during the transmission and reception of data in the communication path of the GO mode.

The UE-R 15 determines the switching to the decentralized mode (S1502). For example, the determination of the switching to the decentralized mode may be performed by detecting that the member of the group is present in proximity. That is, the switching may be determined by detecting that the UE 10a and the UE 10b are present in proximity.

The determination of the switching to the decentralized mode may be performed by detecting that the UE-R 15 is not present within the zone of the eNB 20 and is not able to maintain the connection to the core network.

[1.3.4.1 Communication Path Establishment Procedure including Switching Request to Decentralized Mode]

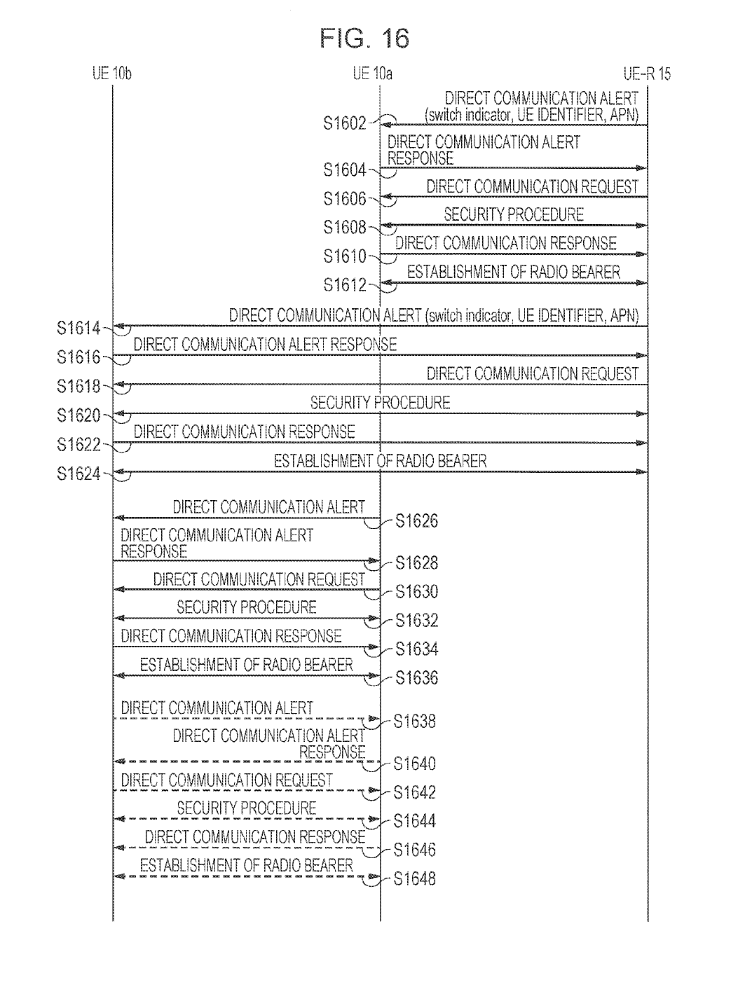

Subsequently, the UE-R 15 performs the communication path establishment procedure including the switching request to the decentralized mode (S1504). FIG. 16 illustrates an example of the communication path establishment procedure including the switching request to the decentralized mode. Any procedure may be performed instead of the present procedure as long as the communication path establishment procedure including the switching request to the decentralized mode is performed.

Initially, the UE-R 15 transmits a direct communication alert to the UE 10a (S1602). Here, the direct communication alert includes a switch indicator indicating the switching request to the decentralized mode. Any indicator may be used instead of the switch indicator as long as the indicator indicating the switching request to the decentralized mode is used.

Although it has been described in the present procedure that the switch indicator is added to the direct communication alert, another message may be used instead of the direct communication alert.

Although it has been described in the present procedure that the switch indicator is included in one message indicating the communication path establishment of the decentralized mode, and thus, this message indicates that the switching to the communication path of the decentralized mode is performed, the UE-R 15 may transmit a switching request message to the decentralized mode to the UE 10a and may notify the UE 10a of the switching to the communication path of the decentralized mode before the communication path establishment procedure of the decentralized mode is performed.

The UE-R 15 may add the UE identifier to the direct communication alert. Since the UE-R 15 adds the UE identifier to the direct communication alert, this alert may indicate the transmission and reception of data which is a target of a switching source and is associated with the UE identifier in the communication path of the GO mode, and the UE-R may perform the switching. For example, in a case where the UE-R adds the UE identifier indicating the UE 10b to the direct communication alert, the UE-R 15 may inform the UE 10a of the transmission and reception of data to and from the UE 10b and may switch the transmission and reception of data to and from the UE 10b. Although it has been described that the UE identifier is added to the direct communication alert, another message may be used instead of the direct communication alert.

The UE-R 15 may add the APN to the direct communication alert. Since the UE-R 15 adds the APN to the direct communication alert, this alert may indicate the transmission and reception of data in the communication path of the GO mode in the APN, and the UE-R may switch the communication path of the GO mode corresponding to the APN. Although it has been described in this example that the APN is added to the direct communication alert, another message may be used instead of the direct communication alert.

The UE-R 15 may add the PDN connection identifier to the direct communication alert. Since the UE-R 15 adds the PDN connection identifier to the direct communication alert, this alert may indicate the transmission and reception of data in the communication path of the GO mode corresponding to the PDN connection identifier, and the UE-R may switch the communication path of the GO mode corresponding to the PDN connection identifier. Although it has been described in this example that the PDN connection identifier is added to the direct communication alert, another message may be used instead of the direct communication alert.

In a case where the direct communication alert does not include the UE identifier, the APN or the PDN connection identifier, it may be detected that the communication path of all data items transmitted and received in the communication path of the GO mode is switched to the communication path of the decentralized mode.

The UE 10a receives the direct communication alert from the UE-R 15. The UE 10a detects that the switching from the communication path of the GO mode to the communication path of the decentralized mode is performed by the switch indicator included in the direct communication alert.

In a case where the UE identifier is added to the direct communication alert, the UE detects that the transmission and reception of data in the GO mode corresponding to the UE identifier are switched. In a case where the APN is added to the direct communication alert, the UE detects that the transmission and reception of data in the GO mode corresponding to the APN are switched. In a case where the PDN connection identifier is added to the direct communication alert, the UE detects that the transmission and reception of data in the GO mode corresponding to the PDN connection identifier are switched.

The UE 10a that detects the switching to the communication path of the decentralized mode transmits a direct communication alert response to the UE-R 15 (S1604), and the UE-R 15 receives the direct communication alert response from the UE 10a. The UE-R 15 detects that the UE 10a detects the switching to the communication path of the decentralized mode by this response.

Subsequently, the UE-R 15 transmits the direct communication request in order to establish the communication path of the decentralized mode with the UE 10a (S1606). Here, the direct communication request includes a direct communication ID indicating that the communication path of the decentralized mode and an IP address of the UE-R 15 for performing the transmission and reception of data in the decentralized mode. The UE 10a receives the direct communication request from the UE-R 15, and manages the direct communication ID or the IP address of the UE-R 15 included in the direct communication request.

Thereafter, the UE 10a performs a security procedure in order to perform the transmission and reception of data to and from the UE-R 15 (S1608). The security procedure is performed such that the transmission and reception of data between the UE 10a and the UE-R 15 are not intercepted from another UE or UE-R. For example, a security key is exchanged between the UE 10a and the UE-R 15, and thus, communication interception can be prevented.

There are various methods as the method of exchanging the security key, and there is a method in which the UE 10a and the UE-R 15 respectively exchange public keys as in a public key encryption method. Here, the UE-R 15 transmits a public key R to the UE 10a, and the UE-R 15 receives the public key R from the UE 10a. The UE 10a transmits a public key A to the UE-R, and the UE-R 15 receives the public key A from the UE 10a.

A transmission side (UE-R 15 or UE 10a) encrypts the data by using the public key and transmits the encrypted data, and a reception side (UE 10a or UE-R 15) decodes the transmission of the data encrypted using the public key by using a single private key capable of decoding the transmission of the encrypted data, and can prevent the communication interception from another UE other than the UE 10a or the UE-R 15. In the security procedure, the UE 10a may notify the UE-R 15 of an encryption method in addition to the encrypted key. The UE-R 15 may notify the UE 10a of the encryption method in addition to the encrypted key.

The UE 10a detects that the security procedure is completed, transmits a direct communication response (S1610), and the UE-R 15 receives the direct communication response from the UE 10a. The direct communication response includes the direct communication ID or the IP address of the UE 10a.

The UE-R 15 receives the direct communication response, and checks that the direct communication path is established in the UE 10a. The UE-R 15 manages the IP address of the UE 10a or the direct communication ID in the communication path of the decentralized mode included in the direct communication response.

Thereafter, the UE-R 15 and the UE 10a establish the radio bearer (S1612). In the establishment of the radio bearer, the UE-R 15 notifies of a communication resource for performing the transmission and reception of data in the communication path of the decentralized mode. For example, the communication resource is information related to frequency or information related to time.

Through the above-described procedure, the UE-R 15 can notify the UE 10a of the switching to the communication path of the decentralized mode, and the UE-R 15 and the UE 10a can establish the communication path of the decentralized mode.

Subsequently, the UE-R 15 performs the communication path establishment procedure including the switching request to the communication path of the decentralized mode together with the UE 10b. The communication path establishment procedure including the switching request to the decentralized mode with the UE 10b, which is performed by the UE-R 15 is the same as the communication path establishment procedure including the switching request to the decentralized mode with the UE 10a, which is performed by the UE-R 15. That is, the UE-R 15 transmits the direct communication alert to the UE 10b (S1614), the UE 10b receives the direct communication alert from the UE-R 15, the UE 10b transmits the direct communication alert response to the UE-R 15 (S1616), the UE-R 15 receives the direct communication alert response from the UE 10b, the UE-R 15 transmits the direct communication request to the UE 10b (S1618), the UE 10b receives the direct communication request from the UE-R 15, the UE 10b and the UE-R 15 perform the security procedure (S1620), the UE 10b transmits the direct communication response to the UE-R 15 (S1622), the UE-R 15 receives the direct communication response from the UE 10b, and the UE-R 15 and the UE 10b establish the radio bearer (S1624).

Through the above-described procedure, the UE-R 15 may notify the UE 10b of the switching to the communication path of the decentralized mode, and the UE-R 15 and the UE 10a may establish the communication path of the decentralized mode.

The UE 10a that receives the switching request to the communication path of the decentralized mode establishes the communication path of the decentralized mode with the UE 10b. Initially, the UE 10a transmits the direct communication alert to the UE 10b (S1626), and the UE 10b receives the direct communication alert from the UE 10a. The UE 10b detects that the UE 10a requests the direct communication, and the UE 10b transmits the direct communication alert response to the UE 10a (S1628).

The UE 10a receives the direct communication alert response from the UE 10b, and detects that the communication path of the decentralized mode can be established. Subsequently, the UE 10a transmits the direct communication request to the UE 10b (S1630). Here, the direct communication request includes the direct communication ID indicating that the communication path of the decentralized mode or the IP address of the UE 10a for performing the transmission and reception of data in the decentralized mode. The UE 10b receives the direct communication request from the UE 10a, and manages the direct communication ID or the IP address of the UE 10a included in the direct communication request.

The UE 10b and the UE 10a perform the security procedure (S1632). Since the security procedure can use the same method as that in the security procedure (S1608) performed by the UE-R 15 and the UE 10a, the detailed description thereof will be omitted. Here, the UE 10a transmits the public key A to the UE 10b, and the UE 10b receives the public key A from the UE 10a. The UE 10b transmits the public key B to the UE 10a, and the UE 10a receives the public key B from the UE 10b. The UE 10a may notify the UE 10b of the encryption method in addition to the public key. The UE 10b may notify the UE 10a of the encryption method in addition to the public key.

The UE 10b detects that the security procedure is completed, transmits the direct communication response to the UE 10a (S1634), and the UE 10a receives the direct communication response from the UE 10b. The direct communication response includes the direct communication ID or the IP address of the UE 10b.

Subsequently, the UE 10a and the UE 10b establish the radio bearer (S1636). In the establishment of the radio bearer, the UE 10a notifies the UE 10b of the communication resource for performing the transmission and reception of data in the communication path of the decentralized mode. For example, the communication resource is information related to frequency or information related to time.

Through the above-described procedure, the UE 10a and the UE 10b can establish the communication path of the decentralized mode.

The UE 10b that receives the switching request to the communication path of the decentralized mode may perform the procedure of establishing the communication path of the decentralized mode with the UE 10a. In a case where the UE 10b detects that the communication path of the decentralized mode with the UE 10a is established by receiving the direct communication alert from the UE 10a, the UE 10b may not perform the communication path establishment procedure of the decentralized mode with the UE 10a.

The procedure in which the UE 10b establishes the communication path of the decentralized mode with the UE 10a is the same as the procedure in which the UE 10a establishes the communication path of the decentralized mode with the UE 10b.

That is, the UE 10b transmits the direct communication alert to the UE 10a (S1638), the UE 10a transmits the direct communication alert response to the UE 10b (S1640), the UE 10b transmits the direct communication request to the UE 10a (S1642), the UE 10a and the UE 10b perform the security procedure (S1644), the UE 10a transmits the direct communication response to the UE 10b (S1646), and the UE 10b and the UE 10a establish the radio bearer (S1648).

Through the above-described procedure, the UE 10b and the UE 10a can establish the communication path of the decentralized mode.

As described above, the communication path of the decentralized mode can be respectively established between the UE-R 15, the UE 10a and the UE 10b.

The description is continued by referring back to FIG. 15. The UE-R 15 detects that the communication path of the decentralized mode with the UE 10a is established, detects that the communication path of the decentralized mode with the UE 10b is established, and switches to the communication path of the decentralized mode (S1506). Here, the UE-R 15 may switch only the communication path for the transmission and reception of data in the GO mode indicated by the UE identifier, the APN or the PDN connection identifier notified to the UE 10a or the UE 10b to the communication path of the decentralized mode.

The UE 10a detects that the communication path of the decentralized mode with the UE-R 15 is established, detects that the communication path of the decentralized mode with the UE 10b is established, and switches to the communication path of the decentralized mode (S1508). Here, the UE 10a may switch only the transmission and reception of data in the GO mode indicated by the UE identifier, the APN or the PDN connection identifier notified from the UE-R 15 to the communication path of the decentralized mode.

The UE 10b detects that the communication path of the decentralized mode with the UE-R 15 is established, detects that the communication path of the decentralized mode with the UE 10a is established, and switches to the communication path of the decentralized mode (S1510). Here, the UE 10b may switch only the transmission and reception of data in the GO mode indicated by the UE identifier, the APN or the PDN connection identifier notified from the UE-R 15 to the communication path of the decentralized mode.

Subsequently, the UE 10a and the UE 10b remove the communication path of the GO mode (S1512). In a case where the communication path of the GO mode may be maintained, these UEs may maintain the communication path of the GO mode, and may not perform the communication path removal procedure of the GO mode.

[1.3.4.2 Communication Path Removal Procedure of GO Mode]

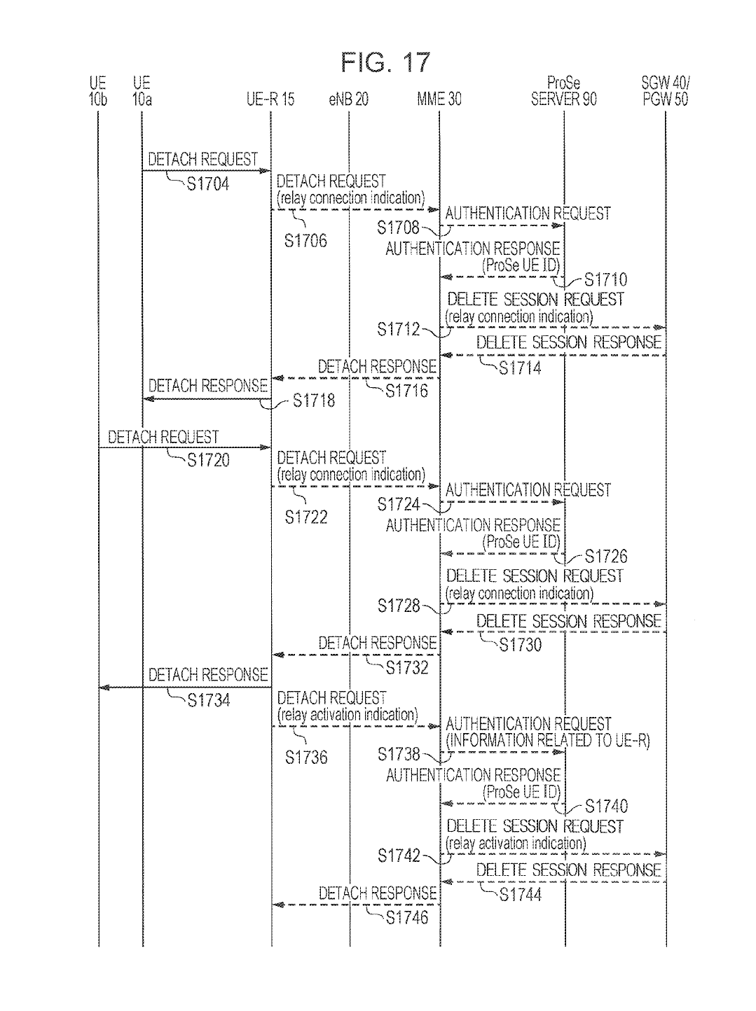

The communication path removal procedure of the GO mode will be described. FIG. 17 illustrates an example of the communication path removal procedure of the GO mode. Any procedure may be performed instead of the present procedure as long as the communication path removal procedure of the GO mode is performed. The UE 10a transmits a detach request to the UE-R 15 (S1704). The detach request transmitted herein may include the information for identifying the group in addition to the request transmitted to the eNB 20 or the MME 30 from the UE of the related art.

Thereafter, the UE-R 15 transmits the detach request to the MME 30 (S1706). In this case, the detach request includes a relay connection indication. The relay connection indication is information indicating that the UE such as the UE 10a or the UE 10b is disconnected from the UE-R 15. Here, although the relay connection indication is used as the information indicating that the UE is disconnected from the UE-R 15, any information element may be used as long as the information indicates that the UE is disconnected from the UE-R 15. The detach request may include an information element for identifying the disconnected UE.

The MME 30 receives the detach request from the UE-R 15. The MME 30 may receive the detach request, and may perform a process of removing the PDN address (the IP address of the UE 10a) or a PDP context parameter.

The MME 30 detects that the UE 10a is disconnected from the UE-R 15 by the relay connection indication included in the detach request from the UE-R 15.

In a case where it is detected that the UE 10a is disconnected from the UE-R 15, the MME 30 may transmit the authentication request to the ProSe Server 90 (S1708). Here, the MME 30 may add the UE identifier of the UE 10a connected to the UE-R 15 to the authentication request.

The ProSe Server 90 receives the authentication request from the MME 30. Here, the ProSe Server 90 that receives the authentication request may authenticate that the UE 10a performs ProSe, or may authenticate that the UE is connected to the core network via the UE-R 15. In a case where the ProSe Server 90 authenticates that the UE 10a performs ProSe or authenticates that the UE is connected to the core network via the UE-R 15, the ProSe Server may extract the ProSe UE ID for identifying the UE 10a.

The ProSe Server 90 transmits the authentication response to the MME 30 (S1710), and the MME 30 receives the authentication response from the ProSe Server 90. Here, the ProSe Server 90 may notify the MME 30 of the ProSe UE ID. The MME 30 receives the authentication response from the ProSe Server 90, and detects that the UE 10a is disconnected from the UE-R 15. The MME 30 may perform a process of removing the PDN address (the IP address of the UE 10a) or a PDP context parameter.

The MME 30 transmits a delete session request to the SGW 40/PGW 50 (S1712). Here, the delete session request includes the relay connection indication. Since this request includes the relay connection indication, this request may indicate that the communication path that secures communication quality in order for the UE 10a to transmit and receive the data to the SGW 40/PGW 50 via the UE-R 15 is established.

The SGW 40/PGW 50 receives the delete session request from the MME 30. The ProSe Server 90 detects that the UE 10a is disconnected from the core network via the UE-R 15 by the relay connection indication included in the delete session request. Accordingly, since the UE 10a does not transmit and receive the data via the UE-R 15, the SGW 40/PGW 50 may re-establish the communication path.

The SGW 40/PGW 50 transmits a delete session response to the MME 30 (S1714), and the MME 30 receives the session establishment response from the SGW 40/PGW 50. Accordingly, the MME 30 checks that the communication path through which the UE 10a is connected to the UE-R 15 to perform the transmission and reception of data is removed between the PGW 50 and the SGW 30, between the SGW 30 and the eNB 20 and between the eNB 20 and the UE-R 15.

The MME 30 transmits a detach response to the UE-R 15 (S1716), and the UE-R 15 receives the detach response from the MME 30.

In a case where the detach response is received from the MME 30, the UE-R 15 may remove the TFT for the communication path in the GO mode. Here, in a case where the bearer ID is included in the detach response, the UE-R may remove the TFT associated with the bearer ID.

Although the UE-R 15 transmits the detach request to the MME 30 (S1706) and gains the authentication of the disconnection of the UE 10a, the authentication for the UE 10a may not be performed.

That is, the UE-R 15 may not transmit the detach request to the MME 30 (S1706). In a case where the UE-R 15 does not transmit the detach request to the MME 30, the MME 30 may not transmit the authentication request to the ProSe Server 90 (S1708), the ProSe Server 90 may not transmit the authentication response to the MME 30 (S1710), the MME 30 may not transmit the delete session request to the SGW 40/PGW 50 (S1712), the SGW 40/PGW 50 may not transmit the delete session response to the MME 30 (S1714), and the MME 30 may not transmit the detach response to the UE-R 15 (S1716).

The UE-R 15 transmits the detach response to the UE 10a (S1718), and the UE 10a receives the detach response from the UE-R 15.

In a case where the detach response is received from the UE-R 15, the UE 10a may remove the TFT. Here, in a case where the bearer ID is included in the detach response, the UE-R may remove the TFT associated with the bearer ID.

Through the above-described procedure, the UE 10a can remove the communication path of the GO mode.

The above-described procedure is similarly performed in the UE 10b. That is, the UE 10b transmits the detach request to the UE-R 15 (S1720), the UE-R 15 transmits the detach request to the MME 30 (S1722), the MME 30 transmits the authentication request to the ProSe Server 90 (S1724), the ProSe Server 90 transmits the authentication response to the MME 30 (S1726), the MME 30 transmits the delete session request to the SGW 40/PGW 50 (S1728), the SGW 40/PGW 50 transmits the session removal response to the MME 30 (S1730), the MME 30 transmits the detach response to the UE-R 15 (S1732), and the UE-R 15 transmits the detach response to the UE 10b.

Similarly to the case of the UE 10a, the UE-R 15 may not perform the authentication of the UE 10b. That is, the UE-R 15 does not transmit the detach request to the MME 30 (S1722), the MME 30 may not transmit the authentication request to the ProSe Server 90 (S1724), the ProSe Server 90 may not transmit the authentication response to the MME 30 (S1726), the MME 30 may not transmit the delete session request to the SGW 40/PGW 50 (S1728), the SGW 40/PGW 50 may not transmit the delete session response to the MME 30 (S1730), and the MME 30 may not transmit the detach response to the UE-R 15 (S1732). Through the above-described procedure, the UE 10b can remove the communication path of the GO mode.

As described above, the UE 10a, the UE 10b and the UE-R 15 can remove the communication path of the GO mode.

[1.3.4.3 Management of Communication Path of Decentralized Mode]

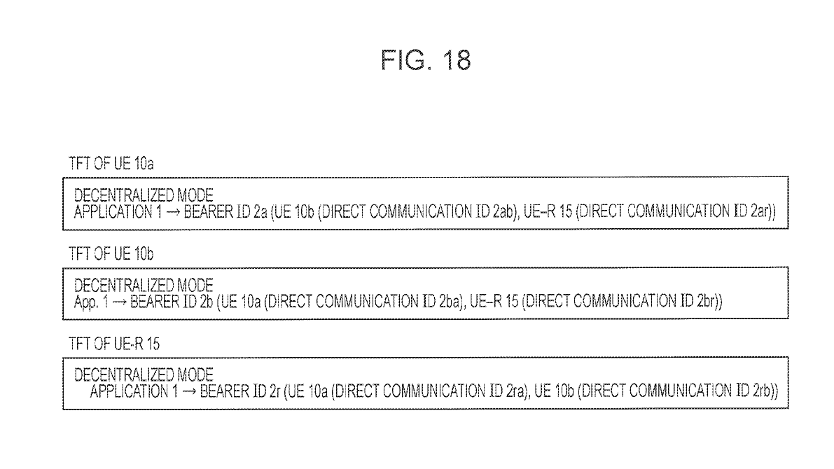

FIG. 18 illustrates an example of the TFT in the UE 10a, the UE 10b and the UE-R 15 in a case where the communication path in the decentralized mode is established. In FIG. 18, an example of the TFT in Application 1 is illustrated. Here, although only the example in Application 1 is illustrated, Application 2 or Application 3 may be managed in the TFT.

In the TFT of the UE 10a, Application 1 is managed in association with a bearer ID 2a. Here, the bearer ID 2a is a bearer ID indicating the communication path in the decentralized mode established by the UE 10a with the UE 10b and the UE-R 15. The bearer ID 2a is managed in association with the a direct communication ID 2ab with the UE 10b and a direct communication ID 2ar with the UE-R 15.

In a case where the data is transmitted in Application 1, this bearer ID indicates that the UE 10a transmits the data to the UE 10b and the UE-R 15. As described above, the UE 10a can perform the transmission and reception of data in Application 1 in the communication path of the decentralized mode by managing the TFT.

That is, in a case where the transmission and reception of data are performed in Application 1, the UE 10a transmits the data to the UE 10b and the UE-R 15.

In the TFT of the UE 10b, Application 1 is managed in association with a bearer ID 2b. Here, the bearer ID 2b is a bearer ID indicating the communication path in the decentralized mode established by the UE 10b with the UE 10a and the UE-R 15. The bearer ID 2b is managed in association with the a direct communication ID 2ba with the UE 10a and a direct communication ID 2br with the UE-R 15.

In a case where the data is transmitted in Application 1, this bearer ID indicates that the UE 10b transmits the data to the UE 10a and the UE-R 15. As described above, the UE 10b can perform the transmission and reception of data in Application 1 in the communication path of the decentralized mode by managing the TFT.

That is, in a case where the transmission and reception of data are performed in Application 1, the UE 10b transmits the data to the UE 10a and the UE-R 15.

In the TFT of the UE-R 15, Application 1 is managed in association with a bearer ID 2r. Here, the bearer ID 2r is a bearer ID indicating the communication path established by the UE-R 15 with the UE 10a and the UE 10b. The bearer ID 2r is managed in association with the a direct communication ID 2ra with the UE 10a and a direct communication ID 2rb with the UE-R 15.

In a case where the data is transmitted in Application 1, this bearer ID indicates that the UE-R 15 transmits the data to the UE 10a and the UE 10b. As described above, the UE-R 15 can perform the transmission and reception of data in Application 1 in the communication path of the decentralized mode by managing the TFT. That is, in a case where the transmission and reception of data are performed in Application 1, the UE-R 15 transmits the data to the UE 10a and the UE 10b.

As mentioned above, the UE 10a, the UE 10b and the UE-R 15 can switch from the transmission and reception of data in the communication path of the GO mode to the transmission and reception of data in the communication path of the decentralized mode.

### 1.4 Modification Example 1

Although it has been described in the first embodiment that the switching to the communication path to the communication path of the decentralized mode is performed through the communication path establishment procedure including the switching request to the decentralized mode, the switching procedure may be performed in the communication path removal procedure of the GO mode including the switching request to the decentralized mode after the communication path of the decentralized mode is established.

The structure of the communication system can be the same as that of the first embodiment, and thus, the detailed description thereof will be omitted. The structures of the respective devices and apparatuses of the communication system are the same as those of the first embodiment, and thus the detailed description thereof will be omitted. The UE 10a and the UE 10b previously perform the registration procedure of the ProSe application and the method of performing this procedure can be the same as that of the first embodiment, and thus, the description thereof will be omitted. The UE-R 15 previously performs the connection procedure to the network and the service registration procedure and the methods of performing these procedures can be the same as those of the first embodiment, and thus, the description thereof will be omitted. The method in which the UE 10a and the UE 10b perform the communication path establishment of the GO mode can be the same as that of the first embodiment, and thus, the detailed description thereof will be omitted.

[1.4.1 Switching Procedure to Decentralized Mode]

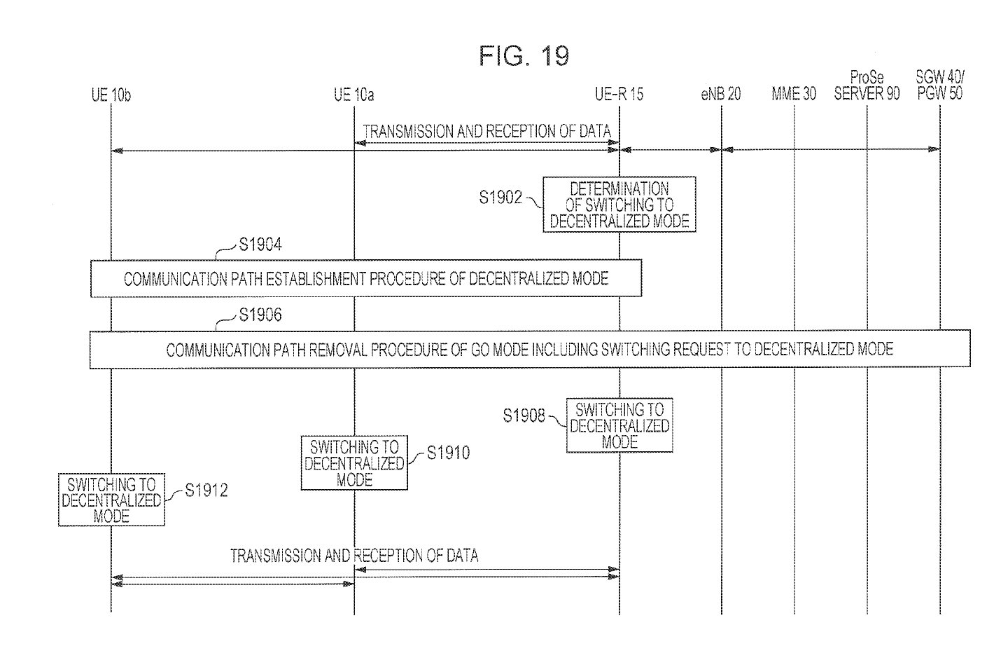

FIG. 19 illustrates a switching procedure to the decentralized mode according to Modification Example 1. The UE-R 15 determines the switching to the decentralized mode (S1902). For example, the determination of the switching to the decentralized mode may be performed by detecting that the member of the group is present in proximity. That is, the switching may be determined by detecting that the UE 10a and the UE 10b are present in proximity. The determination of the switching to the decentralized mode may be performed by detecting that the UE-R 15 is not present within the zone of the eNB 20 and is not able to maintain the connection to the core network.

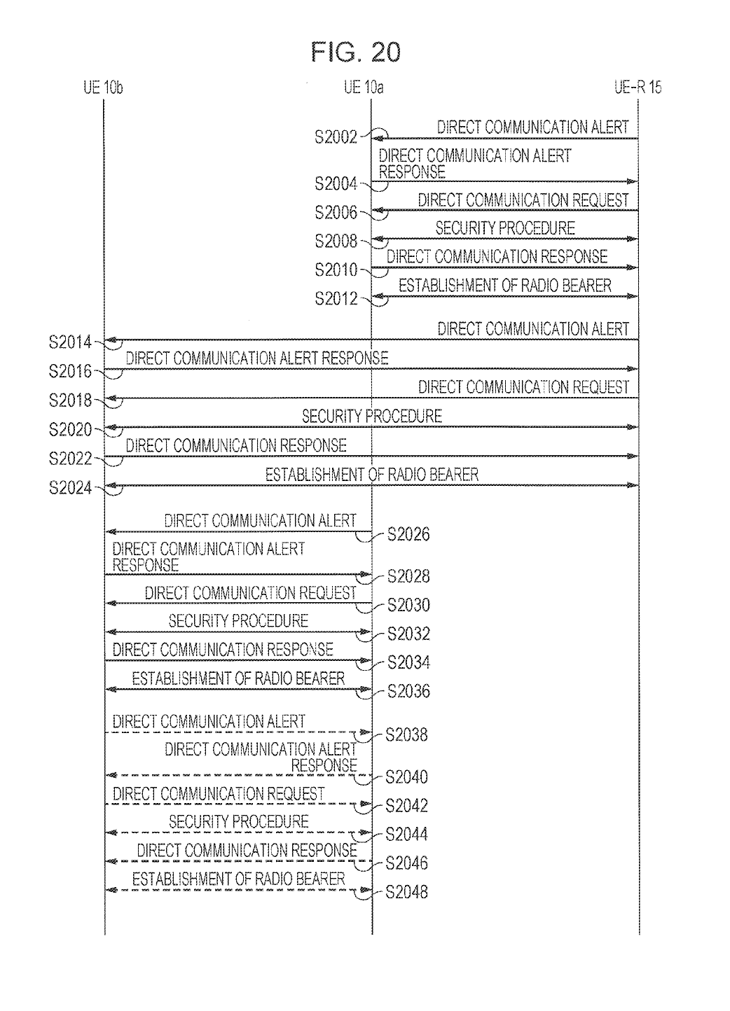

Subsequently, the UE 10a and the UE 10b perform communication path establishment procedure in the decentralized mode (S1904). FIG. 20 illustrates an example of the communication path establishment procedure of the decentralized mode. Any procedure may be performed instead of the present procedure as long as the communication path establishment procedure of the decentralized mode is performed.

Initially, the UE-R 15 transmits the direct communication alert to the UE 10a (S2002). The UE 10a receives the direct communication alert, and checks that this UE is present in the proximity of the UE-R 15.

Subsequently, the UE 10a transmits the direct communication alert response to the UE-R 15 (S2004), and the UE-R 15 receives the direct communication alert response from the UE 10a. The UE-R 15 detects that the UE 10a is present in proximity by this response.

Subsequently, the UE-R 15 transmits the direct communication request to the UE 10a in order to establish the communication path of the decentralized mode with the UE 10a (S2006). Here, the direct communication request includes a direct communication ID indicating that the communication path of the decentralized mode and an IP address of the UE-R 15 for performing the transmission and reception of data in the decentralized mode. The direct communication request may include the APN or the PDN connection identifier. The UE 10a receives the direct communication request from the UE-R 15, and manages the direct communication ID or the IP address of the UE-R 15 included in the direct communication request. The UE 10a may manage the APN or the PDN connection identifier.

Thereafter, the UE 10a performs a security procedure in order to perform the transmission and reception of data to and from the UE-R 15 (S2008). The security procedure is performed such that the transmission and reception of data between the UE 10a and the UE-R 15 are not intercepted from another UE or UE-R. For example, a security key is exchanged between the UE 10a and the UE-R 15, and thus, communication interception can be prevented. The method of exchanging the security key can be the same as the method described in the first embodiment, and thus, the detailed description thereof will be omitted.

The UE 10a detects that the security procedure is completed, transmits a direct communication response (S2010), and the UE-R 15 receives the direct communication response from the UE 10a. The direct communication response includes the direct communication ID or the IP address of the UE 10a.

The UE-R 15 receives the direct communication response, and checks that the direct communication path is established in the UE 10a. The UE-R 15 manages the IP address of the UE 10a or the direct communication ID in the communication path of the decentralized mode included in the direct communication response.

Subsequently, the UE-R 15 and the UE 10a establish the radio bearer (S2012). In the establishment of the radio bearer, the UE-R 15 notifies the UE 10a of the communication resource for performing the transmission and reception of data in the communication path of the decentralized mode. For example, the communication resource is information related to frequency or information related to time.

Through the above-described procedure, the UE-R 15 can establish the communication path of the decentralized mode with the UE 10a.

Subsequently, the UE-R 15 performs the communication path establishment procedure of the decentralized mode with the UE 10b. The communication path establishment procedure of the decentralized mode performed by the UE-R 15 with the UE 10b is the same as the communication path establishment procedure of the decentralized mode performed by the UE-R 15 with the UE 10a. That is, the UE-R 15 transmits the direct communication alert to the UE 10b (S2014), the UE 10b receives the direct communication alert from the UE-R 15, the UE 10b transmits the direct communication alert response to the UE-R 15 (S2016), the UE-R 15 receives the direct communication alert response from the UE 10b, the UE-R 15 transmits the direct communication request to the UE 10b (S2018), the UE 10b receives the direct communication request from the UE-R 15, the UE 10b and the UE-R 15 perform the security procedure (S2020), the UE 10b transmits the direct communication response to the UE-R 15 (S2022), the UE-R 15 receives the direct communication response from the UE 10b, and the UE-R 15 and the UE 10b establish the radio bearer (S2024).

Through the above-described procedure, the UE-R 15 can establish the communication path of the decentralized mode with the UE 10b.

The UE 10a that establishes the communication path of the decentralized mode with the UE-R 15 establishes the communication path of the decentralized mode with the UE 10b. Initially, the UE 10a transmits the direct communication alert to the UE 10b (S2026), and the UE 10b receives the direct communication alert from the UE 10a. The UE 10b detects that the UE 10a requests the direct communication, and the UE 10b transmits the direct communication alert response to the UE 10a (S2028).

The UE 10a receives the direct communication alert response from the UE 10b, and detects that the communication path of the decentralized mode can be established. Subsequently, the UE 10a transmits the direct communication request to the UE 10b (S2030). Here, the direct communication request includes the direct communication ID indicating that the communication path of the decentralized mode or the IP address of the UE 10a for performing the transmission and reception of data in the decentralized mode. The direct communication request may include the APN or the PDN connection identifier. The UE 10b receives the direct communication request from the UE 10a, and manages the direct communication ID or the IP address of the UE 10a included in the direct communication request. The UE 10b may manage the APN or the PDN connection identifier.

The UE 10b and the UE 10a perform the security procedure (S2032). Since the security procedure can use the same method as that in the security procedure (S2008) performed by the UE-R 15 and the UE 10a, the detailed description thereof will be omitted.

The UE 10b detects that the security procedure is completed, transmits a direct communication response (S2034), and the UE 10a receives the direct communication response from the UE 10b. The direct communication response includes the direct communication ID or the IP address of the UE 10b.

Subsequently, the UE 10a and the UE 10b establish the radio bearer (S2036). In the establishment of the radio bearer, the UE 10a notifies the UE 10b of the communication resource for performing the transmission and reception of data in the communication path of the decentralized mode. For example, the communication resource is information related to frequency or information related to time.

Through the above-described procedure, the UE 10a and the UE 10b can establish the communication path of the decentralized mode.

The UE 10b may perform the procedure of establishing the communication path of the decentralized mode with the UE 10a. In a case where the UE 10b detects that the communication path of the decentralized mode with the UE 10a is established by receiving the direct communication alert from the UE 10a, the UE 10b may not perform the communication path establishment procedure of the decentralized mode with the UE 10a.

The procedure in which the UE 10b establishes the communication path of the decentralized mode with the UE 10a is the same as the procedure in which the UE 10a establishes the communication path of the decentralized mode with the UE 10b.

That is, the UE 10b transmits the direct communication alert to the UE 10a (S2038), the UE 10a transmits the direct communication alert response to the UE 10b (S2040), the UE 10b transmits the direct communication request to the UE 10a (S2042), the UE 10a and the UE 10b perform the security procedure (S2044), the UE 10a transmits the direct communication response to the UE 10b (S2046), and the UE 10b and the UE 10a establish the radio bearer (S2048).

Through the above-described procedure, the UE 10b and the UE 10a can establish the communication path of the decentralized mode.

[1.4.2 Communication Path Removal Procedure of GO Mode including Switching Request to Decentralized Mode]

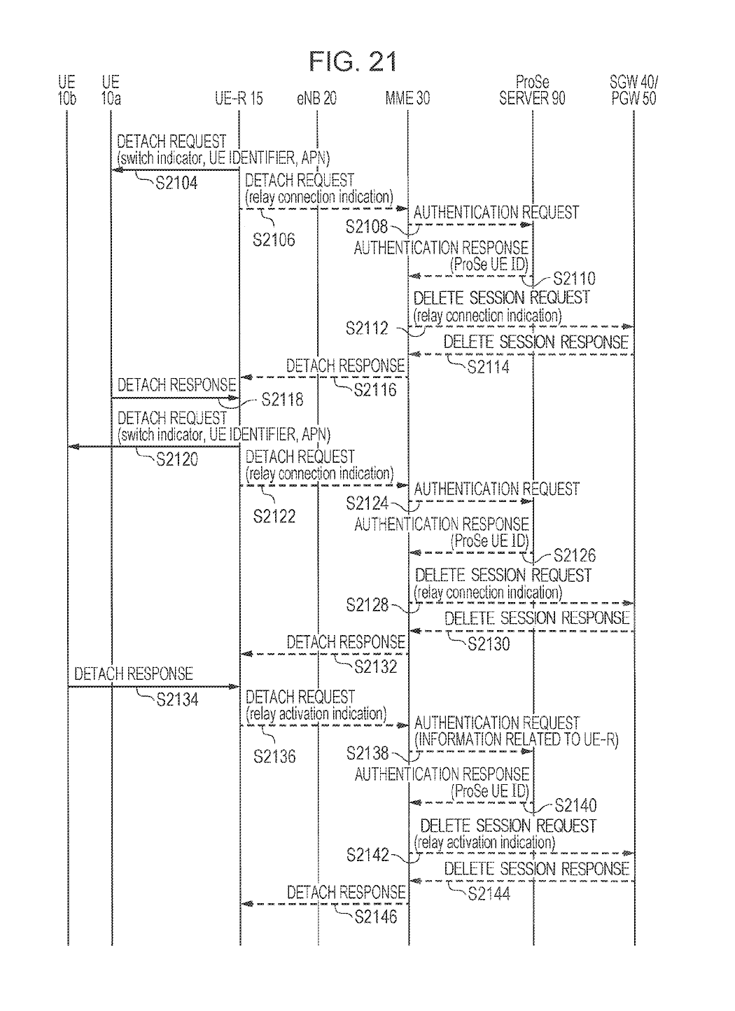

The communication path removal procedure of the GO mode including the switching request to the decentralized mode will be described. FIG. 21 illustrates an example of the communication path removal procedure of the GO mode including the switching request to the decentralized mode. Any procedure may be performed instead of the present procedure as long as the communication path establishment procedure including the switching request to the GO mode is performed.

The UE-R 15 transmits a detach request to the UE 10a (S2104). Here, the detach request includes the switch indicator indicating the switching request to the decentralized mode. Any indicator may be used instead of the switch indicator as long as the indicator indicating the switching request to the decentralized mode is used.

Although it has been described in this example that the switch indicator is added to the detach request, another message may be used instead of the detach request. Although it has been described in the present procedure that the switch indicator is included in one message indicating the communication path removal procedure of the GO mode, and thus, this message indicates that the switching to the communication path of the decentralized mode is performed, the UE-R 15 may transmit a switching request message to the decentralized mode to the UE 10a and may notify the UE 10a of the switching to the communication path of the decentralized mode before the communication path removal procedure of the GO mode is performed.

The UE-R 15 may add the UE identifier to the detach request. Since the UE-R 15 adds the UE identifier to the detach request, this request may indicate the transmission and reception of data which is a target of a switching source and is associated with the UE identifier in the communication path of the GO mode, and the UE-R may perform the switching. For example, in a case where the UE-R adds the UE identifier indicating the UE 10b to the detach request, the UE-R 15 may inform the UE 10a of the transmission and reception of data to and from the UE 10b and may switch the transmission and reception of data to and from the UE 10b. Although it has been described in this example that the UE identifier is added to the detach request, another message may be used instead of the detach request.

The UE-R 15 may add the APN to the detach request. Since the UE-R 15 adds the APN to the detach request, this request may indicate the transmission and reception of data in the communication path of the GO mode established by the APN, and the UE-R may switch the communication path of the GO mode corresponding to the APN. Although it has been described in this example that the APN is added to the detach request, another message may be used instead of the detach request.

The UE-R 15 may add the PDN connection identifier to the detach request. Since the UE-R 15 adds the PDN connection identifier to the detach request, this request may indicate the transmission and reception of data in the communication path of the GO mode corresponding to the PDN connection identifier, and the UE-R may switch the communication path of the GO mode corresponding to the PDN connection identifier. Although it has been described in this example that the PDN connection identifier is added to the detach request, another message may be used instead of the detach request.

In a case where the UE identifier, the APN and the PDN connection identifier are not included in the detach request, the UE-R detects that the communication path for all the data items transmitted and received in the communication path of the GO mode is switched to the communication path of the decentralized mode.

In a case where the detach request is received from the UE-R 15, the UE 10a may remove the TFT corresponding to the communication path of the GO mode. Here, in a case where the bearer ID is included in the detach response, the UE-R may remove the TFT associated with the bearer ID.

Thereafter, the UE-R 15 transmits the detach request to the MME 30 (S2106). In this case, the detach request includes a relay connection indication. Here, if the detach request is information indicating that the UE is disconnected from the UE-R 15, the detach request is not necessarily the relay connection indication, and may be any information element. The detach request may include an information element for identifying the disconnected UE.

The MME 30 receives the detach request from the UE-R 15. The MME 30 may receive the detach request, and may perform a process of removing the PDN address (the IP address of the UE 10a) or a PDP context parameter.

The MME 30 detects that the UE is disconnected from the UE-R 15 by the relay connection indication included in the detach request from the UE-R 15.

In a case where it is detected that the UE 10a is disconnected from the UE-R 15, the MME 30 may transmit the authentication request to the ProSe Server 90 (S2108). Here, the MME 30 may add the UE identifier of the UE 10a connected to the UE-R 15 to the authentication request.

The ProSe Server 90 receives the authentication request from the MME 30. Here, the ProSe Server 90 that receives the authentication request may authenticate that the UE 10a performs ProSe, or may authenticate that the UE is connected to the core network via the UE-R 15. In a case where the ProSe Server 90 authenticates that the UE 10a performs ProSe or authenticates that the UE is connected to the core network via the UE-R 15, the ProSe Server may extract the ProSe UE ID for identifying the UE 10a.

The ProSe Server 90 transmits the authentication response to the MME 30 (S2110), and the MME 30 receives the authentication response from the ProSe Server 90. Here, the ProSe Server 90 may notify the MME 30 of the ProSe UE ID. The MME 30 receives the authentication response from the ProSe Server 90, and detects that the UE 10a is disconnected from the UE-R 15. The MME 30 may perform a process of removing the PDN address (the IP address of the UE 10a) or a PDP context parameter.

The MME 30 transmits a session removal request to the SGW 40/PGW 50 (S2112). Here, the session removal request includes the relay connection indication. Since this request includes the relay connection indication, this request may indicate that the communication path that secures communication quality in order for the UE 10a to transmit and receive the data to the SGW 40/PGW 50 via the UE-R 15 is established.

The SGW 40/PGW 50 receives the session removal request from the MME 30. The ProSe Server 90 detects that the UE 10a is disconnected from the core network via the UE-R 15 by the relay connection indication included in the session removal request. Accordingly, since the UE 10a does not transmit and receive the data via the UE-R 15, the SGW 40/PGW 50 may re-establish the communication path.

The SGW 40/PGW 50 transmits a session removal response to the MME 30 (S2114), and the MME 30 receives the session establishment response from the SGW 40/PGW 50. Accordingly, the MME 30 checks that the communication path through which the UE 10a is connected to the UE-R 15 to perform the transmission and reception of data is removed between the PGW 50 and the SGW 30, between the SGW 30 and the eNB 20 and between the eNB 20 and the UE-R 15.

The MME 30 transmits a detach response to the UE-R 15 (S2116), and the UE-R 15 receives the detach response from the MME 30.

In a case where the detach response is received from the MME 30, the UE-R 15 may remove the TFT for the communication path in the GO mode. Here, in a case where the bearer ID is included in the detach response, the UE-R may remove the TFT associated with the bearer ID.

Although the UE-R 15 transmits the detach request to the MME 30 and gains the authentication of the disconnection of the UE 10a, the authentication for the UE 10a may not be performed.

That is, the UE-R 15 may not transmit the detach request to the MME 30 (S2106). In a case where the UE-R 15 does not transmit the detach request to the MME 30, the MME 30 may not transmit the authentication request to the ProSe Server 90 (S2108), the ProSe Server 90 may not transmit the authentication response to the MME 30 (S2110), the MME 30 may not transmit the session removal request to the SGW 40/PGW 50 (S2112), the SGW 40/PGW 50 may not transmit the session removal response to the MME 30 (S2114), and the MME 30 may not transmit the detach response to the UE-R 15 (S2116).

Meanwhile, the UE 10a that receives the detach request transmits the detach response to the UE-R 15 (S2118), and the UE-R 15 receives the detach response from the UE 10a.

In a case where the detach response is received from the UE 10a, the UE-R 15 may remove the TFT corresponding to the communication path of the GO mode. Here, in a case where the bearer ID is included in the detach response, the UE-R may remove the TFT associated with the bearer ID.

The description is continued by referring back to FIG. 19. The UE-R 15 switches to the communication path of the decentralized mode (S1908). Here, the UE-R 15 may switch only the communication path for the transmission and reception of data in the GO mode indicated by the UE identifier, the APN or the PDN connection identifier notified to the UE 10a or the UE 10b to the communication path of the decentralized mode.

The UE 10a switches to the communication path of the decentralized mode (S1910). Here, the UE 10a may switch only the transmission and reception of data in the GO mode indicated by the UE identifier, the APN or the PDN connection identifier notified from the UE-R 15 to the communication path of the decentralized mode.

The UE 10b switches to the communication path of the decentralized mode (S1912). Here, the UE 10b may switch only the transmission and reception of data in the GO mode indicated by the UE identifier, the APN or the PDN connection identifier notified from the UE-R 15 to the communication path of the decentralized mode.

Through the above-described procedure, the UE-R 15 can notify the UE 10a of the switching to the communication path of the decentralized mode, and the UE-R 15 and the UE 10a can switch from the transmission and reception of data in the communication path of the GO mode to the communication path of the decentralized mode.

The above-described procedure is similarly performed in the UE 10b.

As mentioned above, the UE 10a, the UE 10b and the UE-R 15 can switch from the transmission and reception of data in the communication path of the GO mode to the transmission and reception of data in the communication path of the decentralized mode.

### 2. Second Embodiment

Although the switching procedure to the communication path of the decentralized mode from the communication path of the GO mode has been described in the first embodiment and Modification Example 1, a switching procedure to the communication path of the GO mode from the communication path of the decentralized mode will be described in the second embodiment.

The structure of the communication system can be the same as that of the first embodiment, and thus, the detailed description thereof will be omitted. The structures of the respective devices and apparatuses of the communication system are the same as those of the first embodiment, and thus the detailed description thereof will be omitted.

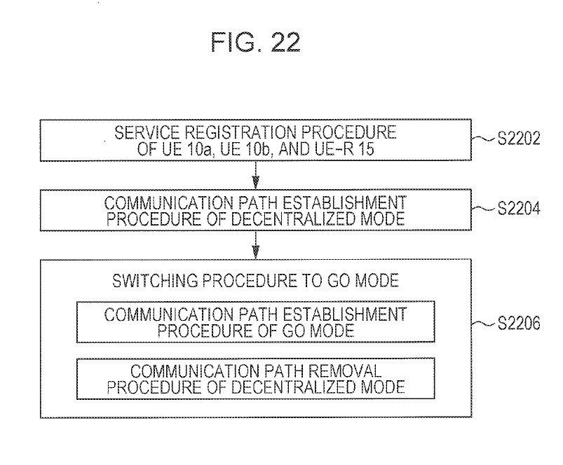

FIG. 22 illustrates a flow of primary processes in the second embodiment. In the second embodiment, the UE 10a, the UE 10b and the UE-R 15 initially perform the connection procedure to the network and the service registration procedure (S2202). Thereafter, the UE-R 15 and the UE 10 (UE 10a or UE 10b) perform the communication path establishment procedure of the decentralized mode (S2204). Accordingly, the UE 10 (UE 10a or UE 10b) and the UE-R 15 start the transmission and reception of data in the communication path of the decentralized mode.

The UE 10 and the UE-R 15 perform a switching procedure to the communication path of the GO mode during the transmission and reception of data through the communication path of the decentralized mode (S2206). The switching procedure to the GO mode is performed by a communication path establishment procedure of the GO mode and a communication path removal procedure of the decentralized mode.

Here, the UE 10a and the UE 10b previously perform the service registration procedure and the method of performing this procedure can be the same as that of the first embodiment, and thus, the description thereof will be omitted.

The UE-R 15 previously performs the service registration procedure and the method of performing this procedure can be the same as that of the first embodiment, and thus, the description thereof will be omitted. The method in which the UE 10a, the UE 10b and UE-R 15 perform the communication path establishment of the decentralized mode can be the same as that of the first embodiment, and thus, the detailed description thereof will be omitted. The TFT in the UE 10a, the UE 10b and the UE-R 15 in a case where the communication path of the decentralized mode is established can have the same structure as that described in the first embodiment, and thus, the detailed description thereof will be omitted.

### 2.1 Switching Procedure to GO Mode

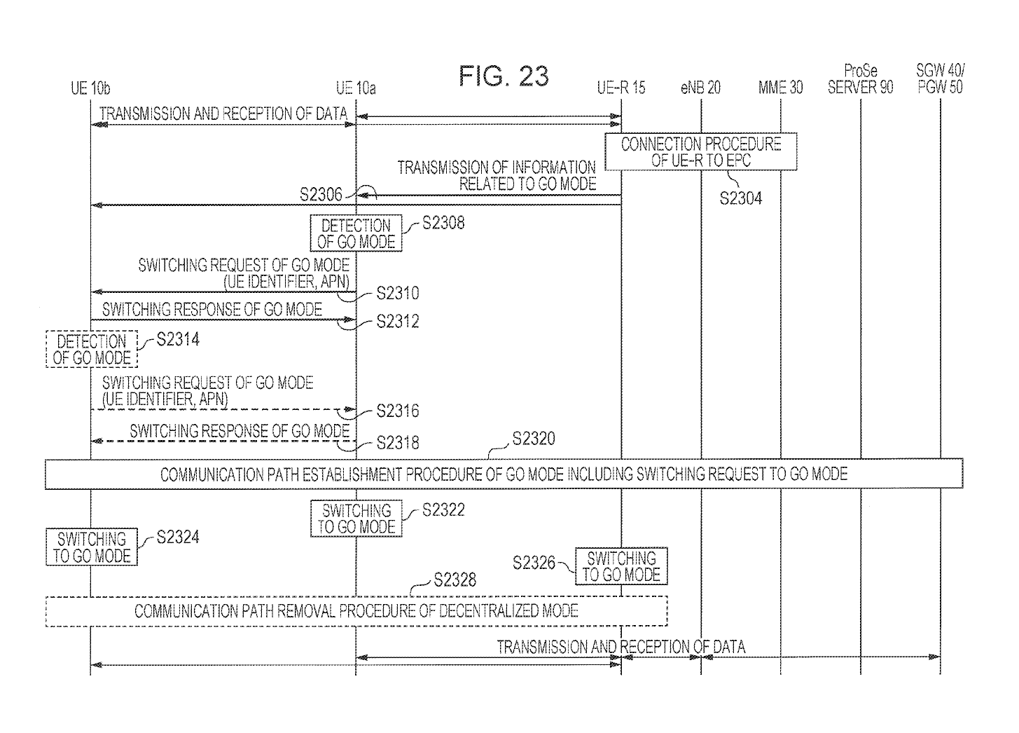

A switching procedure to a GO mode according to the second embodiment will be described. FIG. 23 illustrates the switching procedure to the GO mode. Initially, the UE-R 15 performs a connection procedure to the EPC (S2304). The connection procedure of the UE-R 15 to the EPC can be performed by the same method as that described in the first embodiment, and thus, the detailed description thereof will be omitted.

The UE-R 15 of which the connection procedure to the EPC is completed transmits information related to the GO mode to the UE 10a and the UE 10b (S2306), and the UE 10a and the UE 10b receives the information related to the GO mode from the UE-R 15. The information related to the GO mode transmitted from the UE-R 15 is the same as that of the first embodiment, and thus, the detailed description will be omitted.

The UE 10a detects that the communication path of the GO mode is available by the information related to the GO mode (S2308). The UE 10a that detects that the communication path of the GO mode is available transmits the switching request to the GO mode to the UE 10b (S2310). The switching request of the GO mode may include the UE identifier. Since the UE 10a adds the UE identifier to the switching request, this request may indicate the transmission and reception of data which is a target of a switching source and is associated with the UE identifier in the communication path of the decentralized mode, and the UE may perform the switching. For example, in a case where the UE adds the UE identifier indicating the UE-R 15 to the switching request, the UE 10a may inform the UE 10b of the transmission and reception of data to and from the UE-R 15, and may switch the transmission and reception of data to and from the UE-R 15. Although it has been described in this example that the UE identifier is added to the switching request of the GO mode, another message may be used instead of the switching request of the GO mode as long as the message is transmitted from the UE 10a to the UE 10b.

The UE 10a may add the APN to the switching request of the GO mode. Since the UE 10a adds the APN to the switching request, this request may indicate the transmission and reception of data in the communication path of the decentralized mode established by the APN, and the UE may switch the communication path of the decentralized mode corresponding to the APN. Although it has been described in this example that the APN is added to the switching request of the GO mode, another message may be used instead of the switching request of the GO mode.

The UE 10a may add the PDN connection identifier to the switching request of the GO mode. Since the UE 10a adds the PDN connection identifier to the switching request, this request may indicate the transmission and reception of data in the communication path of the decentralized mode corresponding to the PDN connection identifier, and the UE may switch the communication path of the decentralized mode corresponding to the PDN connection identifier. Although it has been described in this example that the PDN connection identifier is added to the switching request of the GO mode, another message may be used instead of the switching request of the GO mode.

In a case where the switching request does not include the UE identifier, the APN or the PDN connection identifier, it may be detected that the communication path of all data items transmitted and received in the communication path of the decentralized mode is switched to the communication path of the decentralized mode. The UE 10a may add the permission information indicating that the switching between the GO mode and the decentralized mode can be performed to the switching request of the GO mode.

Although it has been described that the UE 10a transmits the switching request of the GO mode in a case where the communication path of the GO mode is not established (S2310), the UE 10a may transmit the switching request of the GO mode in a case where the communication path of the GO mode is established (S2310). That is, after the communication path establishment procedure of the GO mode including the switching request to the GO mode is performed (S2320), the UE may transmit the switching request of the GO mode (S2310). The communication path establishment procedure of the GO mode including the switching request to the GO mode (S2320) will be described in detail below, and thus, the description thereof will be omitted.

As a condition for transmitting the switching request of the GO mode, the UE 10a may perform the determination using the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10a may transmit the switching request of the GO mode.

Here, the UE may not transmit the switching request of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the switching request of the GO mode.

The UE 10b receives the switching request of the GO mode from the UE 10a. The UE 10b detects that the switching from the communication path of the decentralized mode to the communication path of the GO mode is performed by the switching request of the GO mode.

In a case where the UE identifier is added to the switching request, the UE detects that the transmission and reception of data corresponding to the UE identifier are switched. In a case where the APN is added to the switching request, the UE detects that the transmission and reception of data in the communication path corresponding to the APN are switched. In a case where the PDN connection identifier is added to the switching request, the UE detects that the transmission and reception of data in the communication path corresponding to the PDN connection identifier are switched.

Although it has been described in this example that the UE 10b receives the switching request of the GO mode in a case where the communication path of the GO mode is not established (S2310), the UE 10b may receive the switching request of the GO mode in a case where the communication path of the GO mode is established (S2310). That is, after the communication path establishment procedure of the GO mode including the switching request to the GO mode is performed (S2320), the UE may receive the switching request of the GO mode (S2310). The communication path establishment procedure of the GO mode including the switching request to the GO mode (S2320) will be described in detail below, and thus, the description thereof will be omitted.

Since the permission information indicating that the switching between the GO mode and the decentralized mode can be performed is added to the switching request of the GO mode, the UE 10b may determine the switching of the GO mode.

Here, the UE 10b may determine the switching of the GO mode by the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may determine the switching of the GO mode.

Here, the UE 10b may determine not to perform the switching of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may determine not to perform the switching of the GO mode.

The UE 10b that determines to perform the switching to the communication path of the GO mode transmits the switching response of the GO mode to the UE 10a (S2312). Here, the UE 10b may add the permission information indicating that the switching between the GO mode and the decentralized mode can be performed to the switching response of the GO mode. The UE 10b may add the permission information indicating that the switching between the GO mode and the decentralized mode can be performed to the switching response of the GO mode. Since the UE 10b does not add the permission information indicating that the switching between the GO mode and the decentralized mode can be performed to the switching response of the GO mode, the switching response may indicate that the switching between the GO mode and the decentralized mode can be performed.

Although it has been described in this example that the UE 10b transmits the switching response of the GO mode in a case where the communication path of the GO mode is not established (S2312), the UE 10b may transmit the switching request of the GO mode in a case where the communication path of the GO mode is established (S2312). That is, after the communication path establishment procedure of the GO mode including the switching request to the GO mode is performed (S2320), the UE may transmit the switching request of the GO mode (S2310). The communication path establishment procedure of the GO mode including the switching request to the GO mode (S2320) will be described in detail below, and thus, the description thereof will be omitted.

As a condition for transmitting the switching response of the GO mode, the UE 10b may perform the determination using the permission information (S1104) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may transmit the switching response of the GO mode.

Here, the UE may not transmit the switching response of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the switching response of the GO mode.

Meanwhile, the UE 10a receives the switching response of the GO mode from the UE 10b. The UE 10a detects that the UE 10b detects the switching to the communication path of the GO mode by this response. The UE 10b may detect the GO mode (S2314) through the reception (S2306) of the information related to the GO mode.

Although it has been described in this example that the UE 10a receives the switching response of the GO mode in a case where the communication path of the GO mode is not established (S2312), the UE 10b may receive the switching response of the GO mode in a case where the communication path of the GO mode is established (S2312). That is, after the communication path establishment procedure of the GO mode including the switching request to the GO mode is performed (S2320), the UE may receive the switching response of the GO mode (S2312). The communication path establishment procedure of the GO mode including the switching request to the GO mode (S2320) will be described in detail below, and thus, the description thereof will be omitted.

As a condition for detecting the switching of the GO mode, the UE 10a may perform the determination by the notification (S1104) which is transmitted from the ProSe application server and indicates that the switching between the GO mode and the decentralized mode can be performed. The UE 10a may manage that the switching between the GO mode and the decentralized mode can be performed, and may detect the switching of the GO mode in a case where the switching between the GO mode and the decentralized mode can be performed.

Here, the UE 10a may determine not to perform the switching of the GO mode by the permission information (S1104) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may determine not to perform the switching of the GO mode.

Since the permission information indicating that the switching between the GO mode and the decentralized mode can be performed is added to the switching response of the GO mode, the UE 10a may determine the switching of the GO mode. Since the permission information indicating that the switching between the GO mode and the decentralized mode is not able to be performed is added to the switching response of the GO mode, the UE 10a may determine not to perform the switching of the GO mode. Since the permission information indicating that the switching between the GO mode and the decentralized mode can be performed is not added to the switching response of the GO mode, the UE 10a may determine not to perform the switching of the GO mode.

The UE 10b that detects the GO mode may transmit the switching request of the GO mode to the UE 10a (S2316). The switching request of the GO mode may include the UE identifier. Since the UE 10b adds the UE identifier to the switching request, this request may indicate the transmission and reception of data which is a target of a switching source and is associated with the UE identifier in the communication path of the decentralized mode, and the UE may perform the switching. Another message may be used instead of the switching request of the GO mode as long as the message is transmitted to the UE 10a from the UE 10b.

The UE 10b may add the APN to the switching request of the GO mode. Since the UE 10b adds the APN to the switching request, this request may indicate the transmission and reception of data in the communication path of the decentralized mode established by the APN, and the UE may switch the communication path of the decentralized mode corresponding to the APN. Another message may be used instead of the switching request of the GO mode as long as the message is transmitted to the UE 10a from the UE 10b.

The UE 10b may add the PDN connection identifier to the switching request of the GO mode. Since the UE-R 15 adds the PDN connection identifier to the switching request, this request may indicate the transmission and reception of data in the communication path of the decentralized mode corresponding to the PDN connection identifier, and the UE-R may switch the communication path of the decentralized mode corresponding to the PDN connection identifier. Although it has been described in this example that the PDN connection identifier is added to the switching request of the GO mode, another message may be used instead of the switching request of the GO mode.

In a case where the switching request does not include the UE identifier, the APN or the PDN connection identifier, it may be detected that the communication path of all data items transmitted and received in the communication path of the decentralized mode is switched to the communication path of the decentralized mode.

The UE 10b may add the permission information indicating that the switching between the GO mode and the decentralized mode can be performed to the switching request of the GO mode.

In a case where the switching request of the GO mode is received from the UE 10a (S2310) before the UE 10b transmits the switching request of the GO mode to the UE 10a (S2316), this UE may not transmit the switching request of the GO mode (S2316).

Although it has been described in this example that the UE 10b transmits the switching response of the GO mode in a case where the communication path of the GO mode is not established (S2316), the UE 10b may transmit the switching request of the GO mode in a case where the communication path of the GO mode is established (S2316). That is, after the communication path establishment procedure of the GO mode including the switching request to the GO mode is performed (S2320), this UE may transmit the switching request of the GO mode (S2320). The communication path establishment procedure of the GO mode including the switching request to the GO mode (S2320) will be described in detail below, and thus, the description thereof will be omitted.

As a condition for transmitting the switching request of the GO mode, the UE 10b may perform the determination using the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may transmit the switching request of the GO mode.

Here, the UE may not transmit the switching request of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may not transmit the switching request of the GO mode.

In a case where the UE 10b transmits the switching request of the GO mode to the UE 10a (S2316), the UE 10a receives the switching request of the GO mode from the UE 10b.

The UE 10a detects that the switching from the communication path of the decentralized mode to the communication path of the GO mode is performed by the switching request of the GO mode.

In a case where the UE identifier is added to the switching request, the UE detects that the transmission and reception of data corresponding to the UE identifier are switched. In a case where the APN is added to the switching request, the UE detects that the transmission and reception of data in the communication path corresponding to the APN are switched. In a case where the PDN connection identifier is added to the switching request, the UE detects that the transmission and reception of data in the communication path corresponding to the PDN connection identifier are switched.

Although it has been described in this example that the UE 10a receives the switching request of the GO mode in a case where the communication path of the GO mode is not established (S2316), the UE 10a may receive the switching request of the GO mode in a case where the communication path of the GO mode is established (S2316). That is, after the communication path establishment procedure of the GO mode including the switching request to the GO mode is performed (S2320), the UE may receive the switching request of the GO mode (S2316). The communication path establishment procedure of the GO mode including the switching request to the GO mode (S2320) will be described in detail below, and thus, the description thereof will be omitted.

Since the permission information indicating that the switching between the GO mode and the decentralized mode can be performed is added to the switching request of the GO mode, the UE 10a may determine the switching of the GO mode.

Here, the UE 10a may determine the switching of the GO mode by the permission information (S1104) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10a may determine the switching of the GO mode.

Here, the UE 10a may determine not to perform the switching of the GO mode by the permission information (S1104) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may determine not to perform the switching of the GO mode.

The UE 10a that determines to perform the switching to the communication path of the GO mode may transmit the switching response of the GO mode to the UE 10b (S2318). In a case where the UE 10a transmits the switching response of the GO mode to the UE 10b, the UE 10a receives the switching response of the GO mode from the UE 10b. The UE 10b detects that the UE 10a detects the switching to the communication path of the GO mode by this response.

In a case where the switching response of the GO mode is received from the UE 10b (S2312) before the switching response of the GO mode is transmitted to the UE 10b (S2318), the UE 10a may not transmit the switching response of the GO mode to the UE 10b (S2318).

Here, the UE 10a may add the permission information indicating that the switching between the GO mode and the decentralized mode can be performed to the switching response of the GO mode. The UE 10b may add the permission information indicating that the switching between the GO mode and the decentralized mode can be performed to the switching response of the GO mode. Since the UE 10a does not add the permission information indicating that the switching between the GO mode and the decentralized mode can be performed to the switching response of the GO mode, the switching response may indicate that the switching between the GO mode and the decentralized mode can be performed.

Although it has been described in this example that the UE 10a transmits the switching response of the GO mode in a case where the communication path of the GO mode is not established (S2318), the UE 10a may transmit the switching response of the GO mode in a case where the communication path of the GO mode is established (S2318). That is, after the communication path establishment procedure of the GO mode including the switching request to the GO mode is performed (S2320), the UE may transmit the switching response of the GO mode (S2318). The communication path establishment procedure of the GO mode including the switching request to the GO mode (S2320) will be described in detail below, and thus, the description thereof will be omitted.

As a condition for transmitting the switching response of the GO mode, the UE 10a may perform the determination using the permission information (S1104) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may transmit the switching response of the GO mode.

Here, the UE may not transmit the switching response of the GO mode by the permission information (S1104) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may not transmit the switching response of the GO mode.

The UE 10b receives the switching response of the GO mode. The UE 10b detects that the UE 10a detects the switching to the communication path of the GO mode by this response. In a case where the UE identifier is added to the switching response, the UE detects that the transmission and reception of data corresponding to the UE identifier are switched. In a case where the APN is added to the switching response, the UE detects that the transmission and reception of data in the communication path corresponding to the APN are switched. In a case where the PDN connection identifier is added to the switching response, the UE detects that the transmission and reception of data in the communication path corresponding to the PDN connection identifier are switched.

Although it has been described in this example that the UE 10b receives the switching response of the GO mode in a case where the communication path of the GO mode is not established (S2318), the UE 10b may receive the switching response of the GO mode in a case where the communication path of the GO mode is established (S2318). That is, after the communication path establishment procedure of the GO mode including the switching request to the GO mode is performed (S2320), the UE may receive the switching response of the GO mode (S2318). The communication path establishment procedure of the GO mode including the switching request to the GO mode (S2320) will be described in detail below, and thus, the description thereof will be omitted.

As a condition for detecting the switching of the GO mode, the UE 10b may perform the determination by the notification (S1104) which is transmitted from the ProSe application server and indicates that the switching between the GO mode and the decentralized mode can be performed. The UE 10b may manage that the switching between the GO mode and the decentralized mode can be performed, and may detect the switching of the GO mode in a case where the switching between the GO mode and the decentralized mode can be performed.

Here, the UE 10b may determine not to perform the switching of the GO mode by the permission information (S1104) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may determine not to perform the switching of the GO mode.

Since the permission information indicating that the switching between the GO mode and the decentralized mode can be performed is added to the switching request of the GO mode, the UE 10b may determine to the switching of the GO mode. Since the permission information indicating that the switching between the GO mode and the decentralized mode is not able to be performed is added to the switching request of the GO mode, the UE 10b may determine not to perform the switching mode of the GO mode. Since the permission information indicating that the switching between the GO mode and the decentralized mode can be performed is not added to the switching request of the GO mode, the UE 10b may determine not to perform the switching of the GO mode.

[2.1.1 Communication Path Establishment Procedure of GO Mode Including Switching Request to GO Mode]

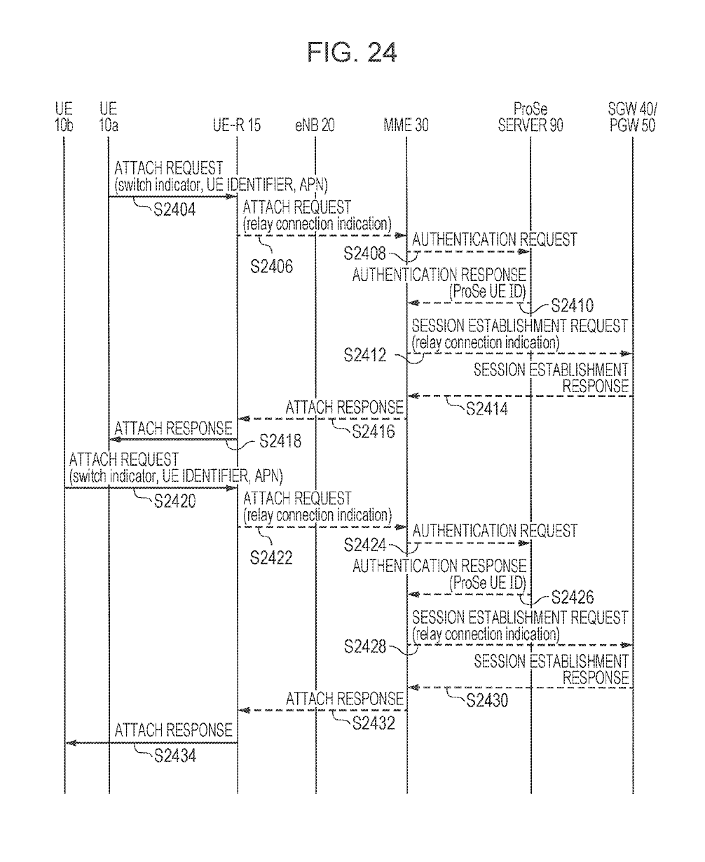

Subsequently, the UE 10a and the UE 10b performs the communication path establishment procedure of the GO mode including the switching request to the GO mode (S2320). FIG. 24 illustrates an example of the communication path establishment procedure including the switching request to the GO mode. Any procedure may be performed instead of the present procedure as long as the communication path establishment procedure including the switching request to the GO mode is performed.

The UE 10a transmits the attach request to the UE-R 15 (S2404). Here, the attach request includes the switch indicator indicating the switching request to the GO mode. Any indicator may be used instead of the switch indicator as long as the indicator indicating the switching request to the GO mode is used.

Although it has been described in this example that the switch indicator is added to the attach request, another message may be used instead of the attach request. Although it has been described in the present procedure that the switch indicator is included in one message indicating the communication path establishment procedure of the GO mode, and thus, this message indicates that the switching to the communication path of the GO mode is performed, the UE 10a may transmit a switching request message to the GO mode to the UE-R 15 and may notify the UE-R 15 of the switching to the communication path of the GO mode before the communication path establishment procedure of the GO mode is performed.

The UE 10a may add the UE identifier to the attach request. Since the UE 10a adds the UE identifier to the attach request, this request may indicate the transmission and reception of data which is a target of a switching source and is associated with the UE identifier in the communication path of the decentralized mode, and the UE may perform the switching. For example, in a case where the UE adds the UE identifier indicating the UE 10b to the attach request, the UE 10a may inform the UE 10b of the transmission and reception of data to and from the UE-R 15, and may switch the transmission and reception of data to and from the UE 10b. Although it has been described in this example that the UE identifier is added to the attach request, another message may be used instead of the attach request.

The UE-R 15 may add the APN to the attach request. Since the UE-R 15 adds the APN to the attach request, this request may indicate the transmission and reception of data in the communication path of the decentralized mode in the APN, and the UE-R may switch the communication path of the decentralized mode corresponding to the APN. Although it has been described in this example that the APN is added to the attach request, another message may be used instead of the attach request.

The UE-R 15 may add the PDN connection identifier to the attach request. Since the UE-R 15 adds the PDN connection identifier to the detach request, this request may indicate the transmission and reception of data in the communication path of the decentralized mode of the PDN connection identifier, and the UE-R may switch the communication path of the decentralized mode corresponding to the PDN connection identifier. Although it has been described in this example that the PDN connection identifier is added to the attach request, another message may be used instead of the attach request.

In a case where the attach request does not include the UE identifier, the APN or the PDN connection identifier, it may be detected that the communication path of all data items transmitted and received in the communication path of the GO mode is switched to the communication path of the GO mode.

As a condition for transmitting the attach request including the switch indicator, the UE 10a may perform the determination using the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10a may transmit the attach request including the switch indicator.

Here, the UE may not transmit the attach request including the switch indicator by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the attach request including the switch indicator.

The UE 10a may transmit the attach request including the switch indicator through the reception (S2312 of FIG. 23) of the switching response of the GO mode from the UE 10b. Here, since the permission information indicating that the switching between the GO mode and the decentralized mode can be performed is added to the switching response of the GO mode, the UE 10a may transmit the attach request including the switch indicator. Here, since the permission information indicating that the switching between the GO mode and the decentralized mode is not able to be performed is added to the switching response of the GO mode, the UE 10a may not transmit the attach request including the switch indicator. Here, since the permission information indicating that the switching between the GO mode and the decentralized mode can be performed is not added to the switching response of the GO mode, the UE 10a may not transmit the attach request including the switch indicator.

The UE 10a may transmit the attach request including the switch indicator through the reception (S2316 of FIG. 23) of the switching request of the GO mode from the UE 10b. Since the permission information indicating that the switching between the GO mode and the decentralized mode can be performed is added to the switching request of the GO mode, the UE 10a may transmit the attach request including the switch indicator.

Before the attach request is transmitted to the UE-R 15, the UE 10a may perform the proximity detection in order to detect whether or not the attach request can be transmitted to the UE-R 15. The UE 10a may request that the core network 7 or the ProSe Server 90 performs the proximity detection.

The UE-R 15 receives the attach request from the UE 10a. The UE 10a detects that the switching from the communication path of the decentralized mode to the communication path of the GO mode is performed by the switch indicator included in the attach request.

In a case where the UE identifier is added to the attach request, the UE detects that the transmission and reception of data in the decentralized mode corresponding to the UE identifier are switched. In a case where the APN is added to the attach request, the UE detects that the transmission and reception of data in the communication path of the decentralized mode corresponding to the APN are switched. In a case where the PDN connection identifier is added to the attach request, the UE detects that the transmission and reception of data in the decentralized mode corresponding to the PDN connection identifier are switched.

Subsequently, the UE-R 15 may transmit the attach request to the MME 30 (S2406). In this case, the attach request includes a relay connection indication. The relay connection indication is information indicating that the UE such as the UE 10a or the UE 10b is connected to the UE-R 15. Here, although the relay connection indication is used as the information indicating that the UE is connected to the UE-R 15, any information element may be used as long as the information indicates that the UE is connected to the UE-R 15. The attach request may include an information element for identifying the connected UE.

The MME 30 receives the attach request from the UE-R 15. The MME 30 may receive the attach request, and may perform a process of generating the PDN address (the IP address of the UE 10a) or a PDP context parameter.

The MME 30 detects that the UE 10a is connected to the UE-R 15 by the relay connection indication included in the attach request from the UE-R 15.

In a case where it is detected that the UE 10a is connected to the UE-R 15, the MME 30 may transmit the authentication request to the ProSe Server 90 (S2408). Here, the MME 30 may add the UE identifier of the UE 10a connected to the UE-R 15 to the authentication request.

The ProSe Server 90 receives the authentication request from the MME 30. Here, the ProSe Server 90 that receives the authentication request may authenticate that the UE 10a performs ProSe, or may authenticate that the UE is connected to the core network via the UE-R 15. In a case where the ProSe Server 90 authenticates that the UE 10a performs ProSe or authenticates that the UE is connected to the core network via the UE-R 15, the ProSe Server may extract the ProSe UE ID for identifying the UE 10a capable of being used in the proximity detection of ProSe or the establishment of the direct communication path.

The ProSe Server 90 transmits the authentication response to the MME 30 (S2410), and the MME 30 receives the authentication response from the ProSe Server 90. Here, the ProSe Server 90 may notify the MME 30 of the ProSe UE ID. The MME 30 receives the authentication response from the ProSe Server 90, and detects that the UE 10a is connected to the UE-R 15. Here, the MME 30 may perform the process of generating the PDN address (the IP address of the UE 10a) or the PDP context parameter.

The MME 30 transmits the session establishment request to the SGW 40/PGW 50 (S2412). Here, the session establishment request includes the relay connection indication. Since this request includes the relay connection indication, this request may indicate that the communication path that secures communication quality in order for the UE 10a to transmit and receive the data to the SGW 40/PGW 50 via the UE-R 15 is established.

The SGW 40/PGW 50 receives the session establishment request from the MME 30. The ProSe Server 90 detects that the UE 10a is connected to the core network via the UE-R 15 by the relay connection indication included in the session establishment request. Accordingly, the SGW 40/PGW 50 may establish the communication path that secures communication quality for the UE 10a in order for the UE 10a to transmit and receive the data via the UE-R 15.

The SGW 40/PGW 50 transmits the session establishment response to the MME 30 (S2414), and the MME 30 receives the session establishment response from the SGW 40/PGW 50. Accordingly, the MME 30 checks that the communication path through which the UE 10a is connected to the UE-R 15 to perform the transmission and reception of data is established between the PGW 50 and the SGW 30, between the SGW 30 and the eNB 20 and between the eNB 20 and the UE-R 15.

The MME 30 transmits the attach request to the UE-R 15 (S2416), and the UE-R 15 receives the attach response from the MME 30. Accordingly, the UE-R 15 secures the communication path through which the UE 10a can perform the transmission and reception of data via the UE-R 15 in the communication path between the UE-R 15 and the core network.

In a case where the attach response is received from the MME 30, the UE-R 15 may generate the TFT. Here, in a case where the bearer ID is included in the attach response, the TFT and the bearer ID may be managed so as to be associated with each other, and may be used to determine the transmission destination of data. When the transmission destination is determined, the TFT may be configured in association with information related to communication quality, and data may be transmitted depending on the communication quality.

Although the UE-R 15 transmits the attach request to the MME 30 and gains the authentication of the UE 10a, if the validation of the relay function by the UE-R 15 is previously authenticated, the authentication of the UE 10a may not be performed. That is, the UE-R 15 may not transmit the attach request to the MME 30 (S2406). In a case where the UE-R 15 does not transmit the attach request to the MME 30, the MME 30 may not transmit the authentication request to the ProSe Server 90 (S2408), the ProSe Server 90 may not transmit the authentication response to the MME 30 (S2410), the MME 30 may not transmit the session establishment request to the SGW 40/PGW 50 (S2412), the SGW 40/PGW 50 may not transmit the session establishment response to the MME 30 (S2414), and the MME 30 may not transmit the attach response to the UE-R 15 (S2416).

The UE-R 15 transmits the attach response to the UE 10a (S2418), and the UE 10a receives the attach response from the UE-R 15.

Here, the UE-R 15 may receive the information such as the APN, the PDN address, the bearer ID or the PDP context parameter by the attach response from the MME 30, and may notify the UE 10a of the received information and the attach response.

Here, the UE-R 15 may previously receive the information such as the APN, the PDN address, the bearer ID or the PDP context parameter in the registration procedure to the network or the service registration procedure in the relaying, and may notify the UE 10a of the attach response.

In a case where the attach response is received from the UE-R 15, the UE 10a may generate the TFT. Here, in a case where the bearer ID is included in the attach response, the TFT and the bearer ID may be managed so as to be associated with each other, and may be used to determine the transmission destination of data. When the transmission destination is determined, the TFT may be configured in association with information related to communication quality, and data may be transmitted depending on the communication quality.

Here, in a case where only a single communication path is established, the UE may transmit the data of all the applications to the established communication path without generating the TFT.

Through the above-described procedure, the UE 10a can establish the communication path in the GO mode.

The above-described procedure is similarly performed in the UE 10b. That is, the UE 10b transmits the attach request to the UE-R 15 (S2420), the UE-R 15 transmits the attach request to the MME 30 (S2422), the MME 30 transmits the authentication request to the ProSe Server 90 (S2424), the ProSe Server 90 transmits the authentication response to the MME 30 (S2426), the MME 30 transmits the session establishment request to the SGW 40/PGW 50 (S2428), the SGW 40/PGW 50 transmits the session establishment response to the MME 30 (S2430), the MME 30 transmits the attach request to the UE-R 15 (S2432), and the UE-R 15 transmits the attach response to the UE 10b. Similarly to the case of the UE 10a, if the validation of the relay function of the UE-R 15 is previously authenticated, the UE-R 15 may not perform the authentication of the UE 10b.

That is, the UE-R 15 may not transmit the attach request to the MME 30 (S2422), the MME 30 may not transmit the authentication request to the ProSe Server 90 (S2424), the ProSe Server 90 may not transmit the authentication response to the MME 30 (S2426), the MME 30 may not transmit the session establishment request to the SGW 40/PGW 50 (S2428), the SGW 40/PGW 50 may not transmit the session establishment response to the MME 30 (S2430), and the MME 30 may not transmit the attach response to the UE-R 15 (S2432). Through the above-described procedure, the UE 10b can establish the communication path in the GO mode.

As mentioned above, the UE 10a, the UE 10b and the UE-R 15 can establish the communication path in the GO mode and can perform the transmission and reception of data.

The TFT in the UE 10a, the UE 10b and the UE-R 15 in a case where the communication path of the GO mode is established can have the same structure described in the first embodiment, and thus, the detailed description thereof will be omitted.

By referring back to FIG. 23, the UE 10a detects the communication path establishment procedure of the GO mode is completed, and the UE 10a switches from the communication path of the decentralized mode to the communication path of the GO mode (S2322). Here, the UE 10a may switch only the transmission and reception of data in the decentralized mode indicated by the UE identifier, the APN or the PDN connection identifier notified to the UE-R 15 to the communication path of the GO mode.

The UE 10b detects the communication path establishment procedure of the GO mode is completed, and the UE 10b switches from the communication path of the decentralized mode to the communication path of the GO mode (S2324). Here, the UE 10a may switch only the transmission and reception of data in the decentralized mode indicated by the UE identifier, the APN or the PDN connection identifier notified to the UE-R 15 to the communication path of the GO mode.

The UE-R 15 detects that the communication path establishment procedure of the GO mode with the UE 10a is completed, and detects that the communication path establishment procedure of the GO mode with the UE 10b is completed, and the UE-R 15 switches from the communication path of the decentralized mode to the communication path of the GO mode (S2326). Here, the UE-R 15 may switch only the transmission and reception of data in the decentralized mode indicated by the UE identifier, the APN or the PDN connection identifier notified from the UE 10a or the UE 10b to the communication path of the GO mode.

[2.1.2 Communication Path Removal Procedure of Decentralized Mode]

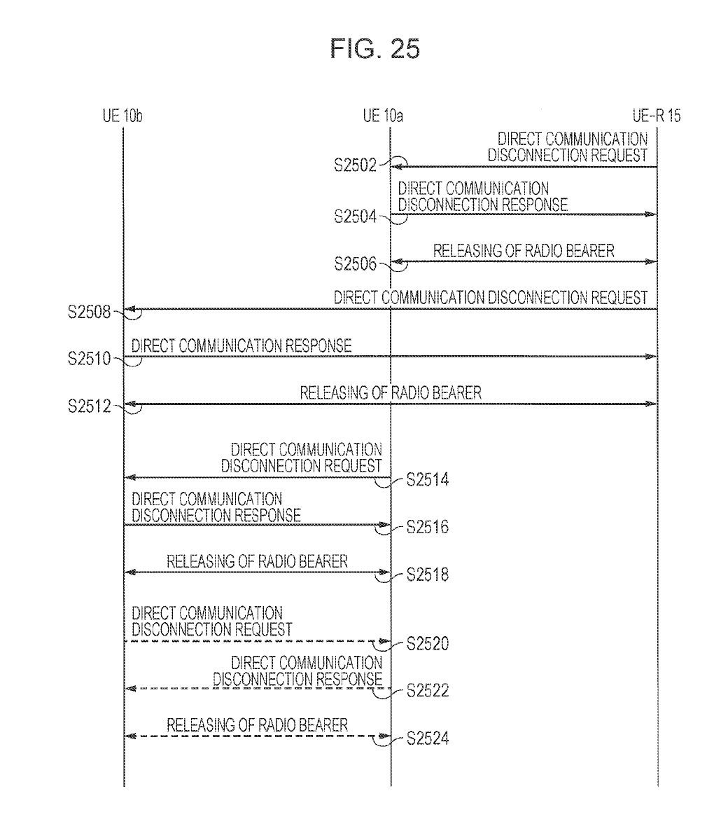

Thereafter, the UE-R 15 performs the communication path removal procedure in the decentralized mode (S2328). FIG. 25 illustrates an example of the communication path establishment procedure of the decentralized mode. Any procedure may be performed instead of the present procedure as long as the communication path establishment procedure of the decentralized mode is performed.

Initially, the UE-R 15 transmits the direct communication disconnection request in order to remove the communication path of the decentralized mode with the UE 10a (S2502). Here, the direct communication disconnection request includes the direct communication ID indicating the communication path of the decentralized mode or the IP address of the UE-R 15. The UE 10a receives the direct communication disconnection request from the UE-R 15, and removes the communication path of the decentralized mode with the UE-R 15 by the direct communication ID or the IP address of the UE-R 15 included in the direct communication disconnection request.

The UE 10a detects that the communication path of the decentralized mode with the UE-R 15 is removed and transmits the direct communication disconnection response (S2504), and the UE-R 15 receives the direct communication disconnection response from the UE 10a. The direct communication response includes the direct communication ID or the IP address of the UE 10a.

The UE-R 15 receives the direct communication disconnection response, and checks that the communication path of the decentralized mode is removed in the UE 10a. The UE-R 15 removes the communication path of the decentralized mode with the UE 10a by the direct communication ID or the IP address of the UE 10a included in the direct communication disconnection response.

Subsequently, the UE-R 15 and the UE 10a release the radio bearer (S2506). In the releasing of the radio bearer, the UE-R 15 notifies the UE 10a of the communication resource for performing the transmission and reception of data in the communication path of the decentralized mode, and causes the communication resource not to be used.

Through the above-described procedure, the UE-R 15 can remove the communication path of the decentralized mode with the UE 10a.

Subsequently, the UE-R 15 performs the communication path establishment procedure of the decentralized mode with the UE 10b. The communication path removal procedure of the decentralized mode performed by the UE-R 15 with the UE 10b is the same as the communication path removal procedure of the decentralized mode performed by the UE-R 15 with the UE 10a. That is, the UE-R 15 transmits the direct communication disconnection request to the UE 10b (S2508), the UE 10b receives the direct communication disconnection request from the UE-R 15, and the UE 10b transmits the direct communication disconnection response to the UE-R 15 (S2510), the UE-R 15 receives the direct communication disconnection response from the UE 10b, and the UE-R 15 and the UE 10b release the radio bearer (S2512).

Through the above-described procedure, the UE-R 15 can remove the communication path of the decentralized mode with the UE 10b.

The UE 10a that removes the communication path of the decentralized mode with the UE-R 15 removes the communication path of the decentralized mode with the UE 10b. Initially, the UE 10a transmits the direct communication disconnection request to the UE 10b (S2514). Here, the direct communication disconnection request includes the direct communication ID indicating the communication path of the decentralized mode or the IP address of the UE 10a. The UE 10b receives the direct communication request from the UE 10a, and removes the communication path of the decentralized mode with the UE 10a by the IP address of the UE 10a or the direct communication ID included in the direct communication disconnection request.

The UE 10b detects that the communication path of the decentralized mode with the UE 10a is removed and transmits the direct communication disconnection response (S2516), and the UE 10a receives the direct communication disconnection response from the UE 10b. The direct communication disconnection response includes the direct communication ID or the IP address of the UE 10b.

The UE-R 15 receives the direct communication disconnection response, and checks that the communication path of the decentralized mode is removed in the UE 10a. The UE-R 15 removes the communication path of the decentralized mode with the UE 10a by the direct communication ID or the IP address of the UE 10a included in the direct communication disconnection response.

Subsequently, the UE-R 15 and the UE 10a release the radio bearer (S2518). In the releasing of the radio bearer, the UE-R 15 notifies the UE 10a of the communication resource for performing the transmission and reception of data in the communication path of the decentralized mode, and causes the communication resource not to be used.

Through the above-described procedure, the UE 10a and the UE 10b can remove the communication path of the decentralized mode.

The UE 10b may perform the communication path removal procedure of the decentralized mode with the UE 10a. In a case where the UE 10b detects that the communication path of the decentralized mode with the UE 10a is removed by receiving the direct communication disconnection request from the UE 10a, the UE 10b may not perform the communication path removal procedure of the decentralized mode with the UE 10a.

The procedure of removing the communication path of the decentralized mode performed by the UE 10b with the UE 10a is the same as the communication path removal procedure of the decentralized mode performed by the UE 10a with the UE 10b.

That is, the UE 10b transmits the direct communication disconnection request to the UE 10a (S2520), the UE 10a transmits the direct communication disconnection response to the UE 10b (S2522), and the UE 10b and the UE 10a release the radio bearer (S2524).

Through the above-described procedure, the UE 10b and the UE 10a can remove the communication path of the decentralized mode.

As described above, the UE 10a, the UE 10b and the UE-R 15 can respectively switch to the transmission and reception of data in the communication path of the GO mode from the transmission and reception of data in the communication path of the decentralized mode.

### 2.2 Modification Example 2

Although it has been described in the second embodiment that the switching to the communication path of the GO mode is performed by the communication path establishment procedure including the switching request to the GO mode, the switching procedure may be performed in the communication path removal procedure of the decentralized mode including the switching request to the GO mode after the communication path of the GO mode is established.

The structure of the communication system can be the same as that of the first embodiment, and thus, the detailed description thereof will be omitted. The structures of the respective devices and apparatuses of the communication system are the same as those of the first embodiment, and thus the detailed description thereof will be omitted.

A flow of primary processes in Modification Example 2 can be performed using the same method as that described in the second embodiment, and thus, the detailed description thereof will be omitted.

Here, the UE 10a and the UE 10b previously perform the service registration procedure and the method of performing this procedure can be the same as that of the first embodiment, and thus, the description thereof will be omitted.

The UE-R 15 previously performs the service registration procedure and the method of performing this procedure can be the same as that of the first embodiment, and thus, the description thereof will be omitted. The method in which the UE 10a, the UE 10b and UE-R 15 perform the communication path establishment of the decentralized mode can be the same as that of the first embodiment, and thus, the detailed description thereof will be omitted. The TFT in the UE 10a, the UE 10b and the UE-R 15 in a case where the communication path of the decentralized mode is established can have the same structure as that described in the first embodiment, and thus, the detailed description thereof will be omitted.

[2.2.1 Switching Procedure to GO Mode]

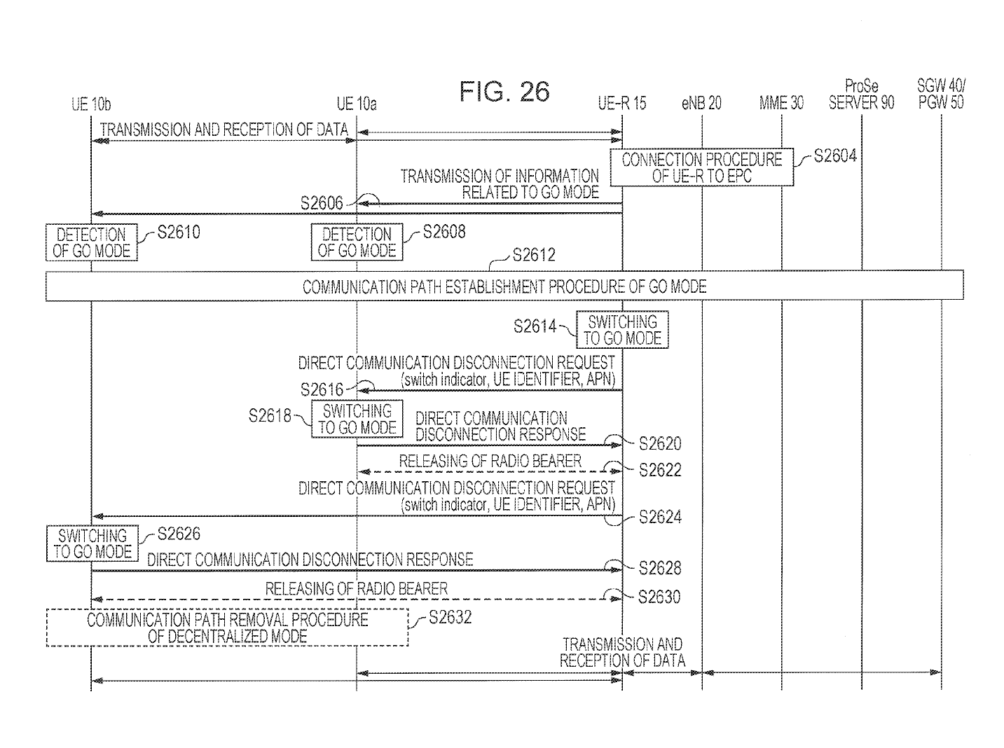

A switching procedure to a GO mode according to Modification Example 2 will be described. FIG. 26 illustrates the switching procedure to the GO mode. Initially, the UE-R 15 performs a connection procedure to the EPC (S2604). The connection procedure of the UE-R 15 to the EPC can be performed by the same method as that described in the first embodiment, and thus, the detailed description thereof will be omitted.

The UE-R 15 of which the connection procedure to the EPC is completed transmits information related to the GO mode to the UE 10a and the UE 10b (S2606), and the UE 10a and the UE 10b receives the information related to the GO mode from the UE-R 15. The information related to the GO mode transmitted from the UE-R 15 is the same as that of the first embodiment, and thus, the detailed description will be omitted.

The UE 10a detects that the communication path of the GO mode is available by the information related to the GO mode (S2608). The UE 10b detects that the communication path of the GO mode is available by the information related to the GO mode (S2610).

Thereafter, the UE 10a and the UE 10b perform the communication path establishment procedure of the GO mode (S2612). The communication path establishment procedure of the GO mode can be performed using the same method as that described in the first embodiment, and thus, the detailed description thereof will be omitted.

The UE-R 15 that completes the communication path establishment procedure of the GO mode with the UE 10a and completes the communication path establishment procedure of the GO mode with the UE 10b performs the switching to the GO mode (S2614).

Subsequently, the UE-R 15 performs the communication path removal procedure of the decentralized mode including the switching request to the communication path of the GO mode with the UE 10a. Initially, the UE-R 15 transmits the direct communication disconnection request to the UE 10a (S2616). Here, the direct communication disconnection request includes the switch indicator indicating the switching request to the GO mode. Any indicator may be used instead of the switch indicator as long as the indicator indicating the switching request to the GO mode is used.

Although it has been described in the present procedure that the switch indicator is included in the direct communication disconnection request, another message may be used instead of the direct communication disconnection request.

Although it has been described in the present procedure that the switch indicator is included in one message indicating the communication path removal procedure of the decentralized mode, and thus, this message indicates that the switching to the communication path of the GO mode is performed, the UE-R 15 may transmit a switching request message to the GO mode to the UE 10a and may notify the UE 10a of the switching to the communication path of the GO mode before the communication path removal procedure of the decentralized mode is performed.

The UE-R 15 may add the UE identifier to the direct communication disconnection request. Since the UE-R 15 adds the UE identifier to the direct communication disconnection request, this request may indicate the transmission and reception of data which is a target of a switching source and is associated with the UE identifier in the communication path of the decentralized mode, and the UE-R may perform the switching. Although it has been described in this example that the UE identifier is added to the direct communication disconnection request, another message may be used instead of the direct communication disconnection request.

The UE-R 15 may add the APN to the direct communication disconnection request. Since the UE-R 15 adds the APN to the direct communication disconnection request, this request may indicate the transmission and reception of data in the communication path of the decentralized mode in the APN, and the UE-R may switch the communication path of the decentralized mode corresponding to the APN. Although it has been described in this example that the APN is added to the direct communication disconnection request, another message may be used instead of the direct communication disconnection request.

The UE-R 15 may add the PDN connection identifier to the direct communication disconnection request. Since the UE-R 15 adds the PDN connection identifier to the direct communication disconnection request, this request may indicate the transmission and reception of data in the communication path of the decentralized mode corresponding to the PDN connection identifier, and the UE-R may switch the communication path of the decentralized mode corresponding to the PDN connection identifier. Although it has been described in this example that the PDN connection identifier is added to the direct communication disconnection request, another message may be used instead of the direct communication disconnection request.

In a case where the direct communication disconnection request does not the UE identifier, the APN or the PDN connection identifier, it may be detected that the communication path of all data items transmitted and received in the communication path of the decentralized mode is switched to the communication path of the GO mode.

The UE 10a receives the direct communication disconnection request from the UE-R 15. The UE 10a detects the switching to the communication path of the GO mode from the communication path of the decentralized mode by the switch indicator included in the direct communication disconnection request.

In a case where the UE identifier is added to the direct communication path disconnection request, the UE detects that the transmission and reception of data in the decentralized mode corresponding to the UE identifier are switched. In a case where the APN is added to the direct communication path disconnection request, the UE detects that the transmission and reception of data in the communication path of the decentralized mode corresponding to the APN are switched. In a case where the PDN connection identifier is added to the direct communication path disconnection request, the UE detects that the transmission and reception of data in the decentralized mode corresponding to the PDN connection identifier are switched.

The UE 10a that detects the switching to the communication path of the GO mode switches the transmission and reception of data in the communication path of the decentralized mode to the already established communication path of the GO mode (S2618). The UE 10a transmits the direct communication disconnection response to the UE-R 15 (S2620), and the UE-R 15 receives the direct communication disconnection response from the UE 10a. The UE-R 15 detects that the UE 10a switches to the communication path of the GO mode by this response. In a case where the transmission and reception of data in the communication path of the decentralized mode are not performed, the UE-R 15 and the UE 10a may release the radio bearer (S2622).

Through the above-described procedure, the UE-R 15 can notify the UE 10a of the switching to the communication path of the GO mode, and the UE-R 15 and the UE 10a can switch from the transmission and reception of data in the communication path of the decentralized mode to the communication path of the GO mode.

Thereafter, the UE-R 15 performs the communication path removal procedure including the switching request to the communication path of the GO mode with the UE 10b. The communication path removal procedure including the switching request to the GO mode performed by the UE-R 15 with the UE 10b is the same as the communication path removal procedure including the switching request to the GO mode performed by the UE-R 15 with the UE 10a. That is, the UE-R 15 transmits the direct communication disconnection request to the UE 10b (S2624), the UE 10b receives the direct communication disconnection request from the UE-R 15, the UE 10b performs the switching to the GO mode (S2626), the UE 10b transmits the direct communication disconnection response to the UE-R 15 (S2628), the UE-R 15 receives the direct communication disconnection response from the UE 10b, and the UE-R 15 and the UE 10b release the radio bearer (S2628).

Through the above-described procedure, the UE-R 15 can notify the UE 10b of the switching to the communication path of the GO mode, and the UE-R 15 and the UE 10b can switch from the transmission and reception of data in the communication path of the decentralized mode to the communication path of the GO mode.

[2.2.2 Communication Path Removal Procedure of Decentralized Mode Between UE 10a and UE 10b]

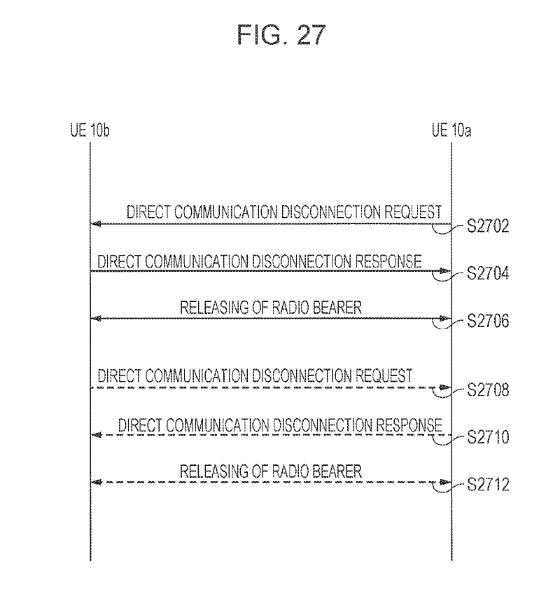

Thereafter, the UE 10a and the UE 10b may perform the communication path removal procedure of the decentralized mode (S2632). FIG. 27 illustrates an example of the communication path removal procedure of the decentralized mode between the UE 10a and the UE 10b. Any procedure may be performed instead of the present procedure as long as the communication path establishment procedure of the decentralized mode between the UE 10a and the UE 10b is performed.

Initially, the UE 10a transmits the direct communication disconnection request to the UE 10b (S2702). Here, the direct communication disconnection request includes the direct communication ID indicating the communication path of the decentralized mode or the IP address of the UE 10a. The UE 10b receives the direct communication request from the UE 10a, and removes the communication path of the decentralized mode with the UE 10a by the IP address of the UE 10a or the direct communication ID included in the direct communication disconnection request.

The UE 10b detects that the communication path of the decentralized mode with the UE 10a is removed and transmits the direct communication disconnection response (S2704), and the UE 10a receives the direct communication disconnection response from the UE 10b. The direct communication disconnection response includes the direct communication ID or the IP address of the UE 10b.

The UE-R 15 receives the direct communication disconnection response, and checks that the communication path of the decentralized mode is removed in the UE 10a. The UE-R 15 removes the communication path of the decentralized mode with the UE 10a by the direct communication ID or the IP address of the UE 10a included in the direct communication disconnection response.

Subsequently, the UE-R 15 and the UE 10a release the radio bearer (S2706). In the releasing of the radio bearer, the UE-R 15 notifies the UE 10a of the communication resource for performing the transmission and reception of data in the communication path of the decentralized mode, and causes the communication resource not to be used.

Through the above-described procedure, the UE 10a and the UE 10b can remove the communication path of the decentralized mode.

The UE 10b may perform the communication path removal procedure of the decentralized mode with the UE 10a. In a case where the UE 10b detects that the communication path of the decentralized mode with the UE 10a is removed by receiving the direct communication disconnection request from the UE 10a, the UE 10b may not perform the communication path removal procedure of the decentralized mode with the UE 10a.

The procedure of removing the communication path of the decentralized mode performed by the UE 10b with the UE 10a is the same as the communication path removal procedure of the decentralized mode performed by the UE 10a with the UE 10b.

That is, the UE 10b transmits the direct communication disconnection request to the UE 10a (S2708), the UE 10a transmits the direct communication disconnection response to the UE 10b (S2710), and the UE 10b and the UE 10a release the radio bearer (S2712).

Through the above-described procedure, the UE 10b and the UE 10a can remove the communication path of the decentralized mode.

### 3. Third Embodiment

Although it has been described in the first embodiment, Modification Example 1, the second embodiment and Modification Example 2 that the UE-R 15 is included in the same group as the group to which the UE 10a and the UE 10b belong, a case where the UE-R 15 is not included in the same group as the group to which the UE 10a and the UE 10b belong will be described in the third embodiment.

Although it has been described in the first embodiment, Modification Example 1, the second embodiment and Modification Example 2 that the UE 10a, the UE 10b and the UE-R 15 directly perform the transmission and reception of data in the decentralized mode, the UE-R 15 which does not belong to the same group does not perform the transmission and reception of data in the UE 10a and the UE 10b in the third embodiment. That is, in the decentralized mode of the third embodiment, the transmission and reception of data between the UE 10a and the UE 10b are performed.

In the third embodiment, a switching procedure to the communication path of the decentralized mode from the communication path of the GO mode in a case where the UE-R 15 is not included in the same group as the group to which the UE 10a and the UE 10b belong will be described.

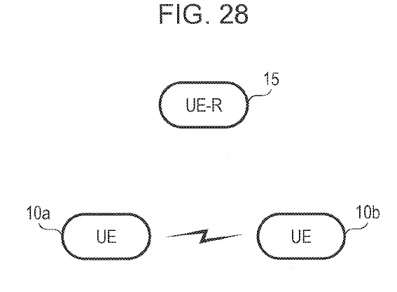

FIG. 28 illustrates an example of the transmission and reception of data in the decentralized mode according to the third embodiment.

In FIG. 28, the UE 10a performs the direct communication with the UE 10b instead of performing the transmission and reception of data via the UE-R 15. This drawing illustrates that the UE 10b performs the direct communication with the UE-R 15 and/or the UE 10a.

The switching procedure to the communication path of the decentralized mode from the communication path of the GO mode according to the third embodiment will be described.

The structure of the communication system can be the same as that of the first embodiment, and thus, the detailed description thereof will be omitted. The structures of the respective devices and apparatuses of the communication system are the same as those of the first embodiment, and thus the detailed description thereof will be omitted.

A flow of primary processes in the third embodiment can be performed using the same method as that in the first embodiment, and thus, the detailed description thereof will be omitted. The UE 10a and the UE 10b previously perform the registration procedure of the ProSe application and the method of performing the registration procedure can be the same as that of the first embodiment, and thus, the description thereof will be omitted. The UE-R 15 previously performs the connection procedure to the network and the service registration procedure and the methods of performing these procedures can be the same as those of the first embodiment, and thus, the description thereof will be omitted. The method in which the UE 10a and the UE 10b perform the communication path establishment of the GO mode can be the same as that of the first embodiment, and thus, the detailed description thereof will be omitted.

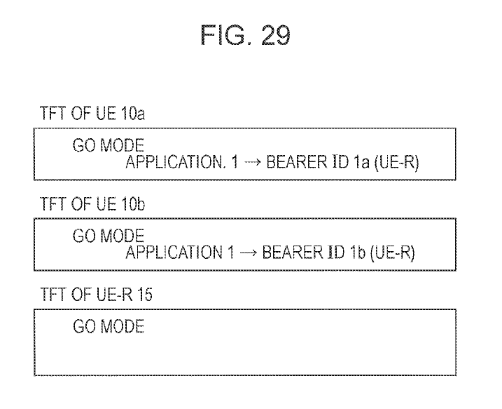

FIG. 29 illustrates an example of the TFT in the UE 10a, the UE 10b and the UE-R 15 in a case where the communication path in the GO mode is established. In FIG. 29, an example of the TFT in Application 1 is illustrated. Here, although only the example in Application 1 is illustrated, Application 2 or Application 3 may be managed in the TFT.

In the TFT of the UE 10a, Application 1 is managed in association with the bearer ID 1a. Here, the bearer ID 1a is a bearer ID indicating the communication path in the GO mode established by the UE 10a with the UE-R 15. In a case where the data is transmitted in Application 1, this bearer ID indicates that the UE 10a transmits the data to the UE-R 15. As described above, the UE 10a can perform the transmission and reception of data in Application 1 in the communication path of the GO mode by managing the TFT.

That is, in a case where the transmission and reception of data are performed in Application 1, the UE 10a transmits the data to the UE-R 15, the UE-R 15 transmits the data received from the UE 10a to the eNB 20, the eNB 20 transmits the data received from the UE-R 15 to the SGW 40, the SGW 40 transmits the data received from the eNB 20 to the PGW 50, and the PGW 50 transmits the data received from the SGW 40 to the PDN 80.

In the PDN 80, the process (routing process) of detecting the path to the UE 10b is performed, and the data is transmitted to the PGW 50 again. The PGW 50 transmits the data received from the PDN 80 to the SGW 40, the SGW 40 transmits the data received from the PGW 50 to the eNB 20, the eNB 20 transmits the data received from the SGW 40 to the UE-R 15, and the UE-R 15 transmits the data received from the eNB 20 to the UE 10b.

In the TFT of the UE 10b, Application 1 is managed in association with a bearer ID 1b. Here, the bearer ID 1b is a bearer ID indicating the communication path established by the UE 10b with the UE-R 15, and indicates that the UE 10b transmits the data to the UE-R 15 in a case where the data is transmitted in Application 1. As described above, the UE 10b can perform the transmission and reception of data in Application 1 in the communication path of the GO mode by managing the TFT.

That is, in a case where the transmission and reception of data are performed in Application 1, the UE 10b transmits the data to the UE-R 15, the UE-R 15 transmits the data received from the UE 10b to the eNB 20, the eNB 20 transmits the data received from the UE-R 15 to the SGW 40, the SGW 40 transmits the data received from the eNB 20 to the PGW 50, and the PGW 50 transmits the data received from the SGW 40 to the PDN 80.

In the PDN 80, the process (routing process) of detecting the path to the UE 10a is performed, and the data is transmitted to the PGW 50 again. The PGW 50 transmits the data received from the PDN 80 to the SGW 40, the SGW 40 transmits the data received from the PGW 50 to the eNB 20, the eNB 20 transmits the data received from the SGW 40 to the UE-R 15, and the UE-R 15 transmits the data received from the eNB 20 to the UE 10a.

Since the UE-R 15 does not belong to the same group as the group to which the UE 10a and the UE 10b belong and does not perform the transmission and reception of data to and from the UE 10a and the UE 10b, the management of the communication path is not performed in the TFT of the UE-R 15.

[3.1 Switching Procedure to Decentralized Mode]

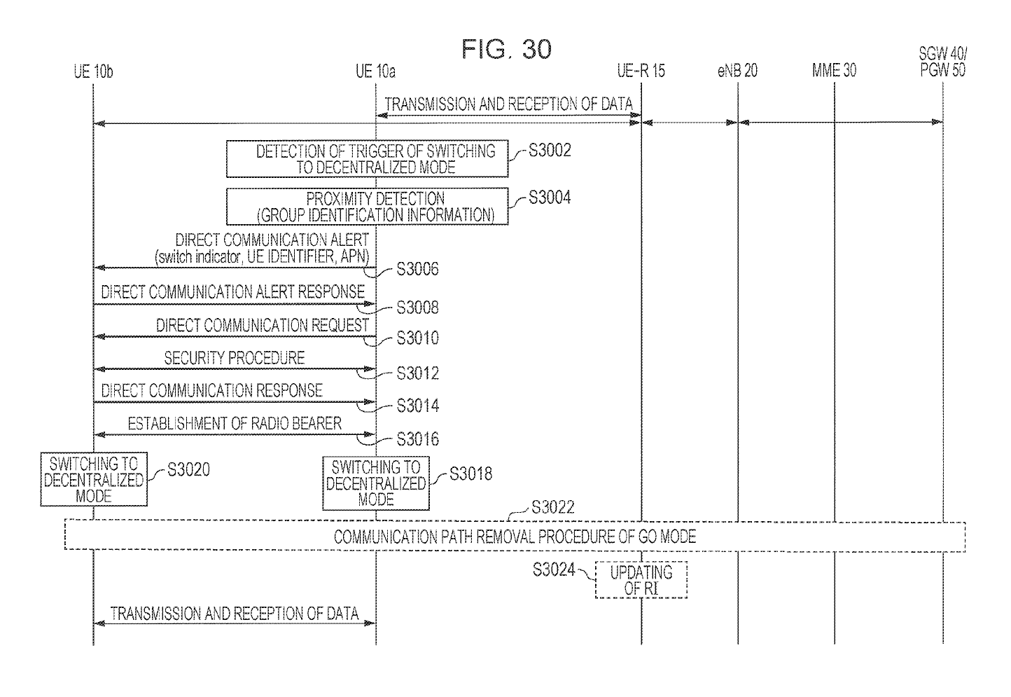

The switching procedure to the decentralized mode according to the third embodiment will be described. FIG. 30 illustrates the switching procedure to the decentralized mode. The switching to the decentralized mode is performed during the transmission and reception of data in the communication path of the GO mode.

The UE 10a detects a trigger for the switching to the decentralized mode (S3002). For example, the detection of the trigger for the switching to the decentralized mode may performed by detecting that the member of the group is present in proximity. That is, it may be detected that the UE 10a and the UE 10b are present in proximity, and the trigger for switching may be detected.

The detection of the trigger for the switching to the decentralized mode may be determined by detecting that the UE 10a is not present in the proximity of the UE-R 15 and the communication path of the GO mode is not able to be maintained. Subsequently, the UE 10a may perform the proximity detection (S3004). The method in which the UE 10a performs the proximity detection can be performed using the same method as that described in the first embodiment, and thus, the detailed description thereof will be omitted.

Thereafter, the UE 10a performs the communication path establishment procedure of the decentralized mode including the switching request to the communication path of the decentralized mode. Any procedure may be performed instead of the present procedure as long as the communication path establishment procedure including the switching request to the decentralized mode is performed.

Initially, the UE 10a transmits the direct communication alert to the UE 10b (S3006). Here, the direct communication alert includes the switch indicator indicating the switching request to the decentralized mode. Any indicator may be used instead of the switch indicator as long as the indicator indicating the switching request to the decentralized mode is used.

Although it has been described in the present procedure that the switch indicator is added to the direct communication alert, another message may be used instead of the direct communication alert.

Although it has been described in the present procedure that the switch indicator is included in one message indicating the communication path establishment procedure of the decentralized mode, and thus, this message indicates that the switching to the communication path of the decentralized mode is performed, the UE 10a may transmit a switching request message to the decentralized mode to the UE 10b and may notify the UE 10b of the switching to the communication path of the decentralized mode before the communication path establishment procedure of the decentralized mode is performed.

The UE 10a may add the UE identifier to the direct communication alert. Since the UE 10a adds the UE identifier to the direct communication alert, this alert may indicate the transmission and reception of data which is a target of a switching source and is associated with the UE identifier in the communication path of the GO mode, and the UE may perform the switching. For example, in a case where the UE adds the UE identifier indicating the UE 10a to the direct communication alert, the UE 10a may inform the UE 10b of the transmission and reception of data to and from the UE 10a, and may switch the transmission and reception of data to and from the UE 10a. Although it has been described that the UE identifier is added to the direct communication alert, another message may be used instead of the direct communication alert.

The UE 10a may add the APN to the direct communication alert. Since the UE 10a adds the APN to the direct communication alert, this alert may indicate the transmission and reception of data in the communication path of the GO mode in the APN, and the UE may switch the communication path of the GO mode corresponding to the APN. Although it has been described in this example that the APN is added to the direct communication alert, another message may be used instead of the direct communication alert.

The UE 10a may add the PDN connection identifier to the direct communication alert. Since the UE 10a adds the PDN connection identifier to the direct communication alert, this alert may indicate the transmission and reception of data in the communication path of the GO mode corresponding to the PDN connection identifier, and the UE may switch the communication path of the GO mode corresponding to the PDN connection identifier. Although it has been described in this example that the PDN connection identifier is added to the direct communication alert, another message may be used instead of the direct communication alert.

In a case where the direct communication alert does not include the UE identifier, the APN or the PDN connection identifier, it may be detected that the communication path of all data items transmitted and received in the communication path of the GO mode is switched to the communication path of the decentralized mode.

The UE 10a may add the permission information indicating that the switching between the GO mode and the decentralized mode can be performed to the direct communication alert.

As a condition for transmitting the direct communication alert request including the switch indicator, the UE 10a may perform the determination using the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10a may transmit the direct communication alert including the switch indicator.

Here, the UE may not transmit the direct communication alert including the witch indicator by the permission information (S1104) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the direct communication alert including the witch indicator.

The UE 10b receives the direct communication alert from the UE 10a. The UE 10b detects that the switching from the communication path of the GO mode to the communication path of the decentralized mode is performed by the switch indicator included in the direct communication alert.

In a case where the UE identifier is added to the direct communication alert, the UE detects that the transmission and reception of data in the GO mode corresponding to the UE identifier are switched. In a case where the APN is added to the direct communication alert, the UE detects that the transmission and reception of data in the communication path of the GO mode corresponding to the APN are switched. In a case where the PDN connection identifier is added to the direct communication alert, the UE detects that the transmission and reception of data in the GO mode corresponding to the PDN connection identifier are switched.

The UE 10b that detects the switching to the communication path of the decentralized mode transmits a direct communication alert response to the UE 10a (S3008), and the UE 10a receives the direct communication alert response from the UE 10b. The UE 10a detects that the UE 10b detects the switching to the communication path of the decentralized mode by this response.

Since the permission information indicating that the switching between the GO mode and the decentralized mode can be performed is added to the direct communication alert including the switch indicator, the UE 10b may determine to perform the switching of the decentralized mode.

As a condition for transmitting the direct communication alert response for the direct communication alert including the switch indicator, the UE 10b may perform the determination using the permission information (S1104 of FIG. 11) which is transmitted from the ProSe application server or the ProSe Server 90 and indicates that the switching between the GO mode and the decentralized mode can be performed. In a case where the UE 10a manages the switching between the GO mode and the decentralized mode can be performed, this UE may transmit the direct communication alert response to the direct communication alert including the switch indicator.

Subsequently, the UE 10a transmits the direct communication request in order to establish the communication path of the decentralized mode with the UE 10b (S3010). Here, the direct communication request includes the direct communication ID indicating that the communication path of the decentralized mode or the IP address of the UE 10a for performing the transmission and reception of data in the decentralized mode. The UE 10b receives the direct communication request from the UE 10a, and manages the direct communication ID or the IP address of the UE 10a included in the direct communication request.

Thereafter, the UE 10b performs the security procedure in order to perform the transmission and reception of data to and from the UE-R 15 (S3012). The security procedure is performed such that the transmission and reception of data between the UE 10b and the UE 10a are not intercepted from another UE or UE-R. The method of performing the security procedure can be performed using the same method as that described in the first embodiment, and thus, the detailed description thereof will be omitted.

The UE 10b detects that the security procedure is completed, transmits a direct communication response (S3014), and the UE 10a receives the direct communication response from the UE 10b. The direct communication response includes the direct communication ID or the IP address of the UE 10b.

The UE 10a receives the direct communication response, and checks that the communication path of the decentralized mode is established in the UE 10b. The UE 10a manages the IP address of the UE 10a or the direct communication ID in the communication path of the decentralized mode included in the direct communication response.

Thereafter, the UE 10a and the UE 10b establish the radio bearer (S3016). In the establishment of the radio bearer, the UE 10a notifies the UE 10b of the communication resource for performing the transmission and reception of data in the communication path of the decentralized mode.

The UE 10a that establishes the communication path of the decentralized mode performs the switching to the communication path of the decentralized mode (S3018). Here, the UE 10a may switch only the communication path for the transmission and reception of data in the GO mode indicated by the UE identifier, the APN or the PDN connection identifier notified to the UE 10b to the communication path of the decentralized mode.

The UE 10a may switch only the transmission and reception of data in the GO mode indicated by the UE identifier, the APN or the PDN connection identifier notified from the UE 10b to the communication path of the decentralized mode.

The UE 10b that establishes the communication path of the decentralized mode performs the switching to the communication path of the decentralized mode (S3020). Here, the UE 10b may switch only the transmission and reception of data in the GO mode indicated by the UE identifier, the APN or the PDN connection identifier notified to the UE 10a to the communication path of the decentralized mode.

The UE 10b may switch only the transmission and reception of data in the GO mode indicated by the UE identifier, the APN or the PDN connection identifier notified from the UE 10a to the communication path of the decentralized mode.

Through the above-described procedure, the UE 10a can notify the UE 10b of the switching to the communication path of the decentralized mode, and the UE 10a and the UE 10b can establish the communication path of the decentralized mode.

Thereafter, the UE 10a and the UE 10b may perform the communication path removal procedure of the GO mode (S3022). The communication path removal procedure of the GO mode can be performed using the same method as that described in the first embodiment, and thus, the detailed description thereof will be omitted.

In a case where the communication path removal procedure of the GO mode is completed, the UE-R 15 may update routing information (RI) (S3024). That is, the UE-R 15 may manage such that the transmission and reception of data between the UE 10a and the UE 10b are not performed.

[3.2 Management of Communication Path of Decentralized Mode]

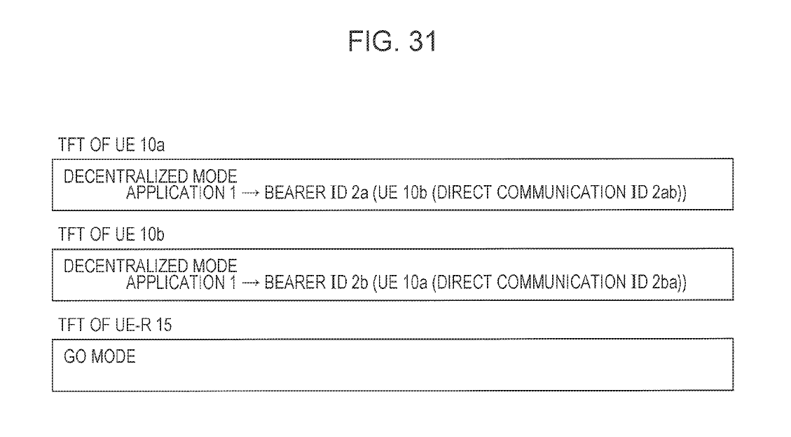

FIG. 31 illustrates an example of the TFT in the UE 10a, the UE 10b and the UE-R 15 in a case where the communication path in the decentralized mode is established. In FIG. 31, an example of the TFT in Application 1 is illustrated. Here, although only the example in Application 1 is illustrated, Application 2 or Application 3 may be managed in the TFT.

In the TFT of the UE 10a, Application 1 is managed in association with a bearer ID 2a. Here, the bearer ID 2a is a bearer ID indicating the communication path in the decentralized mode established by the UE 10a with the UE 10b and the UE-R 15. The bearer ID 2a is managed in association with a direct communication ID 2ab with the UE 10b.

In a case where the data is transmitted in Application 1, this bearer ID indicates that the UE 10a transmits the data to the UE 10b. As described above, the UE 10a can perform the transmission and reception of data in Application 1 in the communication path of the decentralized mode by managing the TFT.

That is, in a case where the transmission and reception of data are performed in Application 1, the UE 10a transmits the data to the UE 10b.

In the TFT of the UE 10b, Application 1 is managed in association with a bearer ID 2b. Here, the bearer ID 2b is a bearer ID indicating the communication path in the decentralized mode established by the UE 10b with the UE 10a. The bearer ID 2b is managed in association with a direct communication ID 2ba with the UE 10a.

In a case where the data is transmitted in Application 1, this bearer ID indicates that the UE 10b transmits the data to the UE 10a and the UE-R 15. As described above, the UE 10b can perform the transmission and reception of data in Application 1 in the communication path of the decentralized mode by managing the TFT.

That is, in a case where the transmission and reception of data are performed in Application 1, the UE 10b transmits the data to the UE 10a.

Since the UE-R 15 does not belong to the same group as the group to which the UE 10a and the UE 10b belong and does not perform the transmission and reception of data to and from the UE 10a and the UE 10b, the management of the communication path is not performed in the TFT of the UE-R 15.

As mentioned above, the UE 10a, the UE 10b and the UE-R 15 can switch from the transmission and reception of data in the communication path of the GO mode to the transmission and reception of data in the communication path of the decentralized mode.

### 4. Fourth Embodiment

Although the switching procedure to the communication path of the decentralized mode from the communication path of the GO mode has been described in the third embodiment, a switching procedure to the communication path of the GO mode from the communication path of the decentralized mode will be described in a fourth embodiment. Although it has been described in the first embodiment, Modification Example 1, the second embodiment and Modification Example 2 that the UE-R 15 is included in the same group as the group to which the UE 10a and the UE 10b belong, a case where the UE-R 15 is not included in the same group as the group to which the UE 10a and the UE 10b belong will be described in the fourth embodiment, similarly to the third embodiment.

The structure of the communication system can be the same as that of the first embodiment, and thus, the detailed description thereof will be omitted. The structures of the respective devices and apparatuses of the communication system are the same as those of the first embodiment, and thus the detailed description thereof will be omitted.

A flow of primary processes in the fourth embodiment can be performed using the same method as that described in the second embodiment, and thus, the detailed description thereof will be omitted. Here, the UE 10a and the UE 10b previously perform the service registration procedure and the method of performing this procedure can be the same as that of the first embodiment, and thus, the description thereof will be omitted.

The UE-R 15 previously performs the service registration procedure and the method of performing this procedure can be the same as that of the first embodiment, and thus, the description thereof will be omitted. The method in which the UE 10a and the UE 10b perform the communication path establishment of the decentralized mode can be the same as that of the first embodiment, and thus, the detailed description thereof will be omitted. The TFT in the UE 10a, the UE 10b and the UE-R 15 in a case where the communication path of the decentralized mode is established can have the same structure as that described in the third embodiment, and thus, the detailed description thereof will be omitted.

### 4.1 Switching Procedure to GO Mode

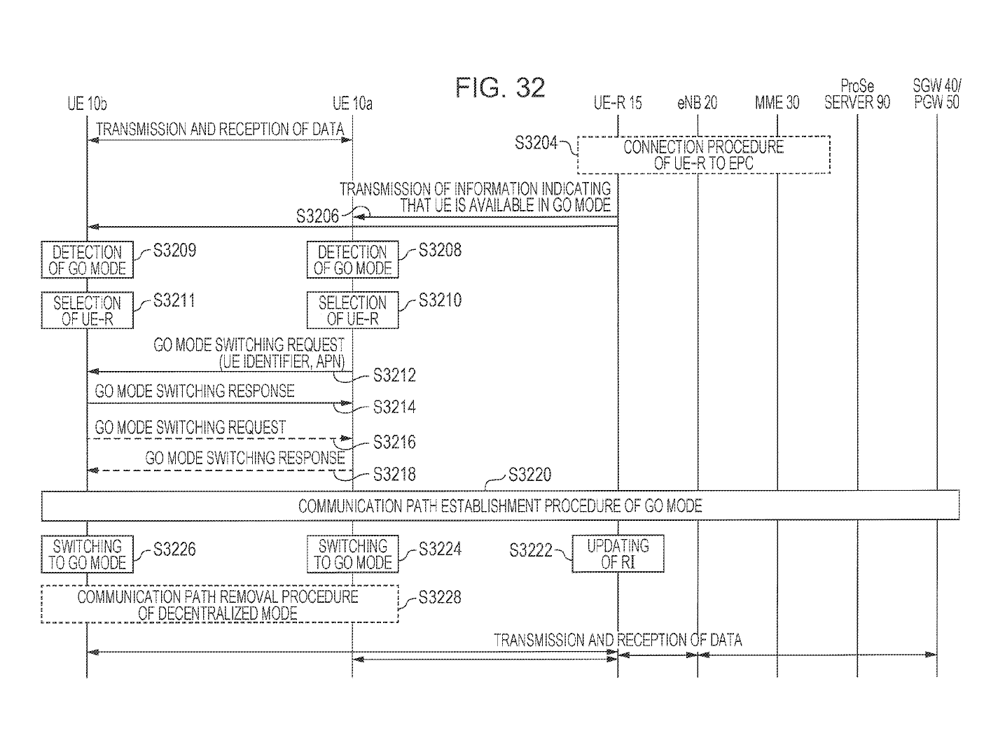

A switching procedure to a GO mode according to the fourth embodiment will be described. FIG. 32 illustrates the switching procedure to the GO mode. Initially, the UE-R 15 previously performs a connection procedure to the EPC (S3204). Here, the connection procedure of the UE-R 15 to the EPC can be performed by the same method as that described in the first embodiment, and thus, the detailed description thereof will be omitted.

The UE-R 15 of which the connection procedure to the EPC is completed transmits information related to the GO mode to the UE 10a and the UE 10b (S3206), and the UE 10a and the UE 10b receives the information related to the GO mode from the UE-R 15. The information related to the GO mode transmitted from the UE-R 15 is the same as that of the first embodiment, and thus, the detailed description will be omitted.

The UE 10a detects that the communication path of the GO mode is available by the information related to the GO mode (S3208).

[4.1.1 Relay Selection Procedure]

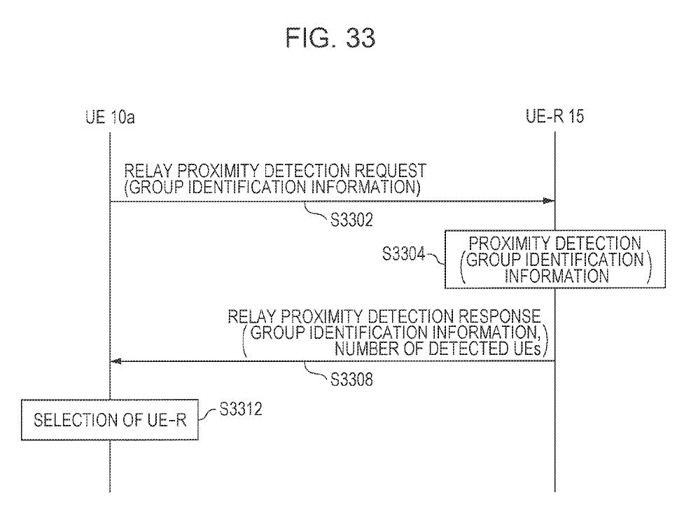

Here, in a case where the UE 10a detects that the communication path of the GO mode is available from plural pieces of UE-R 15, the UE may select the UE-R 15 (S3210). FIG. 33 illustrates an example of a procedure of selecting the UE-R 15. The method of selecting the UE-R 15 is not limited thereto, and another method may be used.

The UE 10a transmits a relay proximity detection request (S3302). This request includes group identification information. Here, this request includes information indicating Group 1 which is a switching target. In a case where there is the plural pieces of UE-R 15 in the proximity of the UE 10a, the UE 10a may transmit the relay proximity detection request to the plural pieces of UE-R 15.

Each UE-R 15 that receives the relay proximity detection request performs the proximity detection by using the group identification information (S3304). The proximity detection performed herein can be performed using the same method as that described in the first embodiment, and thus, the detailed description thereof will be omitted. The UE-R 15 counts the number of UEs belonging to the group present in the proximity of the UE-R 15.

The UE-R 15 transmits a relay proximity detection response to the UE 10a (S3308). Here, the UE-R 15 notifies of the group identification information and the detected number of UEs.

The UE 10a that receives the relay proximity detection response from the UE-R 15 selects the UE-R 15 (S3312). Here, the method of selecting the UE-R 15 is performed based on the number of UEs detected by the UE-R 15. Alternatively, the UE-R may be selected by adding received power from the UE-R 15. Through the above-described procedure, the UE 10a can select the GO.

By referring back to FIG. 32, the UE 10b receives the information related to the GO mode from the UE-R 15, and detects the GO mode (S3209). Here, in a case where the UE 10b detects that the communication path of the GO mode is available from the plural pieces of UE-R 15, the UE may select the UE-R 15 (S3211). The procedure in which the UE 10b selects the UE-R 15 can be performed using the same method as that of the procedure (S3210) in which the UE 10a selects the UE-R 15, and thus, the detailed description thereof will be omitted.

The UE 10a that detects the GO mode (S3208) selects the UE-R (S3210), and transmits the switching request of the GO mode to the UE 10b (S3212). The switching request of the GO mode may include the UE identifier. Since the UE 10a adds the UE identifier to the switching request, this request may indicate the transmission and reception of data which is a target of a switching source and is associated with the UE identifier in the communication path of the decentralized mode, and the UE may perform the switching. For example, in a case where the UE adds the UE identifier indicating the UE 10a to the switching request, the UE 10a may inform the UE 10b of the transmission and reception of data to and from the UE 10a, and may switch the transmission and reception of data to and from the UE 10a. Here, although it has been described that the UE identifier is added to the switching request of the GO mode, another message may be used instead of the switching request of the GO mode as long as the message is transmitted from the UE 10a to the UE 10b.

The UE 10a may add the APN to the switching request of the GO mode. Since the UE 10a adds the APN to the switching request, this request may indicate the transmission and reception of data in the communication path of the decentralized mode established by the APN, and the UE may switch the communication path of the decentralized mode corresponding to the APN. Although it has been described in this example that the APN is added to the switching request of the GO mode, another message may be used instead of the switching request of the GO mode.

The UE 10a may add the PDN connection identifier to the switching request of the GO mode. Since the UE 10a adds the PDN connection identifier to the switching request, this request may indicate the transmission and reception of data in the communication path of the decentralized mode corresponding to the PDN connection identifier, and the UE may switch the communication path of the decentralized mode corresponding to the PDN connection identifier. Although it has been described in this example that the PDN connection identifier is added to the switching request of the GO mode, another message may be used instead of the switching request of the GO mode.

In a case where the switching request does not include the UE identifier, the APN or the PDN connection identifier, it may be detected that the communication path of all data items transmitted and received in the communication path of the decentralized mode is switched to the communication path of the decentralized mode.

The UE 10a may add the permission information indicating that the switching between the GO mode and the decentralized mode can be performed to the switching request of the GO mode.

Although it has been described in this example that the UE 10a transmits the switching request of the GO mode in a case where the communication path of the GO mode is not established (S3212), the UE 10a may transmit the switching request of the GO mode in a case where the communication path of the GO mode is established (S3212). That is, after the communication path establishment procedure of the GO mode is performed (S3220), this UE may transmit the switching request of the GO mode (S3212).

As a condition for transmitting the switching request of the GO mode, the UE 10a may perform the determination using the permission information (S1104) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10a may transmit the switching request of the GO mode.

Here, the UE may not transmit the switching request of the GO mode by the permission information (S1104) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the switching request of the GO mode.

The UE 10b receives the switching request of the GO mode from the UE 10a. The UE 10b detects that the switching from the communication path of the decentralized mode to the communication path of the GO mode is performed by the switching request of the GO mode.

In a case where the UE identifier is added to the switching request, the UE detects that the transmission and reception of data corresponding to the UE identifier are switched. In a case where the APN is added to the switching request, the UE detects that the transmission and reception of data in the communication path corresponding to the APN are switched. In a case where the PDN connection identifier is added to the switching request, the UE detects that the transmission and reception of data in the communication path corresponding to the PDN connection identifier are switched.

Although it has been described in this example that the UE 10b receives the switching request of the GO mode in a case where the communication path of the GO mode is not established (S3212), the UE 10b may receive the switching request of the GO mode in a case where the communication path of the GO mode is established (S3212). That is, after the communication path establishment procedure of the GO mode is performed (S3220), this UE may receive the switching request of the GO mode (S3212). The communication path establishment procedure of the GO mode (S3220) is already described in the first embodiment, and thus, the description thereof will be omitted.

Since the permission information indicating that the switching between the GO mode and the decentralized mode can be performed is added to the switching request of the GO mode, the UE 10b may determine the switching mode of the GO mode.

Here, the UE 10b may determine the switching of the GO mode by the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may determine the switching of the GO mode.

Here, the UE 10b may determine not to perform the switching of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may determine not to perform the switching of the GO mode. The UE 10b that detects the switching to the communication path of the GO mode transmits the switching response of the GO mode to the UE 10a (S3214).

Here, the UE 10b may add the permission information indicating that the switching between the GO mode and the decentralized mode can be performed to the switching response of the GO mode. The UE 10b may add the permission information indicating that the switching between the GO mode and the decentralized mode can be performed to the switching response of the GO mode. Since the UE 10b does not add the permission information indicating that the switching between the GO mode and the decentralized mode can be performed to the switching response of the GO mode, the switching response may indicate that the switching between the GO mode and the decentralized mode can be performed.

Although it has been described in this example that the UE 10b transmits the switching response of the GO mode in a case where the communication path of the GO mode is not established (S3214), the UE 10b may transmit the switching response of the GO mode in a case where the communication path of the GO mode is established (S3214). That is, after the communication path establishment procedure of the GO mode is performed (S3220), this UE may transmit the switching response of the GO mode (S3214).

As a condition for transmitting the switching response of the GO mode, the UE 10b may perform the determination using the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may transmit the switching response of the GO mode.

Here, the UE may not transmit the switching response of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the switching response of the GO mode.

Meanwhile, the UE 10a receives the switching response of the GO mode from the UE 10b. The UE 10a detects that the UE 10b detects the switching to the communication path of the GO mode by this response.

Although it has been described in this example that the UE 10a receives the switching response of the GO mode in a case where the communication path of the GO mode is not established (S3214), the UE 10b may receive the switching response of the GO mode in a case where the communication path of the GO mode is established (S3214). That is, after the communication path establishment procedure of the GO mode is performed (S3220), this UE may receive the switching response of the GO mode (S3214). The communication path establishment procedure of the GO mode (S3220) is already described in the first embodiment, and thus, the description thereof will be omitted.

As a condition for detecting the switching of the GO mode, the UE 10a may perform the determination by the notification (S1104 of FIG. 11) which is transmitted from the ProSe application server and indicates that the switching between the GO mode and the decentralized mode can be performed. The UE 10a may manage that the switching between the GO mode and the decentralized mode can be performed, and may detect the switching of the GO mode in a case where the switching between the GO mode and the decentralized mode can be performed.

Here, the UE 10a may determine not to perform the switching of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may determine not to perform the switching of the GO mode. Since the permission information indicating that the switching between the GO mode and the decentralized mode can be performed is added to the switching response of the GO mode, the UE 10a may determine the switching of the GO mode. Since the permission information indicating that the switching between the GO mode and the decentralized mode is not able to be performed is added to the switching response of the GO mode, the UE 10a may determine not to perform the switching of the GO mode. Since the permission information indicating that the switching between the GO mode and the decentralized mode can be performed is added to the switching response of the GO mode, the UE 10a may determine not to perform the switching of the GO mode.

Meanwhile, the UE 10b that performs the detection (S3209) of the GO mode may transmit the switching request of the GO mode to the UE 10a (S3216). The switching request of the GO mode may include the UE identifier. Since the UE 10b adds the UE identifier to the switching request, this request may indicate the transmission and reception of data which is a target of a switching source and is associated with the UE identifier in the communication path of the decentralized mode, and the UE may perform the switching. Another message may be used instead of the switching request of the GO mode as long as the message is transmitted to the UE 10a from the UE 10b.

The UE 10b may add the APN to the switching request of the GO mode. Since the UE 10b adds the APN to the switching request, this request may indicate the transmission and reception of data in the communication path of the decentralized mode established by the APN, and the UE may switch the communication path of the decentralized mode corresponding to the APN. Another message may be used instead of the switching request of the GO mode as long as the message is transmitted to the UE 10a from the UE 10b.

In a case where the switching request of the GO mode is received from the UE 10a (S3212) before the UE 10b transmits the switching request of the GO mode to the UE 10a (S3216), this UE may not transmit the switching request of the GO mode (S3216).

The UE 10b may add the permission information indicating that the switching between the GO mode and the decentralized mode can be performed to the switching request of the GO mode.

In a case where the UE 10b transmits the switching request of the GO mode to the UE 10a, the UE 10a receives the switching request of the GO mode from the UE 10b. The UE 10a detects that the switching from the communication path of the decentralized mode to the communication path of the GO mode is performed by the switching request of the GO mode.

In a case where the UE identifier is added to the switching request, the UE detects that the transmission and reception of data corresponding to the UE identifier are switched. In a case where the APN is added to the switching request, the UE detects that the transmission and reception of data in the communication path corresponding to the APN are switched. In a case where the PDN connection identifier is added to the switching request, the UE detects that the transmission and reception of data in the communication path corresponding to the PDN connection identifier are switched.

Although it has been described in this example that the UE 10a receives the switching request of the GO mode in a case where the communication path of the GO mode is not established (S3216), the UE 10a may receive the switching request of the GO mode in a case where the communication path of the GO mode is established (S3216). That is, after the communication path establishment procedure of the GO mode is performed (S3220), this UE may receive the switching request of the GO mode (S3216). The communication path establishment procedure of the GO mode including the switching request to the GO mode (S3220) will be described in detail below, and thus, the description thereof will be omitted.

Since the permission information indicating that the switching between the GO mode and the decentralized mode can be performed is added to the switching request of the GO mode, the UE 10a may determine the switching of the GO mode.

Here, the UE 10a may determine the switching of the GO mode by the permission information (S1104) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10a may determine the switching of the GO mode.

Here, the UE 10a may determine not to perform the switching of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may determine not to perform the switching of the GO mode.

The UE 10a that determines to perform the switching to the communication path of the GO mode may transmit the switching response of the GO mode to the UE 10b (S3218).

In a case where the UE 10a transmits the switching response of the GO mode to the UE 10b, the UE 10a receives the switching response of the GO mode from the UE 10b. The UE 10b detects that the UE 10a detects the switching to the communication path of the GO mode by this response.

In a case where the switching response of the GO mode is received from the UE 10b (S3212) before the switching response of the GO mode is transmitted to the UE 10b (S3218), the UE 10a may not transmit the switching response of the GO mode to the UE 10b (S3218).

Here, the UE 10a may add the permission information indicating that the switching between the GO mode and the decentralized mode can be performed to the switching response of the GO mode. The UE 10b may add the permission information indicating that the switching between the GO mode and the decentralized mode can be performed to the switching response of the GO mode. Since the UE 10a does not add the permission information indicating that the switching between the GO mode and the decentralized mode can be performed to the switching response of the GO mode, the switching response may indicate that the switching between the GO mode and the decentralized mode can be performed.

Although it has been described in this example that the UE 10a transmits the switching response of the GO mode in a case where the communication path of the GO mode is not established (S3218), the UE 10a may transmit the switching response of the GO mode in a case where the communication path of the GO mode is established (S3218). That is, after the communication path establishment procedure of the GO mode is performed (S3220), this UE may transmit the switching response of the GO mode (S3218). The communication path establishment procedure of the GO mode including the switching request to the GO mode (S3220) can be performed using the same method as that described in the first embodiment, and thus, the description thereof will be omitted.

As a condition for transmitting the switching response of the GO mode, the UE 10a may perform the determination using the permission information (S1104 of FIG. 11) which is transmitted from the ProSe application server or the ProSe Server 90 and indicates that the switching between the GO mode and the decentralized mode can be performed. In a case where the permission information indicating that the switching between the GO mode and the decentralized mode can be performed is managed, the UE 10b may transmit the switching response of the GO mode.

Here, the UE may not transmit the switching response of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may not transmit the switching response of the GO mode.

Although it has been described in this example that the UE 10b receives the switching response of the GO mode in a case where the communication path of the GO mode is not established (S3218), the UE 10b may receive the switching response of the GO mode in a case where the communication path of the GO mode is established (S3218). That is, after the communication path establishment procedure of the GO mode including the switching request to the GO mode is performed (S3220), this UE may receive the switching response of the GO mode (S3218). The communication path establishment procedure of the GO mode including the switching request to the GO mode (S3220) can be performed using the same method as that described in the first embodiment, and thus, the description thereof will be omitted.

As a condition for detecting the switching of the GO mode, the UE 10b may perform the determination by the notification (S1104 of FIG. 11) which is transmitted from the ProSe application server and indicates that the switching between the GO mode and the decentralized mode can be performed. The UE 10b may manage that the switching between the GO mode and the decentralized mode can be performed, and may detect the switching of the GO mode in a case where the switching between the GO mode and the decentralized mode can be performed.

Here, the UE 10b may determine not to perform the switching of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may determine not to perform the switching of the GO mode.

Since the permission information indicating that the switching between the GO mode and the decentralized mode can be performed is added to the switching request of the GO mode, the UE 10b may determine the switching of the GO mode. Since the permission information indicating that the switching between the GO mode and the decentralized mode is not able to be performed is added to the switching request of the GO mode, the UE 10b may determine not to perform the switching of the GO mode. Since the permission information indicating that the switching between the GO mode and the decentralized mode can be performed is not added to the switching request of the GO mode, the UE 10b may determine not to perform the switching of the GO mode.

The UE 10a and the UE 10b that receive the switching request of the GO mode or the switching response of the GO mode perform the communication path establishment procedure of the GO mode (S3220). The communication path establishment procedure of the GO mode can be performed similarly to the procedure described in the first embodiment, and thus, the detailed description thereof will be omitted.

As a condition for performing the communication path establishment procedure of the GO mode, the UE 10a may perform the determination using the permission information (S1104 of FIG. 11) which is transmitted from the ProSe application server or the ProSe Server 90 and indicates that the switching between the GO mode and the decentralized mode can be performed. In a case where the UE 10a manages that the switching between the GO mode and the decentralized mode can be performed and manages the permission information indicating that the switching between the GO mode and the decentralized mode can be performed, the UE may perform the communication path establishment procedure of the GO mode.

Here, the UE may not perform the communication path establishment procedure of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may determine not to perform the communication path establishment procedure of the GO mode.

The UE 10a may perform the communication path establishment procedure of the GO mode through the reception (S3214) of the switching response of the GO mode from the UE 10b. Here, since the permission information indicating that the switching between the GO mode and the decentralized mode can be performed is added to the switching response of the GO mode, the UE 11a may determine the communication path establishment procedure of the GO mode. Since the permission information indicating that the switching between the GO mode and the decentralized mode is not able to be performed is added to the switching response of the GO mode, the UE 10a may not perform the communication path establishment procedure of the GO mode. Since the permission information indicating that the switching between the GO mode and the decentralized mode can be performed is not added to the switching response of the GO mode, the UE 10a may not perform the communication path establishment procedure of the GO mode.

The UE 10a may perform the communication path establishment procedure of the GO mode through the reception (S3216) of the switching request of the GO mode from the UE 10b. Since the permission information indicating that the switching between the GO mode and the decentralized mode can be performed is added to the switching request of the GO mode, the UE 10a may not perform the communication path establishment procedure of the GO mode.

As a condition for performing the communication path establishment procedure of the GO mode, the UE 10b may perform the determination using the permission information (S1104 of FIG. 11) which is transmitted from the ProSe application server or the ProSe Server 90 and indicates that the switching between the GO mode and the decentralized mode can be performed. In a case where the UE 10b manages that the switching between the GO mode and the decentralized mode can be performed and manages the permission information indicating that the switching between the GO mode and the decentralized mode can be performed, the UE may perform the communication path establishment procedure of the GO mode.

Here, the UE may not perform the communication path establishment procedure of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10b may determine not to perform the communication path establishment procedure of the GO mode.

The UE 10b may perform the communication path establishment procedure of the GO mode through the reception (S3218) of the switching response of the GO mode from the UE 10a. Since the permission information indicating that the switching between the GO mode and the decentralized mode can be performed is added to the switching response of the GO mode, the UE 10b may perform the communication path establishment procedure of the GO mode. Since the permission information indicating that the switching between the GO mode and the decentralized mode is not able to be performed is added to the switching response of the GO mode, the UE 10b may not perform the communication path establishment procedure of the GO mode. Since the permission information indicating that the switching between the GO mode and the decentralized mode can be performed is not added to the switching response of the GO mode, the UE 10b may not perform the communication path establishment procedure of the GO mode.

The UE 10b may perform the communication path establishment procedure of the GO mode through the reception (S3216) of the switching request of the GO mode from the UE 10a. Since the permission information indicating that the switching between the GO mode and the decentralized mode can be performed is added to the switching request of the GO mode, the UE 10b may not perform the communication path establishment procedure of the GO mode.

Through the communication path establishment procedure of the GO mode, the UE-R 15 that establishes the communication path of the GO mode with the UE 10a and the UE 10b updates the RI (S3222). Through the updating of the RI, the UE-R 15 transmits the data transmitted from the UE 10a to the eNB 20, the eNB 20 transmits the data received from the UE-R 15 to the SGW 40, the SGW 40 transmits the data received from the eNB 20 to the PGW 50, and the PGW 50 transmits the data received from the SGW 40 to the PDN 80. The data transmitted to the UE 10a from the PDN 80 is received from the PDN 80 to the PGW 50, the PGW 80 transmits the data received from the PDN 80 to the SGW 40, the SGW 40 transmits the data received from the PGW 50 to the eNB 20, the eNB 20 transmits the data received from the SGW 40 to the UE-R 15, and the UE-R 15 transmits the data received from the eNB 20 to the UE 10a.

Through the updating of the RI, the UE-R 15 transmits the data transmitted from the UE 10b to the eNB 20, the eNB 20 transmits the data received from the UE-R 15 to the SGW 40, the SGW 40 transmits the data received from the eNB 20 to the PGW 50, and the PGW 50 transmits the data received from the SGW 40 to the PDN 80. The data transmitted to the UE 10b from the PDN 80 is received from the PDN 80 to the PGW 50, the PGW 80 transmits the data received from the PDN 80 to the SGW 40, the SGW 40 transmits the data received from the PGW 50 to the eNB 20, the eNB 20 transmits the data received from the SGW 40 to the UE-R 15, and the UE-R 15 transmits the data received from the eNB 20 to the UE 10b.

The UE 10a that performs the communication path establishment procedure of the GO mode performs the switching to the communication path of the GO mode (S3224). Here, the UE 10a may switch only the transmission and reception of data in the decentralized mode indicated by the UE identifier, the APN or the PDN connection identifier notified to the UE 10b to the communication path of the GO mode.

The UE 10a may switch only the transmission and reception of data in the decentralized mode indicated by the UE identifier, the APN or the PDN connection identifier notified from the UE 10b to the communication path of the GO mode.

The UE 10b that performs the communication path establishment procedure of the GO mode performs the switching to the communication path of the GO mode (S3226). Here, the UE 10b may switch only the transmission and reception of data in the decentralized mode identified by the UE identifier, the APN or the PDN connection identifier notified to the UE 10a to the communication path of the GO mode.

The UE 10b may switch only the transmission and reception of data in the decentralized mode identified by the UE identifier, the APN or the PDN connection identifier notified from the UE 10a to the communication path of the GO mode.

The UE 10a and the UE 10b that perform the switching to the communication path of the GO mode may remove the communication path of the decentralized mode (S3228). The communication path removal procedure of the decentralized mode can be performed using the same method as that described in the third embodiment, and thus, the detailed description thereof will be omitted.

The TFT in the UE 10a, the UE 10b and the UE-R 15 in a case where the communication path of the GO mode is established can have the same structure as that described in the third embodiment, and thus, the detailed description thereof will be omitted.

As described above, the UE 10a, the UE 10b and the UE-R 15 can respectively switch to the transmission and reception of data in the communication path of the GO mode from the transmission and reception of data in the communication path of the decentralized mode.

### 4.2 Modification Example 3

Although it has been described in the fourth embodiment that the switching to the communication path of the GO mode is performed by the communication path establishment procedure including the switching request to the GO mode, the switching procedure may be performed in the communication path removal procedure of the decentralized mode including the switching request to the GO mode after the communication path of the GO mode is established.

The structure of the communication system can be the same as that of the first embodiment, and thus, the detailed description thereof will be omitted. The structures of the respective devices and apparatuses of the communication system are the same as those of the first embodiment, and thus the detailed description thereof will be omitted.

A flow of primary processes in Modification Example 3 can be performed using the same method as that described in the second embodiment, and thus, the detailed description thereof will be omitted. Here, the UE 10a and the UE 10b previously perform the service registration procedure and the method of performing this procedure can be the same as that of the first embodiment, and thus, the description thereof will be omitted.

The method in which the UE 10a, the UE 10b and UE-R 15 perform the communication path establishment of the decentralized mode can be the same as that of the first embodiment, and thus, the detailed description thereof will be omitted. The TFT in the UE 10a, the UE 10b and the UE-R 15 in a case where the communication path of the decentralized mode is established can have the same structure as that described in the first embodiment, and thus, the detailed description thereof will be omitted.

[4.2.1 Switching Procedure to GO Mode]

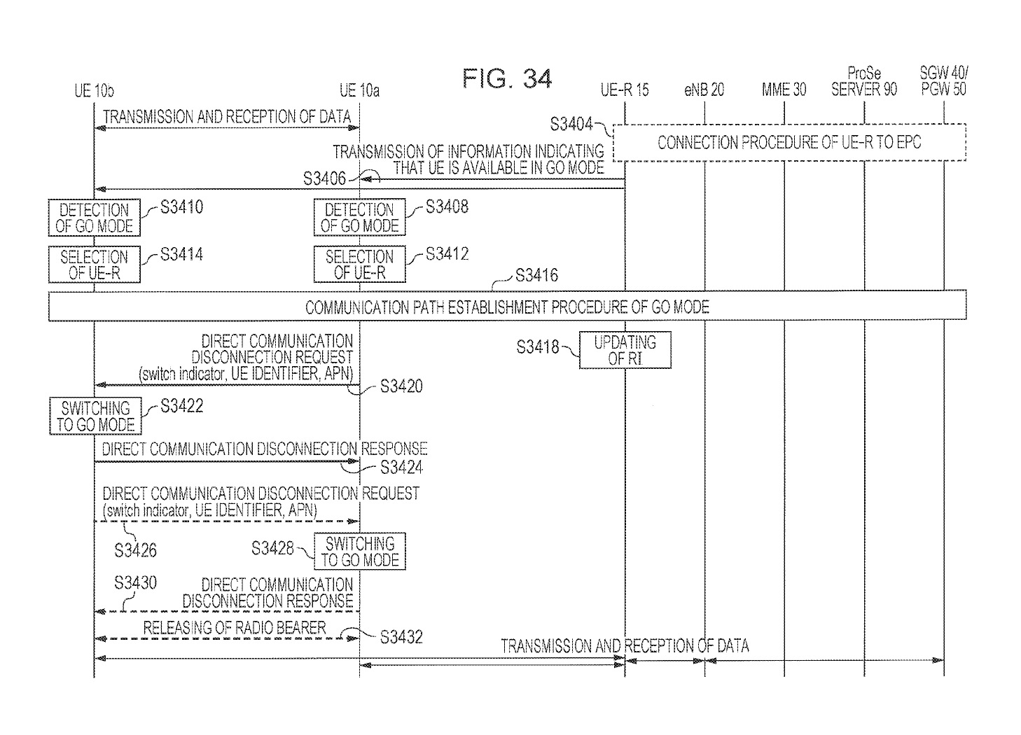

A switching procedure to a GO mode according to the fourth embodiment will be described. FIG. 34 illustrates the switching procedure to the GO mode. Initially, the UE-R 15 previously performs a connection procedure to the EPC (S3404). Here, the connection procedure of the UE-R 15 to the EPC can be performed by the same method as that described in the first embodiment, and thus, the detailed description thereof will be omitted.

The UE-R 15 of which the connection procedure to the EPC is completed transmits information related to the GO mode to the UE 10a and the UE 10b (S3406), and the UE 10a and the UE 10b receives the information related to the GO mode from the UE-R 15. The information related to the GO mode transmitted from the UE-R 15 is the same as that of the first embodiment, and thus, the detailed description will be omitted.

The UE 10a detects that the communication path of the GO mode is available by the information related to the GO mode (S3408). Here, in a case where the UE 10a detects that the communication path of the GO mode is available from the plural pieces of UE-R 15, the UE may select the UE-R 15 (S3412). The procedure in which the UE 10a selects the UE-R 15 can be performed using the same method as that described in the fourth embodiment, and thus, the detailed description thereof will be omitted.

Meanwhile, the UE 10b receives the information related to the GO mode from the UE-R 15, and detects the GO mode (S3410). Here, in a case where the UE 10b detects that the communication path of the GO mode is available from the plural pieces of UE-R 15, the UE may select the UE-R 15 (S3414). The procedure in which the UE 10b selects the UE-R 15 can be performed using the same method as that described in the fourth embodiment, and thus, the detailed description thereof will be omitted.

The UE 10a that detects the GO mode (S3408) performs the communication path establishment procedure of the GO mode (S3416). The communication path establishment procedure of the GO mode can be performed similarly to the method described in the first embodiment, and thus, the detailed description thereof will be omitted.

As a condition for performing the communication path establishment procedure of the GO mode, the UE 10a may perform the determination using the permission information (S1104 of FIG. 11) which is transmitted from the ProSe application server or the ProSe Server 90 and indicates that the switching between the GO mode and the decentralized mode can be performed. In a case where the UE 10a manages the permission information indicating that the switching between the GO mode and the decentralized mode can be performed, the UE may perform the communication path establishment procedure of the GO mode.

Here, the UE may not perform the communication path establishment procedure of the GO mode by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may determine not to perform the communication path establishment procedure of the GO mode.

The UE 10b that detects the GO mode (S3410) performs the communication path establishment procedure of the GO mode (S3416). The communication path establishment procedure of the GO mode can be performed similarly to the method described in the first embodiment, and thus, the detailed description thereof will be omitted.

Here, the UE-R 15 detects that the communication path establishment of the GO mode with the UE 10a and the UE 10b is achieved, and updates the RI (S3418). The updating of the RI can be performed using the same method as that described in the fourth embodiment, and thus, the detailed description thereof will be omitted.

Meanwhile, the UE 10a that performs the communication path establishment of the GO mode transmits the direct communication disconnection request to the UE 10b (S3420). The direct communication disconnection request may include the UE identifier. Since the UE 10a adds the UE identifier to the direct communication disconnection request, this request may indicate the transmission and reception of data which is a target of a switching source and is associated with the UE identifier in the communication path of the decentralized mode, and the UE may perform the switching. For example, in a case where the UE adds the UE identifier indicating the UE 10a to the direct communication disconnection request, the UE 10a may inform the UE 10b of the transmission and reception of data to and from the UE 10a, and may switch the transmission and reception of data to and from the UE 10a. Although it has been described in this example that the UE identifier is added to the direct communication disconnection request, another message may be used instead of the direct communication disconnection request as long as the method is transmitted from the UE 10a to the UE 10b.

The UE 10a may add the APN to the direct communication disconnection request. Since the UE 10a adds the APN to the direct communication disconnection request, this request may indicate the transmission and reception of data in the communication path of the decentralized mode established by the APN, and the UE may switch the communication path of the decentralized mode corresponding to the APN. Although it has been described in this example that the APN is added to the switching request of the GO mode, another message may be used instead of the switching request of the GO mode.

The UE 10a may add the PDN connection identifier to the direct communication disconnection request. Since the UE 10a adds the PDN connection identifier to the direct communication disconnection request, this request may indicate the transmission and reception of data in the communication path of the decentralized mode corresponding to the PDN connection identifier, and the UE may switch the communication path of the decentralized mode corresponding to the PDN connection identifier. Although it has been described in this example that the PDN connection identifier is added to the direct communication disconnection request, another message may be used instead of the direct communication disconnection request.

In a case where the direct communication disconnection request does not include the UE identifier, the APN or the PDN connection identifier, it may be detected that the communication path of all data items transmitted and received in the communication path of the decentralized mode is switched to the communication path of the decentralized mode.

Although it has been described in this example that the UE 10a transmits the direct communication disconnection request including the switch indicator in a case where the communication path of the GO mode is established (S3420), the UE 10a may transmit the direct communication disconnection request including the switch indicator in a case where the communication path of the GO mode is not established (S3420). That is, after the direct communication disconnection request is transmitted (S3420), the UE may perform the communication path establishment procedure (S3416) of the GO mode.

As a condition for transmitting the direct communication disconnection request including the switch indicator, the UE 10a may perform the determination using the permission information (S1104 of FIG. 11) is transmitted from the ProSe application server and indicates that the switching between the GO mode and the decentralized mode can be performed. The UE 10a may manage that the switching between the GO mode and the decentralized mode can be performed, and may transmit the direct communication disconnection request including the switch indicator in a case where the switching between the GO mode and the decentralized mode can be performed.

Here, the UE may not transmit the direct communication disconnection request including the switch indicator by the permission information (S1104 of FIG. 11) which is transmitted from the ProSe application server or the ProSe Server 90 and indicates that the switching between the GO mode and the decentralized mode is not able to be performed. In a case where the permission information indicating that the switching between the GO mode and the decentralized mode is not able to be performed is managed, the UE 10a may not transmit the direct communication disconnection request including the switch indicator.

The UE 10a may add the permission information indicating that the switching between the GO mode and the decentralized mode can be performed to the switching request of the GO mode. In a case where the UE identifier is added to the switching request, the UE detects that the transmission and reception of data corresponding to the UE identifier are switched. In a case where the APN is added to the switching request, the UE detects that the transmission and reception of data in the communication path corresponding to the APN are switched. In a case where the PDN connection identifier is added to the switching request, the UE detects that the transmission and reception of data in the communication path corresponding to the PDN connection identifier are switched.

The UE 10b that detects the switching to the communication path of the GO mode switches the transmission and reception of data in the communication path of the decentralized mode to the already established communication path of the GO mode (S3422).

The UE 10b that switches the transmission and reception of data to the communication path of the GO mode transmits the direct communication disconnection response to the UE 10a (S3424), and the UE 10a receives the direct communication disconnection response from the UE 10b. The UE 10a detects that the UE 10b switches to the communication path of the GO mode by this response.

Although it has been described in this example that the UE 10b transmits the direct communication disconnection response which is the response to the direct communication disconnection request including the switch indicator in a case where the communication path of the GO mode is established (S3424), the UE 10b may transmit the direct communication disconnection response which is the response to the direct communication disconnection request including the switch indicator in a case where the communication path of the GO mode is not established (S3424). That is, after the communication path establishment procedure of the GO mode is performed (S3416), the UE may transmit the direct communication disconnection response (S3424).

As a condition for transmitting the direct communication disconnection response, the UE 10b may perform the determination using the permission information (S1104 of FIG. 11) is transmitted from the ProSe application server and indicates that the switching between the GO mode and the decentralized mode can be performed. The UE 10b may manage that the switching between the GO mode and the decentralized mode can be performed, and may transmit the direct communication disconnection response in a case where the switching between the GO mode and the decentralized mode can be performed.

Since the permission information indicating that the switching between the GO mode and the decentralized mode can be performed is added to the direct communication disconnection request, the UE 10b may determine the switching to the communication path of the GO mode, and may transmit the direct communication disconnection response.

The UE 10b that determines to perform the switching to the communication path of the GO mode may transmit the direct communication disconnection response to the UE 10a (S3424). Here, the UE 10b may add the permission information indicating that the switching between the GO mode and the decentralized mode can be performed to the switching response of the GO mode. The UE 10b may add the permission information indicating that the switching between the GO mode and the decentralized mode can be performed to the switching response of the GO mode. Since the UE 10b does not add the permission information indicating that the switching between the GO mode and the decentralized mode can be performed to the switching response of the GO mode, the switching response may indicate that the switching between the GO mode and the decentralized mode can be performed.

The UE 10a receives the direct communication disconnection response from the UE 10b. The UE 10a detects that the UE 10b detects the switching to the communication path of the GO mode. Since the permission information indicating that the switching between the GO mode and the decentralized mode can be performed is added to the direct communication disconnection response, the UE 10a may determine the switching of the GO mode. Since the permission information indicating that the switching between the GO mode and the decentralized mode is not able to be performed is added to the direct communication disconnection response, the UE 10a may determine not to perform the switching of the GO mode. Since the permission information indicating that the switching between the GO mode and the decentralized mode can be performed is not added to the direct communication disconnection response, the UE 10a may determine not to perform the switching of the GO mode.

Accordingly, the UE 10a may switch the transmission and reception of data n the communication path of the decentralized mode to the communication path of the GO mode (S3428). The UE 10a may add the permission information indicating that the switching between the GO mode and the decentralized mode can be performed to the switching request of the GO mode.

Meanwhile, the UE 10b that performs the communication path establishment procedure of the GO mode may transmit the direct communication disconnection request to the UE 10a (S3426). The direct communication disconnection request may include the UE identifier. Since the UE 10b adds the UE identifier to the direct communication disconnection request, this request may indicate the transmission and reception of data which is a target of a switching source and is associated with the UE identifier in the communication path of the decentralized mode, and the UE may perform the switching. Another message may be used instead of the direct communication disconnection request as long as the method is transmitted from the UE 10b to the UE 10a.

The UE 10b may add the APN to the direct communication disconnection request. Since the UE 10b adds the APN to the direct communication disconnection request, this request may indicate the transmission and reception of data in the communication path of the decentralized mode established by the APN, and the UE may switch the communication path of the decentralized mode corresponding to the APN. Another message may be used instead of the direct communication disconnection request as long as the method is transmitted from the UE 10b to the UE 10a.

In a case where the direct communication disconnection request is received from the UE 10a (S3420) before the UE 10b transmits the direct communication disconnection request to the UE 10a (S3426), the UE may not transmit the direct communication disconnection request (S3426).

In a case where the UE 10b transmits the direct communication disconnection request to the UE 10a, the UE 10a receives the direct communication disconnection request from the UE 10b. The UE 10a detects that the switching from the communication path of the decentralized mode to the communication path of the GO mode is performed by the direct communication disconnection. Since the permission information indicating that the switching between the GO mode and the decentralized mode can be performed is added to the direct communication disconnection request, the UE 10a may determine the switching to the communication path of the GO mode.

In a case where the UE identifier is added to the direct communication disconnection request, the UE detects that the transmission and reception of data corresponding to the UE identifier are switched. In a case where the APN is added to the direct communication disconnection request, the UE detects that the transmission and reception of data in the communication path corresponding to the APN are switched. In a case where the PDN connection identifier is added to the direct communication disconnection request, the UE detects that the transmission and reception of data in the communication path corresponding to the PDN connection identifier are switched.

The UE 10a that receives the direct communication disconnection request may switch the transmission and reception of data in the communication path of the decentralized mode to the already established communication path of the GO mode (S3428).

The UE 10a may transmit the direct communication disconnection response to the UE 10b (S3430). In a case where the UE 10a transmits the direct communication disconnection response to the UE 10b, the UE 10a receives the direct communication disconnection response from the UE 10b. The UE 10b may detect that the UE 10a performs switching to the communication path of the GO mode by this response.

The TFT in the UE 10a, the UE 10b and the UE-R 15 in a case where the communication path of the GO mode is established can have the same structure as that described in the third embodiment, and thus, the detailed description thereof will be omitted.

As described above, the UE 10a, the UE 10b and the UE-R 15 can respectively switch to the transmission and reception of data in the communication path of the GO mode from the transmission and reception of data in the communication path of the decentralized mode.

The first embodiment to the fourth embodiment and Modification Example 1 to Modification Example 4 have been described, and it has been described in these embodiments and examples that the switching from the communication path of the decentralized mode to the communication path of the GO mode or the switching from the communication path of the GO mode to the communication path of the decentralized mode can be performed.

That is, in a case where transmission and reception of data are switched to a second communication path of a second mode in which data is directly transmitted to a terminal device present in the proximity of a relay terminal device for a period during which a first communication path of a first mode in which data transmitted from the terminal device is transferred to a base station apparatus and data transmitted from the base station apparatus is transferred to the terminal device is established and the transmission and reception of data are performed in the first communication path of the first mode, the relay terminal device may transmit to the terminal device a request message which includes information indicating the switching to the second communication path of the second mode and requests the switching to the second communication path of the second mode; receive from the terminal device a response message to the request message for requesting the switching; establish the second communication path of the second mode; and switch the transmission and reception of the data in the first communication path of the first mode to the transmission and reception of the data in the second communication path of the second mode.

In a case where transmission and reception of data are switched to a first communication path of a first mode in which data transmitted from a terminal device is transferred to a base station apparatus and data transmitted from the base station apparatus is transferred to the terminal device for a period during which a second communication path of a second mode in which data is directly transmitted to the terminal device present in the proximity of a relay terminal device is established and the transmission and reception of data are performed in the second communication path of the second mode, the relay terminal device may transmit to the terminal device a request message which includes information indicating the switching to the first communication path of the first mode and requests the switching to the first communication path of the first mode; receive from the terminal device a response message to the request message for requesting the switching; establish the first communication path of the first mode; and switch the transmission and reception of the data in the second communication path of the second mode to the transmission and reception of the data in the first communication path of the first mode.

The request message for requesting the switching may include information for identifying the terminal device or the relay terminal device, or information indicating a connection destination.

In a case where transmission and reception of data are switched to a first communication path of a first mode in which data is transmitted via a relay terminal device for a period during which a second communication path of a second mode in which data is directly transmitted to the relay terminal device present in the proximity of a terminal device is established and the transmission and reception of data are performed in the second communication path of the second mode, the terminal device may transmit to the relay terminal device a request message which includes information indicating the switching to the first communication path of the first mode and requests the switching to the first communication path of the first mode; receive from the relay terminal device a response message to the request message for requesting the switching; establish the first communication path of the first mode; and switch the transmission and reception of the data in the second communication path of the second mode to the transmission and reception of the data in the first communication path of the first mode.

In a case where transmission and reception of data are switched to a second communication path of a second mode in which data is directly transmitted to a second terminal device present in the proximity of a terminal device for a period during which a first communication path of a first mode in which data is transmitted via a relay terminal device present in the proximity of the terminal device is established and the transmission and reception of data are performed in the first communication path of the first mode, the terminal device may transmit to the second terminal device a request message which includes information indicating the switching to the second communication path of the second mode and requests the switching to the second communication path of the second mode; receive from the second terminal device a response message to the request message for requesting the switching; establish the second communication path of the second mode; and switch the transmission and reception of the data in the first communication path of the first mode to the transmission and reception of the data in the second communication path of the second mode.

In a case where transmission and reception of data are switched to a first communication path of a first mode in which data is transmitted via a relay terminal device present in the proximity of a terminal device for a period during which a second communication path of a second mode in which data is directly transmitted to a second terminal device present in the proximity of the terminal device is established and the transmission and reception of data are performed in the second communication path of the second mode, the terminal device may transmit to the second terminal device a request message which includes information indicating the switching to the first communication path of the first mode and requests the switching to the first communication path of the first mode; receive from the second terminal device a response message to the request message for requesting the switching; establish the first communication path of the first mode; and switch the transmission and reception of the data in the second communication path of the second mode to the transmission and reception of the data in the first communication path of the first mode.

The request message for requesting the switching may be a request message for requesting that the communication path is established.

The request message for requesting the switching may be a request message for requesting that the communication path is removed.

The request message for requesting the switching may include information for identifying the terminal device or the relay terminal device, or information indicating a connection destination.

Although the embodiments and modification examples related to these embodiments have been described, the specific structures are not limited to these embodiments and the modification examples, and designs without departing from the gist of the present invention are included in the present invention.

The programs which run on the devices and apparatuses according to the respective embodiments may be programs (programs causing a computer to function) which control a CPU such that the functions of the above-described embodiments are implemented. The information items handled by these devices and apparatuses are temporarily stored in a temporary storage device (for example, RAM) during the process, and then are stored in storage devices of various ROMs or HDDs. The information is read, corrected, and written by the CPU if necessary.

Here, as a recording medium that stores the programs, any one of a semiconductor medium (for example, ROM, or non-volatile memory card), an optical recording medium and a magneto-optical recording medium (for example, digital versatile disc (DVD), magneto optical disc (MO), mini disc (MD), compact disc (CD), or BD), or a magnetic recording medium (for example, magnetic tape, or flexible disc) may be used. The functions of the present invention may be realized by performing the process in cooperation with other application programs or an operating system based on the instruction of the program, in addition to realizing the functions of the aforementioned embodiments by executing the loaded program.

In a case where the programs are distributed on the market, the programs may be distributed by being stored in a portable recording medium, or may be transferred to a server computer connected via a network such as the Internet. In this case, a storage device of the server computer may be included in the present invention as a matter of course.

Some or all of the apparatuses used in the aforementioned embodiments may be realized as large scale integration (LSIs) which are typical integrated circuits. Each functional block of each apparatus may be individually integrated into a chip, or some or all of the functional blocks may be integrated into a chip. A method for achieving the integrated circuit is not limited to the LSI, but may be realized by a dedicated circuit or a general-purpose processor. In addition, in a case where a technique for achieving an integrated circuit which replaces the LSI technique will be developed with the progress of a semiconductor technique, the integrated circuit manufactured by the developed technique can also be used.

### REFERENCE SIGNS LIST

1 Mobile communication system
5 IP mobile communication network
7 Core network
9 LTE access network
10 UE
15 UE-R
20 eNB
30 MME
40 SGW
50 PGW
60 HSS
70 PCRF
80 PDN
90 ProSe Server

1-19. (canceled)

20. A relay terminal device that
in a case where transmission and reception of data are switched to a second communication path of a second mode in which data is directly transmitted to a terminal device present in the proximity of the relay terminal device for a period during which a first communication path of a first mode in which data transmitted from the terminal device is transferred to a base station apparatus and data transmitted from the base station apparatus is transferred to the terminal device is established and the transmission and reception of data are performed in the first communication path of the first mode,
transmits to the terminal device a request message which includes information indicating the switching to the second communication path and requests the switching to the second communication path;
receives from the terminal device a response message to the request message for requesting the switching;
establishes the second communication path of the second mode; and
switches the transmission and reception of the data in the first communication path to the transmission and reception of the data in the second communication path.

21. The relay terminal device according to claim 20,
wherein the request message for requesting the switching is a request message for requesting that the communication path is established.

22. The relay terminal device according to claim 20,
wherein the request message for requesting the switching is a request message for requesting that the communication path before the switching is removed.

23. The relay terminal device according to claim 20,
wherein the request message for requesting the switching includes information for identifying the terminal device or the relay terminal device, or information indicating a connection destination.

24. A terminal device that
in a case where transmission and reception of data are switched to a second communication path of a second mode in which data is directly transmitted to a second terminal device present in the proximity of the terminal device for a period during which a first communication path of a first mode in which data is transmitted via a relay terminal device present in the proximity of the terminal device is established and the transmission and reception of data are performed in the first communication path of the first mode,
transmits to the second terminal device a request message which includes information indicating the switching to the second communication path of the second mode and requests the switching to the second communication path of the second mode;
receives from the second terminal device a response message to the request message for requesting the switching;
establishes the second communication path of the second mode; and
switches the transmission and reception of the data in the first communication path of the first mode to the transmission and reception of the data in the second communication path of the second mode.

25. A terminal device that
in a case where transmission and reception of data are switched to a first communication path of a first mode in which data is transmitted via a relay terminal device present in the proximity of the terminal device for a period during which a second communication path of a second mode in which data is directly transmitted to a second terminal device present in the proximity of the terminal device is established and the transmission and reception of data are performed in the second communication path of the second mode,
transmits to the second terminal device a request message which includes information indicating the switching to the first communication path of the first mode and requests the switching to the first communication path of the first mode;
receives from the second terminal device a response message to the request message for requesting the switching;
establishes the first communication path of the first mode; and
switches the transmission and reception of the data in the second communication path of the second mode to the transmission and reception of the data in the first communication path of the first mode.

26. The terminal device according to claim 24,
wherein the request message for requesting the switching is a request message for requesting that the communication path is established.

27. The terminal device according to claim 24,
wherein the request message for requesting the switching is a request message for requesting that the communication path is removed.

28. The terminal device according to claim 24,
wherein the request message for requesting the switching includes information for identifying the terminal device or the relay terminal device, or information indicating a connection destination.

29. A communication control method of a relay terminal device, the method comprising:
in a case where transmission and reception of data are switched to a second communication path of a second mode in which data is directly transmitted to a terminal device present in the proximity of the relay terminal device for a period during which a first communication path of a first mode in which data transmitted from the terminal device is transferred to a base station apparatus and data transmitted from the base station apparatus is transferred to the terminal device is established and the transmission and reception of data are performed in the first communication path of the first mode,
a step of transmitting to the terminal device a request message which includes information indicating the switching to the second communication path of the second mode and requests the switching to the second communication path of the second mode;
receiving from the terminal device a response message to the request message for requesting the switching;
a step of establishing the second communication path of the second mode; and
a step of switching the transmission and reception of the data in the first communication path of the first mode to the transmission and reception of the data in the second communication path of the second mode.

30. A communication control method of a terminal device, the method comprising:
in a case where transmission and reception of data are switched to a second communication path of a second mode in which data is directly transmitted to a second terminal device present in the proximity of the terminal device for a period during which a first communication path of a first mode in which data is transmitted via a relay terminal device present in the proximity of the terminal device is established and the transmission and reception of data are performed in the first communication path of the first mode,
a step of transmitting to the second terminal device a request message which includes information indicating the switching to the second communication path of the second mode and requests the switching to the second communication path of the second mode;
a step of receiving from the second terminal device a response message to the request message for requesting the switching;
a step of establishing the second communication path of the second mode; and
a step of switching the transmission and reception of the data in the first communication path of the first mode to the transmission and reception of the data in the second communication path of the second mode.

31. The communication control method according to claim 29,
wherein the request message for requesting the switching is a request message for requesting that the communication path is established.

32. The communication control method according to claim 29,
wherein the request message for requesting the switching is a request message for requesting that the communication path is removed.

33. The communication control method according to claim 29,
wherein the request message for requesting the switching includes information for identifying the terminal device or the relay terminal device, or information indicating a connection destination.

34. The terminal device according to claim 25,
wherein the request message for requesting the switching is a request message for requesting that the communication path is established.

35. The terminal device according to claim 25,
wherein the request message for requesting the switching is a request message for requesting that the communication path is removed.

36. The terminal device according to claim 25,
wherein the request message for requesting the switching includes information for identifying the terminal device or the relay terminal device, or information indicating a connection destination.

37. The communication control method according to claim 30,
wherein the request message for requesting the switching is a request message for requesting that the communication path is established.

38. The communication control method according to claim 30,
wherein the request message for requesting the switching is a request message for requesting that the communication path is removed.

39. The communication control method according to claim 30,
wherein the request message for requesting the switching includes information for identifying the terminal device or the relay terminal device, or information indicating a connection destination.
